(19) United States
(12) Patent Application Publication
(10) Pub. No.: US 2012/0183668 A1
(43) Pub. Date: Jul. 19, 2012

(54) AQUACULTURE FEED COMPOSITIONS

(75) Inventors: J. MARTIN ODOM, KENNETT SQUARE, PA (US); MARIOS AVGOUSTI, KENNETT SQUARE, PA (US); TIMOTHY ALLAN BELL, WILMINGTON, DE (US); OLIVER WALTER GUTSCHE, WILMINGTON, DE (US); JOHN L. HUMPHREY, NEWARK, DE (US); KEITH W. HUTCHENSON, LINCOLN UNIVERSITY, PA (US); ROBERT D. ORLANDI, LANDENBERG, PA (US)

(73) Assignee: E.I. DU PONT DE NEMOURS AND COMPANY, WILMINGTON, DE (US)

(21) Appl. No.: 13/370,864

(22) Filed: Feb. 10, 2012

Related U.S. Application Data
(63) Continuation-in-part of application No. 12/854,449, filed on Aug. 11, 2010.
(60) Provisional application No. 61/441,836, filed on Feb. 11, 2011.

(51) Int. Cl. A23K 1/18; A23K 1/16

(52) U.S. Cl. 426/601

(57) ABSTRACT

A method of microbial cell disruption for use in making an aquaculture feed composition is disclosed, wherein a microbial biomass having a moisture level less than 10 weight percent and comprising oil-containing microbes is disrupted, resulting in a disruption efficiency of at least 30% of the oil-containing microbes to produce a disrupted microbial biomass, and, the disrupted microbial biomass is mixed with at least one aquaculture feed component to form an aquaculture feed composition.

### CROSS-REFERENCE TO RELATED APPLICATION

This patent application is a continuation-in-part of U.S. patent application Ser. No. 12/854,449, filed Aug. 11, 2010, now pending, the disclosure of which is herein incorporated by reference in its entirety. This application also claims the benefit of U.S. Provisional Application No. 61/441,836, filed Feb. 11, 2011, which is hereby incorporated by reference in its entirety.

### FIELD OF THE INVENTION

This invention is in the field of aquaculture. More specifically, this invention pertains to methods of microbial cell disruption for use in making improved aquaculture feed compositions.

### BACKGROUND OF THE INVENTION

Aquaculture is a form of agriculture that involves the propagation, cultivation and marketing of aquatic animals and plants in a controlled environment. The history of aquaculture in the United States can be traced back to the mid to late 19^{th} century, when pioneers began to supply brood fish, fingerlings and lessons in fish husbandry to would-be aquaculturists. Until the early 1960's, commercial fish culture in the United States was mainly restricted to rainbow trout, bait fish and a few warmwater species (e.g., buffaloes, bass and crappies).

The aquaculture industry is currently the fastest growing food production sector in the world. World aquaculture produces approximately 60 million tons of seafood, which is worth more than $70 billion (US) annually. Today, farmed fish accounts for approximately 50% of all fish consumed globally. This percentage is expected to increase, as a result of dwindling catches from capture fisheries in both marine and freshwater environments and increasing seafood consumption (i.e., total and per capita). Today, species groups in aquaculture production include, for example: carps and other cyprinids; oysters; clams, cockles and arkshells; shrimps and prawns; salmons, trouts and smelts; mussels; tilapias and other cichlids; and scallops and pectens.

While some aquacultured species (e.g., Tilapia) can be fed on an entirely vegetarian diet, many others species are fed a carnivorous diet. Typically, the feed for carnivorous fish comprises fishmeal and fish oil derived from wild caught species of small pelagic fish (predominantly anchovy, jack mackerel, blue whiting, capelin, sandeel and menhaden). These pelagic fish are processed into fishmeal and fish oil, with the final product often being either a pelleted or flaked feed, depending on the size of the fish (e.g., fry, juveniles, adults). The other components of the aquaculture feed composition may include vegetable protein, vitamins, minerals and pigment as required.

Marine fish oils have traditionally been used as the sole dietary lipid source in commercial fish feed given their ready availability, competitive price and the abundance of essential fatty acids contained within this product. Additionally, fish oils readily supply essential fatty acids which are required for regular growth, health, reproduction and bodily functions within fish. More specifically, all vertebrate species, including fish, have a dietary requirement for both omega-6 and omega-3 polyunsaturated fatty acids [“PUFAs”]. Eicosapentaenoic acid [“EPA”; cis-5,8,11,14,17-eicosapentaenoic acid; ω-3] and docosahexaenoic acid [“DHA”; cis-4,7,10,13,16,19-docosahexaenoic acid; 22:6 ω-3] are required for fish growth and health and are often incorporated into commercial fish feeds via addition of fish oils.

It is estimated that aquaculture feed compositions currently use about 87% of the global supply of fish oil as a lipid source. Since annual fish oil production has not increased beyond 1.5 million tons per year, the rapidly growing aquaculture industry cannot continue to rely on finite stocks of marine pelagic fish as a supply of fish oil. Thus, there is great urgency to find and implement sustainable alternatives to fish oil that can keep pace with the growing global demand for fish products.

Many organizations recognize the limitations noted above with respect to fish oil availability and aquaculture sustainability. For example, in the United States, the National Oceanic and Atmospheric Administration is partnering with the Department of Agriculture in an Alternative Feeds Initiative to “ . . . identify alternative dietary ingredients that will reduce the amount of fishmeal and fish oil contained in aquaculture fees while maintaining the important human health benefits of farmed seafood”.

U.S. Pat. No. 7,932,077 suggests recombinantly engineered Yarrowia lipolytica may be a useful addition to most animal feeds, including aquaculture feeds, as a means to provide necessary omega-3 and/or omega-6 PUFAs and based on its unique protein:lipid:carbohydrate composition, as well as unique complex carbohydrate profile (comprising an approximate 1:4:4.6 ratio of mannan:beta-glucans:chitin).

U.S. Pat. Appl. Pub. No. 2007/0226814 discloses fish food containing at least one biomass obtained from fermenting microorganisms wherein the biomass contains at least 20% DHA relative to the total fatty acid content. Preferred microorganisms used as sources for DHA are organisms belonging to the Stramenopiles.

U.S. Pat. Appl. Pub. No. 2009/0202672 discloses, inter alia, aquaculture feed incorporating oil obtained from a transgenic plant engineered to produce stearidonic acid [“SDA”; 18:4 (ω-3]. However, SDA is converted with low efficiency to DHA in fish.

If the growing aquaculture industry is to sustain its contribution to world fish supplies, then it needs to reduce wild fish inputs in feed and adopt more ecologically sound management practices.

### SUMMARY OF THE INVENTION

In one embodiment, the invention concerns a method of microbial cell disruption for use in making an aquaculture feed composition comprising:
(a) disrupting a microbial biomass, having a moisture level less than 10 weight percent and comprising oil-containing microbes, wherein said disruption results in a disruption efficiency of at least 30% of the oil-containing microbes to produce a disrupted microbial biomass; and,
(b) mixing said disrupted microbial biomass with at least one aquaculture feed component to form an aquaculture feed composition.

In a second embodiment, the disruption is performed with a twin screw extruder comprising:
(a) a total specific energy input (SEI) of about 0.04 to 0.4 KW/(kg/hr);
(b) compaction zone using bushing elements with progressively shorter pitch length; and,
(c) a compression zone using flow restriction;
   wherein the compaction zone is prior to the compression zone within the extruder. Preferably, the flow restriction is provided by reverse screw elements, restriction/blister ring elements or kneading elements.

In a third embodiment, the disrupted microbial biomass of step (b) is in the form of a solid pellet, said solid pellet produced by:
(i) blending the disrupted microbial biomass of step (a) with at least one binding agent to provide a fixable mix; and,
(ii) forming a solid pellet of disrupted microbial biomass from said fixable mix.
   Preferably, the at least one binding agent is selected from water and carbohydrates selected from the group consisting of: sucrose, lactose, fructose, glucose, and soluble starch.

In a fourth embodiment, the solid pellet comprises:
(a) about 0.5 to 20 weight percent binding agent; and,
(b) about 80 to 99.5 weight percent of disrupted biomass comprising oil-containing microbes;
   wherein the weight percents are based on the summation of (a) and (b) in the solid pellet.

In a fifth embodiment, the microbial biomass is obtained from at least one transgenic microbe engineered for the production of polyunsaturated fatty acid-containing microbial oil comprising EPA. The preferred transgenic microbe is Yarrowia lipolytica.

In a sixth embodiment, the bioavailability of the oil within the disrupted microbial biomass to the aquacultured species is proportional to the disruption efficiency of the process used to produce the disrupted microbial biomass.

In a seventh embodiment, the method of microbial cell disruption for use in making an aquaculture feed composition further comprises extruding said aquaculture feed composition into aquaculture feed pellets, wherein said aquaculture feed pellets are suitable for consumption by an aquacultured species.

### Biological Deposits

The following biological materials have been deposited with the American Type Culture Collection (ATCC), 10801 University Boulevard, Manassas, Va. 20110-2209, and bear the following designations, accession numbers and dates of deposit.

| Biological Material | Accession No. | Date of Deposit | |
|---|---|---|---|
| Yarrowia lipolytica Y4128 | ATCC PTA-8614 | Aug. 23, | 2007 |
| Yarrowia lipolytica Y8412 | ATCC PTA-10026 | May 14, | 2009 |
| Yarrowia lipolytica Y8259 | ATCC PTA-10027 | May 14, | 2009 |

The biological materials listed above were deposited under the terms of the Budapest Treaty on the International Recognition of the Deposit of Microorganisms for the Purposes of Patent Procedure. The listed deposits will be maintained in the indicated international depository for at least 30 years and will be made available to the public upon the grant of a patent disclosing it. The availability of a deposit does not constitute a license to practice the subject invention in derogation of patent rights granted by government action.

Yarrowia lipolytica Y4305 was derived from Y. lipolytica Y4128, according to the methodology described in U.S. Pat. Appl. Pub. No. 2009-0093543-A1. Yarrowia lipolytica Y9502 was derived from Y. lipolytica Y8412, according to the methodology described in U.S. Pat. Appl. Pub. No. 2010-0317072-A1. Similarly, Yarrowia lipolytica Y8672 was derived from Y. lipolytica Y8259, according to the methodology described in U.S. Pat. Appl. Pub. No. 2010-0317072-A1.

### BRIEF DESCRIPTION OF THE DRAWINGS AND SEQUENCE LISTING

FIG. 1 provides plasmid maps for the following: (A) pZKUM; and, (B) pZKL3-9DP9N.

The following sequences comply with 37 C.F.R. §1.821-1.825 (“Requirements for Patent Applications Containing Nucleotide Sequences and/or Amino Acid Sequence Disclosures—the Sequence Rules”) and are consistent with World Intellectual Property Organization (WIPO) Standard ST.25 (1998) and the sequence listing requirements of the EPO and PCT (Rules 5.2 and 49.5(a-bis), and Section 208 and Annex C of the Administrative Instructions). The symbols and format used for nucleotide and amino acid sequence data comply with the rules set forth in 37 C.F.R. §1.822.

SEQ ID NOs:1-8 are open reading frames encoding genes, proteins (or portions thereof), or plasmids, as identified in Table 1.

TABLE 1
Summary Of Nucleic Acid And Protein SEQ ID Numbers

| | Nucleic acid | Protein |
|---|---|---|
| Description | SEQ ID NO. | SEQ ID NO. |
| Plasmid pZKUM | 1 | — |
| | (4313 bp) | |
| Plasmid pZKL3-9DP9N | 2 | — |
| | (13,565 bp) | |
| Synthetic mutant delta-9 elongase, derived | 3 | 4 |
| from Euglena gracilis (“EgD9eS-L35G”) | (777 bp) | (258 AA) |
| Yarrowia lipolytica delta-9 desaturase gene | 5 | 6 |
| (Gen Bank Accession No. XM_501496) | (1449 bp) | (482 AA) |
| Yarrowia lipolytica choline-phosphate | 7 | 8 |
| cytidylyl- transferase gene (GenBank | (1101 bp) | (366 AA) |
| Accession No. XM_502978) | | |

### DETAILED DESCRIPTION

All patents, patent applications, and publications cited herein are incorporated by reference in their entirety.

In this disclosure, a number of terms and abbreviations are used. The following definitions are provided.

“Polyunsaturated fatty acid(s)” is abbreviated as “PUFA(s)”.

“Triacylglycerols” are abbreviated as “TAGs”.

“Total fatty acids” are abbreviated as “TFAs”.

“Fatty acid methyl esters” are abbreviated as “FAMEs”.

“Dry cell weight” is abbreviated as “DCW”.

As used herein the term “invention” or “present invention” is intended to refer to all aspects and embodiments of the invention as described in the claims and specification herein and should not be read so as to be limited to any particular embodiment or aspect.

The terms “aquaculture feed composition”, “aquaculture feed formulation”, “aquaculture feed” and “aquafeed” are used interchangeably herein. They refer to manufactured or artificial diets (i.e., formulated feeds) to supplement or to replace natural feeds in the aquaculture industry. These prepared foods are most commonly produced in flake, pellet or tablet form. Typically, an aquaculture feed composition refers to artificially compounded feeds that are useful for farmed finfish and crustaceans (i.e., both lower-value staple food fish species [e.g., freshwater finfish such as carp, tilapia and catfish] and higher-value cash crop species for luxury or niche markets [e.g., mainly marine and diadromous species such as shrimp, salmon, trout, yellowtail, seabass, seabream and grouper]). These formulated feeds are composed of several ingredients in various proportions complementing each other to form a nutritionally complete diet for the aquacultured species.

An aquaculture feed composition is used in the production of an “aquaculture product”, wherein the product is a harvestable aquacultured species (e.g., finfish, crustaceans), which is often sold for human consumption. For example, salmon are intensively produced in aquaculture and thus are aquaculture products.

The term “aquaculture feed pellet” is an aquaculture feed composition that has been molded, extruded or otherwise formed into a pellet and is thus suitable for consumption by an aquacultured species.

“Eicosapentaenoic acid” [“EPA”] is the common name for cis-5,8,11,14,17-eicosapentaenoic acid. This fatty acid is a 20:5 omega-3 fatty acid. The term EPA as used in the present disclosure will refer to the acid or derivatives of the acid (e.g., glycerides, esters, phospholipids, amides, lactones, salts or the like) unless specifically mentioned otherwise.

“Docosahexaenoic acid” [“DHA”] is the common name for cis-4,7,10,13,16,19-docosahexaenoic acid. This fatty acid is a 22:6 omega-3 fatty acid. The term DHA as used in the present disclosure will refer to the acid or derivatives of the acid (e.g., glycerides, esters, phospholipids, amides, lactones, salts or the like) unless specifically mentioned otherwise.

As used herein the term “biomass” refers to microbial cellular material produced from the fermentation of a recombinant production host producing EPA. Preferably, EPA is produced in commercially significant amounts. The preferred production host is a recombinant strain of the oleaginous yeast, Yarrowia lipolytica. The biomass may be in the form of whole cells, whole cell lysates, homogenized cells, partially hydrolyzed cellular material, and/or partially purified cellular material (e.g., microbially produced oil).

The term “processed biomass” refers to biomass that has been subjected to additional processing such as drying, pasterization, disruption, etc.

The term “disrupted microbial biomass” or “disrupted biomass” refers to microbial biomass that has been subjected to a process of disruption, wherein said disruption results in a disruption efficiency of at least 30% of the microbial biomass.

The term “disruption efficiency” refers to the percent of cells walls that have been fractured or ruptured during processing, as determined qualitatively by optical visualization or as determined quantitatively according to the following formula: % disruption efficiency=% free oil*100) divided by % total oil), wherein % free oil and % total oil are measured for the solid pellet. Increased disruption efficiency of the microbial biomass typically leads to increased extraction yields, bioavailability and/or bioabsorption of the microbial oil contained within the microbial biomass.

The term “percent total oil” refers to the total amount of all oil (e.g., including fatty acids from neutral lipid fractions [DAGs, MAGs, TAGs], free fatty acids, phospholipids, etc. present within cellular membranes, lipid bodies, etc.) that is present within a solid pellet sample. Percent total oil is effectively measured by converting all fatty acids within a pelletized sample that has been subjected to mechanical disruption, followed by methadolysis and methylation of acyl lipids. Thus, the sum of the fatty acids (expressed in triglyceride form) is taken to be the total oil content of the sample. In the present invention, percent total oil is preferentially determined by gently grinding a solid pellet into a fine powder using a mortar and pestle, and then weighing aliquots (in triplicate) for analysis. The fatty acids in the sample (existing primarily as triglycerides) are converted to the corresponding methyl esters by reaction with acetyl chloride/methanol at 80° C. A C15:0 internal standard is then added in known amounts to each sample for calibration purposes. Determination of the individual fatty acids is made by capillary gas chromatography with flame ionization detection (GC/FID). And, the sum of the fatty acids (expressed in triglyceride form) is taken to be the total oil content of the sample.

The term “percent free oil” refers to the amount of free and unbound oil (e.g., fatty acids expressed in triglyceride form, but not all phospholipids) that is readily available for extraction from a particular solid pellet sample. Thus, for example, an analysis of percent free oil will not include oil that is present in non-disrupted membrane-bound lipid bodies. In the present invention, percent free oil is preferentially determined by stirring a sample with n-heptane, centrifuging, and then evaporating the supernatant to dryness. The resulting residual oil is then determined gravimetrically and expressed as a weight percentage of the original sample.

The term “solid pellet” refers to a pellet having structural rigidity and resistance to changes of shape or volume. Solid pellets are formed herein from disrupted microbial biomass that has been blended with at least one binding agent via a process of “pelletization”. Typically, solid pellets have a final moisture level of about 0.1 to 5.0 weight percent, with a range about 0.5 to 3.0 weight percent more preferred.

The term “binding agent” refers to an agent that is blended with disrupted microbial biomass to yield a fixable mix. Preferably, the at least one binding agent is present at about 0.5 to 20 parts, based on 100 parts of microbial biomass. In some preferred embodiments, the binding agent is water. Other preferred properties of the binding agent are discussed infra.

The term “fixable mix” refers to the product obtained by blending at least one binding agent with disrupted microbial biomass. The fixable mix is a mixture capable of forming a solid pellet upon removal of solvent (e.g., removal of water in a drying step).

The term “bioavailability” and “bioadsorption” refer to the quantity or fraction of the microbial oil within an aquaculture feed composition (i.e., within the disrupted microbial biomass therein) that is available to be used or absorbed by the aquacultured species that consumes the aquaculture feed composition.

The term “oleaginous” refers to those organisms that tend to store their energy source in the form of lipid (Weete, In: Fungal Lipid Biochemistry, 2^{nd} Ed., Plenum, 1980). A class of plants identified as oleaginous are commonly referred to as “oilseed” plants. Examples of oilseed plants include, but are not limited to: soybean (Glycine and Soja sp.), flax (Linum sp.), rapeseed (Brassica sp.), maize, cotton, safflower (Carthamus sp.) and sunflower (Helianthus sp.).

Within oleaginous microorganisms the cellular oil or TAG content generally follows a sigmoid curve, wherein the concentration of lipid increases until it reaches a maximum at the late logarithmic or early stationary growth phase and then gradually decreases during the late stationary and death phases (Yongmanitchai and Ward, Appl. Environ. Microbiol. 57:419-25 (1991)).

The term “oleaginous yeast” refers to those microorganisms classified as yeasts that make oil. It is not uncommon for oleaginous microorganisms to accumulate in excess of about 25% of their dry cell weight as oil. Examples of oleaginous yeast include, but are no means limited to, the following genera: Yarrowia, Candida, Rhodotorula, Rhodosporidium, Cryptococcus, Trichosporon and Lipomyces.

The term “lipids” refer to any fat-soluble (i.e., lipophilic), naturally-occurring molecule. A general overview of lipids is provided in U.S. Pat. Appl. Pub. No. 2009-0093543-A1 (see Table 2 therein).

The term “oil” refers to a lipid substance that is liquid at 25° C. and usually polyunsaturated. In oleaginous organisms, oil constitutes a major part of the total lipid. “Oil” is composed primarily of triacylglycerols [“TAGs”] but may also contain other neutral lipids, phospholipids and free fatty acids. The fatty acid composition in the oil and the fatty acid composition of the total lipid are generally similar; thus, an increase or decrease in the concentration of PUFAs in the total lipid will correspond with an increase or decrease in the concentration of PUFAs in the oil, and vice versa.

The term “extracted oil” refers to an oil that has been separated from cellular materials, such as the microorganism in which the oil was synthesized. Extracted oils are obtained through a wide variety of methods, the simplest of which involves physical means alone. For example, mechanical crushing using various press configurations (e.g., screw, expeller, piston, bead beaters, etc.) can separate oil from cellular materials. Alternatively, oil extraction can occur via treatment with various organic solvents (e.g., hexane), via enzymatic extraction, via osmotic shock, via ultrasonic extraction, via supercritical fluid extraction (e.g., CO₂ extraction), via saponification and via combinations of these methods. An extracted oil does not require that it can not be further purified or concentrated.

“Fish oil” refers to oil derived from the tissues of an oily fish. Examples of oil fish include, but are not limited to: menhaden, anchovy, cod and the like. Fish oil is a typical component of feed used in aquaculture.

“Menhaden” refer to forage fish of the genera Brevoortia and Ethmidium, two genera of marine fish in the family Clupeidae. Recent taxonomic work using DNA comparisons have organized the North American menhadens into large-scaled (Gulf and Atlantic menhaden) and small-scaled (Finescale and Yellowfin menhaden) designations (Anderson, J. D., Fishery Bulletin, 105(3):368-378).

“Anchovies” from which anchovy fish meal and anchovy fish oil are produced, are a family (Engraulidae) of small, common salt-water forage fish. There are about 140 species in 16 genera, found in the Atlantic, Indian, and Pacific Oceans.

“Vegetable oil” refers to any edible oil obtained from a plant. Typically plant oil is extracted from seed or grain of a plant.

The term “triacylglycerols” [“TAGs”] refers to neutral lipids composed of three fatty acyl residues esterified to a glycerol molecule. TAGs can contain long chain PUFAs and saturated fatty acids, as well as shorter chain saturated and unsaturated fatty acids.

“Neutral lipids” refer to those lipids commonly found in cells in lipid bodies as storage fats and are so called because at cellular pH, the lipids bear no charged groups. Generally, they are completely non-polar with no affinity for water. Neutral lipids generally refer to mono-, di-, and/or triesters of glycerol with fatty acids, also called monoacylglycerol, diacylglycerol or triacylglycerol, respectively, or collectively, acylglycerols. A hydrolysis reaction must occur to release free fatty acids from acylglycerols.

The term “total fatty acids” [“TFAs”] herein refer to the sum of all cellular fatty acids that can be derivitized to fatty acid methyl esters [“FAMEs”] by the base transesterification method (as known in the art) in a given sample, which may be the biomass or oil, for example. Thus, total fatty acids include fatty acids from neutral lipid fractions (including diacylglycerols, monoacylglycerols and TAGs) and from polar lipid fractions (including, e.g., the phosphatidylcholine and phosphatidylethanolamine fractions) but not free fatty acids.

The term “total lipid content” of cells is a measure of TFAs as a percent of the dry cell weight [“DCW”], although total lipid content can be approximated as a measure of FAMEs as a percent of the DCW [“FAMEs % DCW”]. Thus, total lipid content [“TFAs % DCW”] is equivalent to, e.g., milligrams of total fatty acids per 100 milligrams of DCW.

The concentration of a fatty acid in the total lipid is expressed herein as a weight percent of TFAs (% TFAs), e.g., milligrams of the given fatty acid per 100 milligrams of TFAs. Unless otherwise specifically stated in the disclosure herein, reference to the percent of a given fatty acid with respect to total lipids is equivalent to concentration of the fatty acid as TFAs (e.g., % EPA of total lipids is equivalent to EPA % TFAs).

In some cases, it is useful to express the content of a given fatty acid(s) in a cell as its weight percent of the dry cell weight (% DCW). Thus, for example, eicosapentaenoic acid % DCW would be determined according to the following formula: (eicosapentaenoic acid % TFAs)*(TFAs % DCW)]/100. The content of a given fatty acid(s) in a cell as its weight percent of the dry cell weight (% DCW) can be approximated, however, as: (eicosapentaenoic acid % TFAs)*(FAMEs % DCW)]/100.

The terms “lipid profile” and “lipid composition” are interchangeable and refer to the amount of individual fatty acids contained in a particular lipid fraction, such as in the total lipid or the oil, wherein the amount is expressed as a weight percent of TFAs. The sum of each individual fatty acid present in the mixture should be 100.

The term “blended oil” refers to an oil that is obtained by admixing, or blending, the extracted oil described herein with any combination of, or individual, oil to obtain a desired composition. Thus, for example, types of oils from different microbes can be mixed together to obtain a desired PUFA composition. Alternatively, or additionally, the PUFA-containing oils disclosed herein can be blended with fish oil, vegetable oil or a mixture of both to obtain a desired composition.

The term “fatty acids” refers to long chain aliphatic acids (alkanoic acids) of varying chain lengths, from about C₁₂ to C₂₂, although both longer and shorter chain-length acids are known. The predominant chain lengths are between C₁₆ and C₂₂. The structure of a fatty acid is represented by a simple notation system of “X:Y”, where X is the total number of carbon [“C”] atoms in the particular fatty acid and Y is the number of double bonds. Additional details concerning the differentiation between “saturated fatty acids” versus “unsaturated fatty acids”, “monounsaturated fatty acids” versus “polyunsaturated fatty acids” [“PUFAs”], and “omega-6 fatty acids” [“ω-6” or “n-6”] versus “omega-3 fatty acids” [“ω-3” or “n-3”] are provided in U.S. Pat. No. 7,238,482, which is hereby incorporated herein by reference.

Nomenclature used to describe PUFAs herein is given in Table 1. In the column titled “Shorthand Notation”, the omega-reference system is used to indicate the number of carbons, the number of double bonds and the position of the double bond closest to the omega carbon, counting from the omega carbon, which is numbered 1 for this purpose. The remainder of the Table summarizes the common names of omega-3 and omega-6 fatty acids and their precursors, the abbreviations that will be used throughout the specification and the chemical name of each compound.

TABLE 1
Nomenclature of Polyunsaturated Fatty Acids And Precursors

| | | | Shorthand |
|---|---|---|---|
| Common Name | Abbreviation | Chemical Name | Notation |
| Myristic | — | tetradecanoic | 14:0 |
| Palmitic | Palmitate | hexadecanoic | 16:0 |
| Palmitoleic | — | 9-hexadecenoic | 16:1 |
| Stearic | — | octadecanoic | 18:0 |
| Oleic | — | cis-9-octadecenoic | 18:1 |
| Linoleic | LA | cis-9,12- | 18:2 omega-6 |
| | | octadecadienoic | |
| Gamma- | GLA | cis-6,9,12- | 18:3 omega-6 |
| Linolenic | | octadecatrienoic | |
| Eicosadienoic | EDA | cis-11,14- | 20:2 omega-6 |
| | | eicosadienoic | |
| Dihomo- | DGLA | cis-8,11,14- | 20:3 omega-6 |
| Gamma- | | eicosatrienoic | |
| Linolenic | | | |
| Arachidonic | ARA | cis-5,8,11,14- | 20:4 omega-6 |
| | | eicosatetraenoic | |
| Alpha-Linolenic | ALA | cis-9,12,15- | 18:3 omega-3 |
| | | octadecatrienoic | |
| Stearidonic | STA | cis-6,9,12,15- | 18:4 omega-3 |
| | | octadecatetraenoic | |
| Eicosatrienoic | ETrA | cis-11,14,17- | 20:3 omega-3 |
| | | eicosatrienoic | |
| Eicosa- | ETA | cis-8,11,14,17- | 20:4 omega-3 |
| tetraenoic | | eicosatetraenoic | |
| Eicosa- | EPA | cis-5,8,11,14,17- | 20:5 omega-3 |
| pentaenoic | | eicosapentaenoic | |
| Docosa- | DTA | cis-7,10,13,16- | 22:4 omega-6 |
| tetraenoic | | docosatetraenoic | |
| Docosa- | DPAn-6 | cis-4,7,10,13,16- | 22:5 omega-6 |
| pentaenoic | | docosapentaenoic | |
| Docosa- | DPA | cis-7,10,13,16,19- | 22:5 omega-3 |
| pentaenoic | | docosapentaenoic | |
| Docosa- | DHA | cis-4,7,10,13,16,19- | 22:6 omega-3 |
| hexaenoic | | docosahexaenoic | |

As used herein, “transgenic” or “genetically engineered” refers to a microbe, plant or a cell which comprises within its genome a heterologous polynucleotide. Preferably, the heterologous polynucleotide is stably integrated within the genome such that the polynucleotide is passed on to successive generations. The heterologous polynucleotide may be integrated into the genome alone or as part of an expression construct. Thus, transgenic is used herein to include any microbe, cell, cell line, and/or tissue, the genotype of which has been altered by the presence of heterologous nucleic acid.

“Fish meal” refers to a protein source for aquaculture feed compositions. Fish meals are typically either produced from fishery wastes associated with the processing of fish for human consumption (e.g., salmon, tuna) or produced from specific fish (i.e., herring, menhaden, pollack) which are harvested solely for the purpose of producing fish meal.

Aquaculture involves cultivating aquatic populations (e.g., freshwater and saltwater organisms) under controlled conditions. Organisms grown in aquaculture may include fish and crustaceans. Crustaceans are, for example, lobsters, crabs, shrimp, prawns and crayfish. The farming of finfish is the most common form of aquaculture. It involves raising fish commercially in tanks, ponds, or ocean enclosures, usually for food. A facility that releases juvenile fish into the wild for recreational fishing or to supplement a species' natural numbers is generally referred to as a fish hatchery. Particularly of interest are fish of the salmonid group, for example, cherry salmon (Oncorhynchus masou), Chinook salmon (O. tshawytscha), chum salmon (O. keta), coho salmon (O. kisutch), pink salmon (O. gorbuscha), sockeye salmon (O. nerka) and Atlantic salmon (Salmo salar). Other finfish of interest for aquaculture include, but are not limited to, various trout, as well as whitefish such as tilapia (including various species of Oreochromis, Sarotherodon, and Tilapia), grouper (subfamily Epinephelinae), sea bass, catfish (order Siluriformes), bigeye tuna (Thunnus obesus), carp (family Cyprimidae) and cod (genus Gadus).

Aquaculture typically requires a prepared aquaculture feed composition to meet dietary requirements of the cultured animals. Dietary requirements of different aquaculture species vary, as do the dietary requirements of a single species during different stages of growth. Thus, tremendous research is invested towards optimizing each aquaculture feed composition for each stage of growth of a cultured organism.

As an example, one can consider the 6-phase life cycle of salmon. In the wild, the salmon life cycle begins with the fertilization of spawned eggs. The eggs hatch into “alevin”, which live off the nutritious yolk sac that hangs off their undersides for several months. Then, alevin develop into “fry”, which feed mainly on zooplankton until they grow large enough to eat aquatic insects and other larger foods. When the fry are several months to 1 year old, they develop very noticeable markings along their flanks. They are then termed salmon “parr”, which feed mainly on freshwater terrestrial and aquatic insects, amphipods, worms, crustaceans, amphibian larvae, fish eggs, and young fish for 1 to 3 years. The process of smolting, which normally occurs when the fish are 12-18 months old, enables the “smolts” to transition from a freshwater environment to open salt water seas. Adult salmon feed on smaller fish, such as herring, sandeels, pelagic amphipods and krill while in the open ocean; they will return to the rivers in which they were born after being at sea for 1-4 yr.

In aquaculture, salmon are typically farmed in two stages. In the first stage, fish are hatched from eggs and raised in freshwater tanks for 12-18 months to the smolt stage. Alternatively, spawning channels, or artificial streams, may be used in the first stage. In the second stage, the smolts are transferred to floating sea cages or net pens which are anchored in bays or fjords along a coast. Cages or pens are provided with feed delivery equipment. Aquacultured animals may be fed different aquaculture feed compositions that are formulated to meet the changing nutrient requirements needed during different stages of growth (Handbook of Salmon Farming; Stead and Laird (eds) (2002) Praxis Publishing Ltd., Chichester, UK). The present aquaculture feed compositions may be fed to animals to support their growth by any method of aquaculture known by one skilled in the art (“Food for Thought: the Use of Marine Resources in Fish Feed” Editor: Tveferaas, head of conservation, WWF-Norway, Report #02/03 (February 2003)).

Once the aquaculture animals reach an appropriate size, the crop is harvested, processed to meet consumer requirements, and can be shipped to market, generally arriving within hours of leaving the water.

For example, a common harvesting method for aquacultured fish is to use a sweep net, which operates a bit like a purse seine net. The sweep net is a big net with weights along the bottom edge. It is stretched across the pen with the bottom edge extending to the bottom of the pen. Lines attached to the bottom corners are raised, herding some fish into the purse, where they are netted. More advanced systems use a percussive-stun harvest system that kills the fish instantly and humanely with a blow to the head from a pneumatic piston. They are then bled by cutting the gill arches and immediately immersed in iced water. Harvesting and killing methods are designed to minimize scale loss, and avoid the fish releasing stress hormones, which negatively affect flesh quality.

To produce a salmon of harvestable size (i.e., 2.5-4 kg), appropriate aquaculture feed compositions may be formulated as appropriate over the dietary cycles of the salmon. Commercial feeds generally rely on available supplies of fish oil to provide energy and specific fatty acid requirements for aquacultured fish. Generally, it takes between 3-7 kg, with the average around 5 kg, of captured pelagic fish to provide the fish oil necessary to produce one kg of salmon. Thus, the limited global supply of fish oil will ultimately limit growth of aquaculture industries. Additionally, removal of large numbers of smaller species of fish from the food chain can have adverse ecosystem affects.

Aquaculture feed compositions are composed of micro and macro components. In general, all components, which are used at levels of more than 1%, are considered as macro components. Feed ingredients used at levels of less than 1% are micro components. They have to be premixed to achieve a homogeneous distribution of the micro components in the complete feed. Both macro and micro ingredients are subdivided into components with nutritional functions and technical functions. Components with technical functions improve the physical quality of the aquaculture feed composition or its appearance.

Macro components with nutritional functions provide aquatic animals with protein and energy required for growth and performance. With respect to fish, the aquaculture feed composition should ideally provide the fish with: 1) fats, which serve as a source of fatty acids for energy (especially for heart and skeletal muscles); and, 2) amino acids, which serve as building blocks of proteins. Fats also assist in vitamin absorption; for example, vitamins A, D, E and K are fat-soluble or can only be digested, absorbed, and transported in conjunction with fats. Carbohydrates, typically of plant origin (e.g., wheat, sunflower meal, corn gluten, soybean meal), are also often included in the feed compositions, although carbohydrates are not a superior energy source for fish over protein or fat.

Fats are typically provided via incorporation of fish meals (which contain a minor amount of fish oil) and fish oils into the aquaculture feed compositions. Extracted oils that may be used in aquaculture feed compositions include fish oils (e.g., from the oily fish menhaden, anchovy, herring, capelin and cod liver), and vegetable oil (e.g., from soybeans, rapeseeds, sunflower seeds and flax seeds). Typically, fish oil is the preferred oil, because it contains the long chain omega-3 polyunsaturated fatty acids [“PUFAs”], EPA and DHA; in contrast, vegetable oils do not provide a source of EPA and/or DHA. These PUFAs are needed for growth and health of most aquaculture products. A typical aquaculture feed composition will comprise from about 15-30% of oil (e.g., fish, vegetable, etc.), measured as a weight percent of the aquaculture feed composition.

The amount of EPA (as a percent of total fatty acids [“% TFAs”]) and DHA % TFAs provided in typical fish oils varies, as does the ratio of EPA to DHA. Typical values are summarized in Table 2, based on the work of Turchini, Torstensen and Ng (Reviews in Aquaculture 1:10-57 (2009)):

TABLE 2
Typical EPA And DHA Content In Various Fish Oils

| Fish Oil | EPA | DHA | EPA:DHA Ratio |
|---|---|---|---|
| Anchovy oil | 17% | 8.8% | 1.93 |
| Capelin oil | 4.6% | 3.0% | 1.53 |
| Menhaden oil | 11% | 9.1% | 1.21 |
| Herring oil | 8.4% | 4.9% | 1.71 |
| Cod liver oil | 11.2% | 12.6% | 0.89 |

Often, oil from fish that are have lower EPA:DHA ratios is used in aquaculture feed compositions, due to the lower cost. Anchovy oil has the highest EPA:DHA ratio; however, using this oil as the sole oil source in an aquaculture feed composition would result in an EPA:DHA ratio of less than 2:1 in the final formulation.

The protein supplied in aquaculture feed compositions can be of plant or animal origin. For example, protein of animal origin can be from marine animals (e.g., fish meal, fish oil, fish protein, krill meal, mussel meal, shrimp peel, squid meal, squid oil, etc.) or land animals (e.g., blood meal, egg powder, liver meal, meat meal, meat and bone meal, silkworm, pupae meal, whey powder, etc.). Protein of plant origin can include vegetable oil, lecithin, rice and the like.

The technical functions of macro components are overlapping as, for example, wheat gluten may be used as a pelleting aid and for its protein content, which has a relatively high nutritional value. There can also be mentioned guar gum and wheat flour.

Micro components include feed additives such as vitamins, trace minerals, feed antibiotics and other biologicals. Minerals used at levels of less than 100 mg/kg (100 ppm) are considered as micro minerals or trace minerals.

Micro components with nutritional functions are all biologicals and trace minerals. They are involved in biological processes and are needed for good health and high performance. There can be mentioned vitamins such as vitamins A, E, K₃, D₃, B₁, B₃, B₆, B₁₂, C, biotin, folic acid, panthothenic acid, nicotinic acid, choline chloride, inositiol, para-amino-benzoic acid. There can be mentioned minerals such as salts of calcium, cobalt, copper, iron, magnesium, phosophorus, potasium, selenium and zinc. Other components may include, but are not limited to, antioxidants, beta-glucans, bile salt, cholesterol, enzymes, monosodium glutamate, etc.

The technical functions of micro ingredients are mainly related to pelleting, detoxifying, mould prevention, antioxidation, etc.

Nutrient Requirements of Fish (National Research Council, National Academy: Washington D.C., 1993) provides detailed descriptions of the essential nutrients for fish and the nutrient content of various ingredients. One is also referred to Handbook on Ingredients for Aquaculture Feeds (Hertrampf, J. W. and F. Piedad-Pascual. Kluwer Academic: Dordrecht, The Netherlands, 2000) and Standard Methods for the Nutrition and Feeding of Farmed Fish and Shrimp (Tacon, A. G. J. Argent Laboratories: Redmond, 1990) as additional resources to aid determination of the most appropriate ingredients to include in an aquaculture feed composition, in addition to the microbial biomass described herein.

The present invention concerns a sustainable alternative to fish oil. Specifically, the invention concerns an aquaculture feed composition comprising: (a) at least one source of EPA and optionally at least one source of DHA, wherein said source can be the same or different; and, (b) a ratio of concentration of EPA to concentration of DHA which is greater than 2:1 based on the individual concentrations of EPA and DHA, each measured as a weight percent of total fatty acids in the aquaculture feed composition.

The aquaculture feed composition may further comprise a total amount of EPA and DHA that is at least about 0.8%, measured as weight percent of the aquaculture feed composition. This amount (i.e., 0.8%) is typically an appropriate minimal concentration that is suitable to support the growth of a variety of animals grown in aquaculture, and particularly is suitable for inclusion in the diets of salmonid fish.

As previously discussed, the highest EPA:DHA ratio in fish oil (i.e., anchovy oil) was 1.93:1 (Turchini, Torstensen and Ng, supra). Thus, it is believed that no commercially available aquaculture feed composition has been produced having an EPA:DHA ratio greater than 1.93:1. To achieve an EPA:DHA ratio greater than 2:1, as described herein, an alternate source of EPA (and optionally DHA) is required. If no DHA is present in the aquaculture feed composition, then the EPA:DHA ratio may be considered to be greater than 2:1.

In preferred embodiments of the invention herein, the aquaculture feed composition comprises a microbial oil comprising EPA. This may optionally be used in combination with fish oil or fish meal (thereby effectively reducing the total amount of fish oil or fish meal that is required in the feed formulation, while maintaining desired EPA content). The microbial oil comprising EPA may also contain DHA; or, DHA may be obtained from a second microbial oil, fish oil, fish meal, and combinations thereof. In some formulations, the microbial oil comprising EPA may be supplemented with a vegetable oil, to reach the desired total oil/fat content.

EPA can be produced microbially via numerous different processes, based on the natural abilities of the specific microbial organism utilized [e.g., heterotrophic diatoms Cyclotella sp. and Nitzschia sp. (U.S. Pat. No. 5,244,921); Pseudomonas, Alteromonas or Shewanella species (U.S. Pat. No. 5,246,841); filamentous fungi of the genus Pythium (U.S. Pat. No. 5,246,842); or Mortierella elongata, M. exigua, or M. hygrophila (U.S. Pat. No. 5,401,646)]. One of skill in the art will be able to identity other microbes which have the native ability to produce EPA, based on phenotypic analysis, GC analysis of the PUFA products, review of available public and patent literature and screening of microbes related to those previously identified as EPA-producers. Microbial oils comprising EPA from these organisms may be provided in a variety of forms for use in the aquaculture feed compositions herein, wherein the oil is typically contained within microbial biomass or processed biomass, or the oil is partially purified or purified oil. In most cases, it will be most cost effective to incorporate microbial biomass or processed biomass into the aquaculture feed composition, as opposed to the microbial oil (in partial or purified form); however, these economics should not be considered as a limitation herein.

Alternately, microbial oil comprising EPA can be produced in transgenic microbes engineered for the production of polyunsaturated fatty acid-containing microbial oil comprising EPA. Microbes such as algae, fungi, yeast, stramenopiles and bacteria may be engineered for production of PUFAs, including EPA, by integration of appropriate heterologous genes encoding desaturases and elongases of either the delta-6 desaturase/delta-6 elongase pathway or the delta-9 elongase/delta-8 desaturase pathway into the host organism. The particular genes included within a particular expression cassette depend on the host organism, its PUFA profile and/or desaturase/elongase profile, the availability of substrate and the desired end product(s). A PUFA polyketide synthase [“PKS”] system that produces EPA, such as that found in e.g., Shewanella putrefaciens (U.S. Pat. No. 6,140,486), Shewanella olleyana (U.S. Pat. No. 7,217,856), Shewanella japonica (U.S. Pat. No. 7,217,856) and Vibrio marinus (U.S. Pat. No. 6,140,486), could also be introduced into a suitable microbe to enable EPA, and optionally DHA, production. Other PKS systems that natively produce DHA could also be engineered to enable only EPA or a suitable combination of the PUFAs to yield an EPA:DHA ratio of greater than 2:1.

One skilled in the art is familiar with the considerations and techniques necessary to introduce one or more expression cassettes encoding appropriate enzymes for EPA biosynthesis into a microbial host organism of choice, and numerous teachings are provided in the literature to one of skill. Microbial oils comprising EPA from these genetically engineered organisms may also be suitable for use in the aquaculture feed compositions herein, wherein the oil may be contained within the microbial biomass or processed biomass, or the oil may be partially purified or purified oil.

In some applications, the microbe engineered for EPA production is is oleaginous, i.e., the organism tends to store its energy source in the form of lipid (Weete, In: Fungal Lipid Biochemistry, 2^{nd} Ed., Plenum, 1980). Oleaginous yeast are a preferred microbe, as these microorganisms can commonly accumulate in excess of about 25% of their dry cell weight as oil. Examples of oleaginous yeast include, but are by no means limited to, the following genera: Yarrowia, Candida, Rhodotorula, Rhodosporidium, Cryptococcus, Trichosporon and Lipomyces. More specifically, illustrative oil-synthesizing yeasts include: Rhodosporidium toruloides, Lipomyces starkeyii, L. lipoferus, Candida revkaufi, C. pulcherrima, C. tropicalis, C. utilis, Trichosporon pullans, T. cutaneum, Rhodotorula glutinus, R. graminis, and Yarrowia lipolytica (formerly classified as Candida lipolytica). Most preferred is the oleaginous yeast Yarrowia lipolytica. Examples of suitable Y. lipolytica strains include, but are not limited to, Y. lipolytica strains designated as ATCC #20362, ATCC #8862, ATCC #18944, ATCC #76982 and/or LGAM S(7)1 (Papanikolaou S., and Aggelis G., Bioresour. Technol. 82(1):43-9 (2002)).

Some references describing means to engineer the oleaginous host organism Yarrowia lipolytica for EPA biosynthesis are provided as follows: U.S. Pat. No. 7,238,482, U.S. Pat. No. 7,550,286, U.S. Pat. Appl. Pub. No. 2006-0115881-A1, U.S. Pat. Appl. Pub. No. 2009-0093543-A1, U.S. Pat. Pub. No. 2010-0317072-A1 and U.S. Pat. Pub. No. 2010-0317736-A1. This list is not exhaustive and should not be construed as limiting.

It may be desirable for the oleaginous yeast to be capable of “high-level EPA production”, wherein the organism can produce at least about 5-10% of EPA in the total lipids. More preferably, the oleaginous yeast will produce at least about 10-25% of EPA in the total lipids, more preferably at least about 25-35% of EPA in the total lipids, more preferably at least about 35-45% of EPA in the total lipids, more preferably at least about 45-55% of EPA in the total lipids, and most preferably at least about 55-60% of EPA in the total lipids. The structural form of the EPA is not limiting; thus, for example, EPA may exist in the total lipids as free fatty acids or in esterified forms such as acylglycerols, phospholipids, sulfolipids or glycolipids.

For example, U.S. Pat. Appl. Pub. No. 2009-0093543-A1 describes high-level EPA production in optimized recombinant Yarrowia lipolytica strains. Specifically, strains are disclosed having the ability to produce microbial oils comprising at least about 43.3 EPA % TFAs, with less than about 23.6 LA % TFAs (an EPA:LA ratio of 1.83) and less than about 9.4 oleic acid (18:1) % TFAs. The preferred strain was Y4305, whose maximum production was 55.6 EPA % TFAs, with an EPA:LA ratio of 3.03. Generally, the EPA-producing strains of U.S. Pat. Appl. Pub. No. 2009-0093543-A1 comprised the following genes of the omega-3/omega-6 fatty acid biosynthetic pathway: a) at least one gene encoding delta-9 elongase; b) at least one gene encoding delta-8 desaturase; c) at least one gene encoding delta-5 desaturase; d) at least one gene encoding delta-17 desaturase; e) at least one gene encoding delta-12 desaturase; f) at least one gene encoding C_{16/18} elongase; and, g) optionally, at least one gene encoding diacylglycerol cholinephosphotransferase [“CPT1”]. Since the pathway is genetically engineered into the host cell, there is no DHA concomitantly produced due to the lack of the appropriate enzymatic activities for elongation of EPA to DPA (catalyzed by a C_{20/22} elongase) and desaturation of DPA to DHA (catalyzed by a delta-4 desaturase). The disclosure also described microbial oils obtained from these engineered yeast strains and oil concentrates thereof.

A derivative of Yarrowia lipolytica strain Y4305 is described herein, known as Y. lipolytica strain Y4305 F1B1. Upon growth in a two liter fermentation (parameters similar to those of U.S. Pat. Appl. Pub. No. 2009-009354-A1, Example 10), average EPA productivity [“EPA % DCW”] for strain Y4305 was 50-56, as compared to 50-52 for strain Y4305-F1B1. Average lipid content [“TFAs % DCW”] for strain Y4305 was 20-25, as compared to 28-32 for strain Y4305-F1B1. Thus, lipid content was increased 29-38% in strain Y4503-F1B1, with minimal impact upon EPA productivity.

More recently, U.S. Pat. Pub. No. 2010-0317072-A1 and U.S. Pat. Pub. No. 2010-0317735-A1 teach optimized strains of recombinant Yarrowia lipolytica having the ability to produce further improved microbial oils relative to those strains described in U.S. Pat. Appl. Pub. No. 2009-0093543-A1, based on the EPA % TFAs and the ratio of EPA:LA. In addition to expressing genes of the omega-3/omega-6 fatty acid biosynthetic pathway as detailed in U.S. Pat. Appl. Pub. No. 2009-0093543-A1, these improved strains are distinguished by: a) comprising at least one multizyme, wherein said multizyme comprises a polypeptide having at least one fatty acid delta-9 elongase linked to at least one fatty acid delta-8 desaturase [a “DGLA synthase”]; b) optionally comprising at least one polynucleotide encoding an enzyme selected from the group consisting of a malonyl CoA synthetase or an acyl-CoA lysophospholipid acyltransferase [“LPLAT”]; c) comprising at least one peroxisome biogenesis factor protein whose expression has been down-regulated; d) producing at least about 50 EPA % TFAs; and, e) having a ratio of EPA:LA of at least about 3.1.

Specifically, in addition to possessing at least about 50 EPA TFAs, the lipid profile within the improved optimized strains of Yarrowia lipolytica of U.S. Pat. Pub. No. 2010-0317072-A1 and U.S. Pat. Pub. No. 2010-0317735-A1, or within extracted or unconcentrated oil therefrom, will have a ratio of EPA % TFAs to LA % TFAs of at least about 3.1. Lipids produced by the improved optimized recombinant Y. lipolytica strains are also distinguished as having less than 0.5% GLA or DHA (when measured by GC analysis using equipment having a detectable level down to about 0.1%) and having a saturated fatty acid content of less than about 8%. This low percent of saturated fatty acids (i.e., 16:0 and 18:0) benefits both humans and animals.

Thus, it is considered that the EPA oils described above from genetically engineered strains of Yarrowia lipolytica are substantially free of DHA, low in saturated fatty acids and high in EPA. Example 6 herein provides a summary of some representative strains of Y. lipolytica engineered to produce high levels of EPA. Furthermore, the cited art provides numerous examples of additional suitable microbial strains and species, comprising EPA and having an EPA:DHA ratio of greater than 2:1. It is also contemplated herein that any of these microbes could be subjected to further genetic engineering improvements and thus be a suitable source of EPA in the aquaculture feed compositions and methods described herein.

The aquaculture feed compositions of the present invention optionally comprise at least one source of DHA (i.e., in addition to the at least one source of EPA discussed supra). The source of DHA can be the same or different than that of EPA, although the ratio of EPA:DHA must be greater than 2:1 based on the individual concentrations of EPA and DHA, each measured as a weight percent of total fatty acids in the aquaculture feed composition.

In preferred embodiments, at least one source of DHA is selected from the group consisting of: microbial oil, fish oil, fish meal, and combinations thereof.

Fish oil is typically a source of DHA, as well as of EPA, in aquaculture feed compositions (Table 2, supra). Fish meal is also often incorporated into aquaculture feed compositions as a protein source. Since this is a fish product, the meals have a low oil content and thereby can provide a small portion of PUFAs to the total aquaculture feed composition, in addition to that provided directly as fish oil.

DHA can be produced using processes based on the natural abilities of native microbes. See, e.g., processes developed for Schizochytrium species (U.S. Pat. No. 5,340,742; U.S. Pat. No. 6,582,941); Ulkenia (U.S. Pat. No. 6,509,178); Pseudomonas sp. YS-180 (U.S. Pat. No. 6,207,441); Thraustochytrium genus strain LFF1 (U.S. 2004/0161831 A1); Crypthecodinium cohnii (U.S. Pat. Appl. Pub. No. 2004/0072330 A1; de Swaaf, M. E. et al. Biotechnol Bioeng., 81(6):666-72 (2003) and Appl Microbiol Biotechnol., 61(1):40-3 (2003)); Emiliania sp. (Japanese Patent Publication (Kokai) No. 5-308978 (1993)); and Japonochytrium sp. (ATCC #28207; Japanese Patent Publication (Kokai) No. 199588/1989)]. Additionally, the following microorganisms are known to have the ability to produce DHA: Vibrio marinus (a bacterium isolated from the deep sea; ATCC #15381); the micro-algae Cyclotella cryptica and Isochrysis galbana; and, flagellate fungi such as Thraustochytrium aureum (ATCC #34304; Kendrick, Lipids, 27:15 (1992)) and the Thraustochytrium sp. designated as ATCC #28211, ATCC #20890 and ATCC #20891. Currently, there are at least three different fermentation processes for commercial production of DHA: fermentation of C. cohnii for production of DHASCO™ (Martek Biosciences Corporation, Columbia, Md.); fermentation of Schizochytrium sp. for production of an oil formerly known as DHAGold (Martek Biosciences Corporation); and fermentation of Ulkenia sp. for production of DHActive™ (Nutrinova, Frankfurt, Germany). As such, microbial oils comprising DHA from any of these organisms may be provided in a variety of forms for use in the aquaculture feed compositions herein, wherein the oil is typically contained within microbial biomass or processed biomass, or the oil is partially purified or purified oil.

Similarly, means to genetically engineer a microbe such that it is capable of DHA production will be well known to one of skill in the art. Only two additional enzymatic steps are required to convert EPA to DHA and thus integration of appropriate heterologous genes encoding C₂₀₋₂₂ elongase and delta-4 desaturase will be readily possible, using the teachings described above for engineering EPA.

Of particular import, the microbial oil may comprise a mixture of EPA and DHA to achieve the most desired ratio of EPA:DHA in the final aquaculture feed composition. Based on an increasing emphasis on the ability to engineer microorganisms for production of “designer” lipids and oils, wherein the fatty acid content and composition are carefully specified by genetic engineering for a variety of purposes, it is contemplated that a suitable microbe could be engineered producing a combination of EPA and DHA. For example, one is referred to U.S. Pat. No. 7,550,286, wherein recombinant Yarrowia lipolytica strains are disclosed having the ability to produce microbial oils comprising at least about 4.7 EPA % TFAs, 18.3 DPA % TFAs and 5.6 DHA % TFAs. Although this particular example fails to provide a microbial oil having an EPA:DHA ratio of greater than 2:1, subsequent genetic engineering could readily modify the overall lipid profile. Or, this microbial oil could be mixed with microbial oil from an alternate Y. lipolytica strain producing high EPA to achieve the preferred target ratio. One of skill in the art will readily appreciate the numerous alternatives that are disclosed herein, as a means to obtain a microbial oil comprising at least one source of EPA and optionally at least one source of DHA, wherein the EPA:DHA ratio is greater than 2:1.

When a microbe (or combination of microbes) are used in the present invention as a source of EPA and/or DHA, the microbe will be grown under standard conditions well known by one skilled in the art of microbiology or fermentation science to optimize the production of the PUFA. With respect to genetically engineered microbes, the microbe will be grown under conditions that optimize expression of chimeric genes (e.g., encoding desaturases, elongases, acyltransferases, etc.) and produce the greatest and the most economical yield of EPA and/or DHA. Thus, a genetically engineered microbe producing lipids containing the desired PUFA may be cultured and grown in a fermentation medium under conditions whereby the PUFA is produced by the microorganism. Typically, the microorganism is fed with a carbon and nitrogen source, along with a number of additional chemicals or substances that allow growth of the microorganism and/or production of the PUFA. The fermentation conditions will depend on the microorganism used and may be optimized for a high content of the PUFA in the resulting biomass.

In general, media conditions may be optimized by modifying the type and amount of carbon source, the type and amount of nitrogen source, the carbon-to-nitrogen ratio, the amount of different mineral ions, the oxygen level, growth temperature, pH, length of the biomass production phase, length of the oil accumulation phase and the time and method of cell harvest.

More specifically, fermentation media should contain a suitable carbon source, such as are taught in U.S. Pat. No. 7,238,482 and U.S. Pat. Pub. No. 2009-0325265-A1. Although it is contemplated that the source of carbon utilized for growth of an engineered EPA-producing microbe may encompass a wide variety of carbon-containing sources, preferred carbon sources are sugars, glycerol and/or fatty acids. Most preferred are glucose, sucrose, invert sucrose, fructose and/or fatty acids containing between 10-22 carbons. For example, the fermentable carbon source can be selected from the group consisting of invert sucrose (i.e., a mixture comprising equal parts of fructose and glucose resulting from the hydrolysis of sucrose), glucose, fructose and combinations of these, provided that glucose is used in combination with invert sucrose and/or fructose.

Nitrogen may be supplied from an inorganic (e.g., (NH₄)₂SO₄) or organic (e.g., urea or glutamate) source. In addition to appropriate carbon and nitrogen sources, the fermentation media must also contain suitable minerals, salts, cofactors, buffers, vitamins and other components known to those skilled in the art suitable for the growth of the EPA-producing microbe and promotion of the enzymatic pathways necessary for EPA production. Particular attention is given to several metal ions (e.g., Fe⁺², Cu⁺², Mn⁺², Co⁺², Zn⁺² and Mg⁺²) that promote synthesis of lipids and PUFAs (Nakahara, T. et al., Ind. Appl. Single Cell Oils, D. J. Kyle and R. Colin, eds. pp 61-97 (1992)).

Preferred growth media are common commercially prepared media, such as Yeast Nitrogen Base (DIFCO Laboratories, Detroit, Mich.). Other defined or synthetic growth media may also be used and the appropriate medium for growth of Yarrowia lipolytica will be known by one skilled in the art of microbiology or fermentation science. A suitable pH range for the fermentation is typically between about pH 4.0 to pH 8.0, wherein pH 5.5 to pH 7.5 is preferred as the range for the initial growth conditions. The fermentation may be conducted under aerobic or anaerobic conditions.

Typically, accumulation of high levels of PUFAs in oleaginous yeast cells requires a two-stage process, since the metabolic state must be “balanced” between growth and synthesis/storage of fats. Thus, most preferably, a two-stage fermentation process is necessary for the production of EPA in Yarrowia lipolytica. This approach is described in U.S. Pat. No. 7,238,482, as are various suitable fermentation process designs (i.e., batch, fed-batch and continuous) and considerations during growth.

When the desired amount of EPA and/or DHA has been produced by the microorganism, the fermentation medium may be treated to obtain microbial biomass comprising the PUFA. For example, the fermentation medium may be filtered or otherwise treated to remove at least part of the aqueous component. Preferably, a portion of the water is removed from the untreated microbial biomass after microbial fermentation to provide a microbial biomass with a moisture level of less than 10 weight percent, more preferably a moisture level of less than 5 weight percent, and most preferably a moisture level of 3 weight percent or less. The microbial biomass moisture level can be controlled in drying. Preferably the microbial biomass has a moisture level in the range of about 1 to 10 weight percent.

Optionally, the fermentation medium and/or the microbial biomass may be further processed, for example the microbial biomass may be pasteurized or treated via other means to reduce the activity of endogenous microbial enzymes that can harm the microbial oil and/or PUFA products.

Step (a) of the present invention comprises a step of disrupting a microbial biomass, having a moisture level less than 10 weight percent and comprising oil-containing microbes, wherein said disruption results in a disruption efficiency of at least 30% of the oil-containing microbes to produce a disrupted microbial biomass.

More preferably, the disrupting provides a disrupted microbial biomass having a disruption efficiency of at least 40-60%, more preferably at least 60-75% and most preferably 75-90% or more, of the oil-containing microbes. Although preferred ranges are described above, useful examples of disruption efficiencies include any integer percentage from 30% to 100%, such as 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98% or 99% disruption efficiency.

The disruption efficiency refers to the percent of cells walls that have been fractured or ruptured during processing, as determined qualitatively by optical visualization or as determined quantitatively according to the following formula: % disruption efficiency=% free oil*100) divided by % total oil), wherein % free oil and % total oil are measured for the solid pellet.

A solid pellet that has been not subjected to a process of disruption (e.g., mechanical crushing using e.g., screw extrusion, an expeller, pistons, bead beaters, mortar and pestle, Hammer-milling, air-jet milling, etc.) will typically have a low disruption efficiency since fatty acids within DAGs, MAGs and TAGs, phosphatidylcholine and phosphatidylethanolamine fractions and free fatty acids, etc. are generally not extractable from the microbial biomass until a process of disruption has broken both cell walls and internal membranes of various organelles, including membranes surrounding lipid bodies. Various processes of disruption will result in various disruption efficiencies, based on the particular shear, compression, static and dynamic forces inherently produced in the process.

Increased disruption efficiency of the microbial biomass typically leads to increased extraction yields (e.g., as measured by the weight percent of crude extracted oil), likely since more of the microbial oil is susceptible to the presence of the extraction solvents(s) with disruption of cell walls and membranes. It is assumed that increased disruption efficiency also leads to increased bioavailability/bioabsorption efficiency of the microbial oil within the aquaculture feed composition to the organism consuming the aquaculture feed composition (i.e., disruption efficiency appears to be proportional to bioavailability of the oil).

Although a variety of equipment may be utilized to produce the disrupted microbial biomass, preferably the disrupting is performed in a twin screw extruder. More specifically, the twin screw extruder preferably comprises: (i) a total specific energy input (SEI) in the extruder of about 0.04 to 0.4 KW/(kg/hr), more preferably 0.05 to 0.2 KW/(kg/hr) and most preferably about 0.07 to 0.15 KW/(kg/hr); (ii) a compaction zone using bushing elements with progressively shorter pitch length; and, (iii) a compression zone using flow restriction. Most of the mechanical energy required for cell disruption is imparted in the compression zone, which is created using flow restriction e.g., the form of reverse screw elements, restriction/blister ring elements or kneading elements. The compaction zone is prior to the compression zone within the extruder. A first zone of the extruder may be present to feed and transport the biomass into the compaction zone.

Preferably the disrupting provides a disrupted biomass mix having a temperature of 90° C. or less, and more preferably 70° C. or less.

Step (b) of the present invention comprises a step of mixing the disrupted microbial biomass with at least one aquaculture feed component (e.g., macro components such as proteins, fats, carbohydrates, etc. and micro components, as discussed above) to form an aquaculture feed composition. For example, U.S. Pat. No. 7,932,077 describes general proportions of proteins, fats (a portion of which are omega-3 and/or omega-6 PUFAs), carbohydrates, minerals and vitamins included in aquaculture feeds for fish, as well as a variety of other ingredients that may optionally be added to the formulation (e.g., carotenoids, particularly for salmonid and ornamental “aquarium” fishes, to enhance flesh and skin coloration, respectively; binding agents, to provide stability to the pellet and reduce leaching of nutrients into the water; preservatives, such as antimicrobials and antioxidants, to extend the shelf-life of fish diets and reduce the rancidity of the fats; chemoattractants and flavorings, to enhance feed palatability and its intake; and, other feedstuffs).

In one embodiment, herein, the aquaculture feed composition is then further extruded into aquaculture feed pellets, wherein said aquaculture feed pellets are suitable for consumption by an aquacultured species. For example, although this should not be construed as a limitation herein, the aquaculture feed compositions described in the present examples were extruded into pellets using a 4.5 mm die opening, thereby producing approximately 5.5 mm pellets after expansion.

One of skill in the art of the manufacture of aquafeed formulations will be familiar with consideration of factors affecting palatability, water stability, and proper size/texture requirements, based on the particular species for which the aquaculture feed composition is produced. In general, feeds are formulated to be dry (i.e., final moisture content of 6-10%), semi-moist (i.e., 35-40% water content) or wet (i.e., 50-70% water content). Dry feeds include the following: simple loose mixtures of dry ingredients (i.e., “mash” or “meals”); compressed pellets, crumbles or granules; and flakes. Depending on the feeding requirements of the fish, pellets can be made to sink or float.

In some embodiments, advantages may be incurred during the manufacture of the aquaculture feed composition if the disrupted microbial biomass may be readily stored and/or transported prior to incorporation additional with aquaculture feed components to form the feed composition. For example, it may be desirable to disrupt microbial cells for use in making an aquaculture feed compositions, according to the following steps:
(a) disrupting a microbial biomass, having a moisture level less than 10 weight percent and comprising oil-containing microbes, wherein said disruption results in a disruption efficiency of at least 30% of the oil-containing microbes to produce a disrupted microbial biomass; and,
(b) mixing said disrupted microbial biomass with at least one aquaculture feed component to form an aquaculture feed composition;
   wherein said disrupted microbial biomass of step (b) is in the form of a solid pellet, said solid pellet produced by:
(i) blending the disrupted microbial biomass of step (a) with at least one binding agent to provide a fixable mix; and,
(ii) forming a solid pellet of disrupted microbial biomass from said fixable mix.

The most preferred binding agent in the present invention is water. Other binding agents useful herein include hydrophilic organic materials and hydrophilic inorganic materials that are water soluble or water dispersible. Preferred water soluble binding agents have solubility in water of at least 1 weight percent, preferably at least 2 weight percent and more preferably at least 5 weight percent, at 23° C.

The binding agent preferably has solubility in supercritical fluid carbon dioxide at 500 bar of less than 1×10⁻³ mol fraction; and preferably less than 1×10⁻⁴, more preferably less than 1×10⁻⁵, and most preferably less than 1×10⁻⁶ mol fraction. The solubility may be determined according to the methods disclosed in “Solubility in Supercritical Carbon Dioxide”, Ram Gupta and Jae-Jin Shim, Eds., CRC (2007).

The binding agent acts to retain the integrity and size of solid pellets of disrupted microbial biomass and may facilitate further processing and transport of the disrupted microbial biomass.

Suitable organic binding agents include: alkali metal carboxymethyl cellulose with degrees of substitution of 0.5 to 1; polyethylene glycol and/or alkyl polyethoxylate, preferably with an average molecular weight below 1,000; phosphated starches; cellulose and starch ethers, such as carboxymethyl starch, methyl cellulose, hydroxyethyl cellulose, hydroxypropyl cellulose and corresponding cellulose mixed ethers; proteins including gelatin and casein; polysaccharides including tragacanth, sodium and potassium alginate, guam Arabic, tapioca, partly hydrolyzed starch including maltodextrose and dextrin, and soluble starch; sugars including sucrose, invert sugar, glucose syrup and molasses; synthetic water-soluble polymers including poly(meth)acrylates, copolymers of acrylic acid with maleic acid or compounds containing vinyl groups, polyvinyl alcohol, partially hydrolyzed polyvinyl acetate and polyvinyl pyrrolidone. If the compounds mentioned above are those containing free carboxyl groups, they are normally present in the form of their alkali metal salts, more particularly their sodium salts.

Phosphated starch is understood to be a starch derivative in which hydroxyl groups of the starch anhydroglucose units are replaced by the group —O—P(O)(OH)₂ or water-soluble salts thereof, more particularly alkali metal salts, such as sodium and/or potassium salts. The average degree of phosphation of the starch is understood to be the number of esterified oxygen atoms bearing a phosphate group per saccharide monomer of the starch averaged over all the saccharide units. The average degree of phosphation of preferred phosphate starches is in the range from 1.5 to 2.5.

Partly hydrolyzed starches in the context of the present invention are understood to be oligomers or polymers of carbohydrates which may be obtained by partial hydrolysis of starch using conventional, for example acid- or enzyme-catalyzed processes. The partly hydrolyzed starches are preferably hydrolysis products with average molecular weights of 440 to 500,000. Polysaccharides with a dextrose equivalent (DE) of 0.5 to 40 and, more particularly, 2 to 30 are preferred, DE being a standard measure of the reducing effect of a polysaccharide by comparison with dextrose (which has a DE of 100, i.e., DE 100). Both maltodextrins (DE 3-20) and dry glucose syrups (DE 20-37) and also so-called yellow dextrins and white dextrins with relatively high average molecular weights of about 2,000 to 30,000 may be used after phosphation.

A preferred class of binding agent is water and carbohydrates selected from the group consisting of sucrose, lactose, fructose, glucose, and soluble starch. Preferred binding agents have a melting point of at least 50° C., preferably at least 80° C., and more preferably at least 100° C.

Suitable inorganic binding agents include sodium silicate, bentonite, and magnesium oxide.

Preferred binding agents are materials that are considered “food grade” or “generally recognized as safe” (GRAS).

The binding agent is present at about 0.5 to 20 weight percent, preferably 3 to 15 weight percent, and more preferably about 5 to 10 weight percent, based on the summation of the disrupted microbial biomass and the binding agent in the solid pellet.

As one of skill in the art will appreciate, fixable mix (i.e., obtained by blending the disrupted microbial biomass with at least one binding agent) will have significantly higher moisture level than the moisture level of the final solid pellet, to permit ease of handling (e.g., extruding the fixable mix into a die). Thus, for example, a binding agent comprising a solution of sucrose and water can be added to the disrupted microbial biomass in a manner that results in a fixable mix having within 0.5 to 20 weight percent water. However, upon drying of the fixable mix to form a solid pellet, the final moisture level of the solid pellet is less than 5 weight percent of water and the sucrose is less than 10 weight percent

Blending the at least one binding agent with the disrupted microbial biomass to provide a fixable mix [step (i)] can be performed by any method that allows dissolution of the binding agent and blending with the disrupted microbial biomass to provide a fixable mix. The term “fixable mix” means that the mix is capable of forming a solid pellet upon removal of solvent, for instance water, in a drying step.

More specifically, the binding agent can be blended by a variety of means. One method includes dissolution of the binding agent in a solvent to provide a binder solution, following by metering the binder solution, at a controlled rate, into the disrupted microbial biomass. A preferred solvent is water, but other solvents, for instance ethanol, isopropanol, and such, may be used advantageously. Another method includes adding the binding agent, as a solid or solution, to the disrupted microbial biomass at the beginning or during the disruption step, that is, step (a) and (i) are combined and simultaneous. If the binding agent is added as a solid, preferably sufficient moisture is present in the disrupted microbial biomass to dissolve the binding agent during the blending step. A preferred method of blending includes metering the binder solution, at a controlled rate, into the disrupted microbial biomass in an extruder, preferably after the compression zone, as disclosed above. The addition of a binder solution after the compression zone allows for rapid cooling of the disrupted microbial biomass.

Forming solid pellets from the fixable mix [step (c)] can be performed by a variety of means known in the art. One method includes extruding the fixable mix into a die, for instance a dome granulator, to form strands of uniform diameter that are dried on a vibrating or fluidized bed drier to break the strands to provide pellets.

The solid disrupted microbial biomass pellets provided by the process disclosed herein desirably are non-tacky at room temperature. A large plurality of the solid pellets may be packed together for many days without degradation of the pellet structure, and without binding together. A large plurality of pellets desirably is a free-flowing pelletized composition. Preferably the pellets have an average diameter of about 0.5 to about 1.5 mm and an average length of about 2.0 to about 8.0 mm. Preferably, the solid pellets have a final moisture level of about 0.1% to 5.0%, with a range about 0.5% to 3.0% more preferred. Increased moisture levels in the final solid pellets may lead to difficulties during storage due to growth of e.g., molds.

In one embodiment, the present invention is thus drawn to a pelletized disrupted microbial biomass made by the process of steps (a), (i) and (ii), as disclosed above.

Also disclosed is a solid pellet comprising:
a) about 80 to about 99.5 weight percent of disrupted biomass comprising oil-containing microbes;
b) about 0.5 to 20 weight percent binding agent;
   wherein the weight percents are based on the summation of (a) and (b) in the solid pellet. The solid pellet may comprise 85 to 97 weight percent (a) and 3 to 15 weight percent (b); and, preferably the solid pellet comprises 90 to 95 weight percent (a) and 5 to 10 weight percent (b).

Thus, the disrupted microbial biomass obtained from any of the means described above may be used as a source of microbial oil comprising EPA and/or DHA for use in the aquaculture feed compositions described herein.

In some embodiments, the PUFAs may be extracted from the host cell through a variety of means well-known in the art. This may be useful, since PUFAs, including EPA, may be found in the host microorganism as free fatty acids or in esterified forms such as acylglycerols, phospholipids, sulfolipids or glycolipids. One review of extraction techniques, quality analysis and acceptability standards for yeast lipids is that of Z. Jacobs (Critical Reviews in Biotechnology, 12(5/6):463-491 (1992)). In general, extraction may be performed with organic solvents, sonication, supercritical fluid extraction (e.g., using carbon dioxide), saponification and physical means such as presses, or combinations thereof. One is referred to the teachings of U.S. Pat. No. 7,238,482 for additional details.

Thus, microbial oil, whether partially purified or purified, obtained from any of the means described above may be used as a source of EPA and/or DHA for use in the aquaculture feed compositions described herein. Preferably, the microbial oil will be used as a replacement of at least a portion of the fish oil that would be used in a similar aquaculture feed composition.

The present invention also concerns a method of making an aquaculture feed composition comprising:
a) providing at least one source of EPA and, optionally, at least one source of DHA, wherein said source can be the same or different;
b) providing additional feed components; and,
c) contacting (a) and (b) to make an aquaculture feed composition;

wherein said aquaculture feed composition has a ratio of concentration of EPA to concentration of DHA which is greater than 2:1 based on the individual concentrations of EPA and DHA in the aquaculture feed composition.

In preferred embodiments, the at least one source of EPA is a first source that is microbial oil and an optional second source that is fish oil or fish meal. The at least one source of DHA is selected from the group consisting of: microbial oil, fish oil, fish meal, and combinations thereof.

One of skill in the art will be able to determine the appropriate amount of microbial oil comprising EPA and optionally DHA to be included in an aquaculture feed composition, to increase the EPA:DHA ratio of the resulting aquaculture feed composition to greater than 2:1 and, preferably, to result in a total amount of EPA and DHA that is at least about 0.8%, measured as a weight percent of the aquaculture feed composition. The microbial oil may be included in an aquaculture feed as partially purified or purified oil, or the microbial oil may be contained within microbial biomass or processed biomass that is included.

The amount of microbial oil, or biomass containing microbial oil, needed to achieve an EPA:DHA ratio of greater than 2:1 will vary depending on factors. Determinants include consideration of the EPA TFAs, the EPA % DCW, the DHA % TFAs and the DHA % DCW of the microbial biomass comprising the oil, the EPA % TFAs and DHA % TFAs of a purified or partially purified oil, the content of EPA and DHA in other components to be added to the aquaculture feed composition (e.g., fishmeal, fish oil, vegetable oil, microalgae oil), etc.

Exemplary calculations of EPA content, DHA content and EPA:DHA ratios in aquaculture feed compositions are provided in Example 4 (infra), based on formulation with variable concentrations (i.e., 10%, 20% And 30%) of Yarrowia lipolytica Y4305 F1B1 biomass, which was assumed to contain 15 EPA % DCW, 50 EPA % TFAs and 0.0 DHA % TFAs. More specifically, various calculations are provided to demonstrate how this microbial biomass containing EPA could readily be mixed with variable concentrations of either anchovy oil or menhaden oil (0%, 2%, 5%, 10% and 20%), to result in aquaculture feed compositions comprising from 1.8% to 10.02% total EPA and DHA in the final composition, with EPA:DHA ratios ranging from 1.94:1 up to 47.7:1.

For example, if an aquaculture feed composition is prepared comprising anchovy fishmeal (25% of total weight), anchovy oil (20% of total weight) and Yarrowia lipolytica Y4305 F1B1 biomass that provides 15 EPA % DCW (10% of total weight), the EPA:DHA ratio is calculated to be 2.69:1. With less anchovy oil and/or more Y. lipolytica Y4305 F1B1 biomass, the EPA:DHA ratio increases. In another example, if an aquaculture feed composition is prepared comprising menhaden fishmeal (25% of total weight), menhaden oil (10% of total weight) and with Y. lipolytica Y4305 F1B1 biomass that provides 15 EPA % DCW (10% of total weight), EPA:DHA ratio is calculated to be 2.61:1. If fish oil is not used in the aquaculture feed composition, as seen in the scenarios using no anchovy oil or menhaden oil, then DHA will be available in the final composition only as a result of fishmeal; this leads to even higher EPA:DHA ratios.

Thus, Example 4 clearly demonstrates that a variety of aquaculture feed compositions can be formulated, using different amounts of various fish oils, in combination with different amounts of microbial biomass containing EPA, to result in a range of EPA:DHA ratios in the final aquaculture feed composition that are greater than 2:1. Similar calculations may be made for microbial biomass samples that contain various percents of EPA and/or in alternate feed formulations that comprise vegetable oils, etc. In this manner, various aquaculture feed compositions may be designed, by one skilled in the art, that have an EPA:DHA ratio of greater than 2:1. EPA:DHA ratios in the present aquaculture feed composition are greater than 2:1, and may be at least about 2.2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, or 10:1 or higher. Although preferred EPA:DHA ratios are described above, useful examples of EPA:DHA ratios include any integer or portion thereof that is greater than 2:1.

Based on the disclosure herein, it will be clear that renewable alternatives to fish oil can be utilized as a means to produce aquaculture feed compositions. These modified formulations do not impact fish health and may yield economic benefits to those performing aquaculture. Additionally, the modified formulations of the present invention will have societal benefits, as they will support sustainable aquaculture. Implementing sustainable alternatives to fish oil that can keep pace with the growing global demand for aquaculture products will also be advantageous.

### EXAMPLES

The present invention is further defined in the following Examples. It should be understood that these Examples, while indicating preferred embodiments of the invention, are given by way of illustration only. It will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

All aquaculture feed formulations and feed ingredients were obtained from and/or produced by Nofima Ingrediens, Kierreidviken 16, NO-5141 Fvllingsdalen, Norway (“Nofima”). Thus, fish meal; sunflower meal; hydrolyzed feather meal; corn gluten; soybean meal; wheat; Carophyll Pink comprising 10% astaxanthin; and yttrium oxide were obtained from Nofima.

The meaning of abbreviations is as follows: “kb” means kilobase(s), “bp” means base pairs, “nt” means nucleotide(s), “hr” means hour(s), “min” means minute(s), “sec” means second(s), “d” means day(s), “L” means liter(s), “ml” means milliliter(s), “μL” means microliter(s), “μg” means microgram(s), “ng” means nanogram(s), “mM” means millimolar, “μM” means micromolar, “nm” means nanometer(s), “μmol” means micromole(s), “DCW” means dry cell weight, “TFAs” means total fatty acids and “FAMEs” means fatty acid methyl esters. “HPLC” is High Performance Liquid Chromatography, “ASTM” is American Society for Testing And Materials, “C” is Celsius, “kPa” is kiloPascal, “mm” is millimeter, “μm” is micrometer, “mTorr” is milliTorr, “cm” is centimeter, “g” is gram, “wt” is weight, “temp” or “T” is temperature, “SS” is stainless steel, “in” is inch, “i.d.” is inside diameter, and “o.d.” is outside diameter.

### General Methods

Lipid Analysis: Lipids were extracted using the Folch method (Folch et al., J. Biol. Chem., 226:497 (1957)). Following extraction, the chloroform phase was dried under N₂ and the residual lipid extract was redissolved in benzene, and then transmethylated overnight with 2,2-dimethoxypropane and methanolic HCl at room temperature, as described by Mason, M. E. and G. R. Waller (J. Agric. Food Chem., 12:274-278 (1964)) and by Hoshi et al. (J. Lipid Res., 14:599-601 (1973)). The methyl esters of fatty acids thus formed were separated in a gas chromatograph (Hewlett Packard 6890) with a split injector, a SGE BPX70 capillary column (having a length of 60 m, an internal diameter of 0.25 mm and a film thickness of 0.25 m) with flame ionization detector. The carrier gas was helium. The injector and detector temperatures were 280° C. The oven temperature was raised from 50° C. to 180° C. at the rate of 10° C./min, and then raised to 240° C. at the rate of 0.7° C./min. All GC results were analyzed using HP ChemStation software (Hewlett-Packard Co.). The relative quantity of each fatty acid present was determined by measuring the area under the peak of the FAME corresponding to that fatty acid, and calculating the percentage relative to the sum of all integrated peaks.

Yarrowia lipolytica Strains: Y. lipolytica strain Y4305 was derived from wild type Yarrowia lipolytica ATCC #20362. Strain Y4305 was previously described in U.S. Pat. Appl. Pub. No. 2009-0093543-A1, the disclosure of which is hereby incorporated in its entirety. The final genotype of strain Y4305 with respect to wild type Yarrowia lipolytica ATCC #20362 is SCP2- (YALIOE01298g), YALIOC18711g-, Pex10-, YALIOF24167g-, unknown 1-, unknown 3-, unknown 8-, GPD::FmD12::Pex20, YAT1::FmD12::OCT, GPM/FBAIN::FmD12S::OCT, EXP1::FmD12S::Aco, YAT1::FmD12S::Lip2, YAT1::ME3S::Pex16, EXP1::ME3S::Pex20 (3 copies), GPAT::EgD9e::Lip2, EXP1::EgD9eS::Lip1, FBAINm::EgD9eS::Lip2, FBA::EgD9eS::Pex20, GPD::EgD9eS::Lip2, YAT1::EgD9eS::Lip2, YAT1::E389D9eS::OCT, FBAINm::EgD8M::Pex20, FBAIN::EgD8M::Lip1 (2 copies), EXP1::EgD8M::Pex16, GPDIN::EgD8M::Lip1, YAT1::EgD8M::Aco, FBAIN::EgD5::Aco, EXP1::EgD5S::Pex20, YAT1::EgD5S::Aco, EXP1::EgD5S::ACO, YAT1::RD5S::OCT, YAT1::PaD17S::Lip1, EXP1::PaD17::Pex16, FBAINm::PaD17::Aco, YAT1::YICPT1::ACO, GPD::YICPT1::ACO.

Chimeric genes in the above strain genotype are represented by the notation system “X::Y::Z”, where X is the promoter region, Y is the coding region, and Z is the terminator, which are all operably linked to one another.

Abbreviations are as follows: FmD12 is a Fusarium moniliforme delta-12 desaturase coding region [U.S. Pat. No. 7,504,259]; FmD12S is a codon-optimized delta-12 desaturase coding region derived from Fusarium moniliforme (U.S. Pat. No. 7,504,259); MESS is a codon-optimized C_{16/18} elongase coding region derived from Mortierella alpina (U.S. Pat. No. 7,470,532); EgD9e is a Euglena gracilis delta-9 elongase coding region (U.S. Pat. No. 7,645,604); EgD9eS is a codon-optimized delta-9 elongase coding region derived from Euglena gracilis (U.S. Pat. No. 7,645,604); E389D9eS is a codon-optimized delta-9 elongase coding region derived from Eutreptiella sp. CCMP389 (U.S. Pat. No. 7,645,604); EgD8M is a synthetic mutant delta-8 desaturase coding region (U.S. Pat. No. 7,709,239) derived from Euglena gracilis (U.S. Pat. No. 7,256,033); EgD5 is a Euglena gracilis delta-5 desaturase coding region (U.S. Pat. No. 7,678,560); EgD5S is a codon-optimized delta-5 desaturase coding region derived from Euglena gracilis (U.S. Pat. No. 7,678,560); RD5S is a codon-optimized delta-5 desaturase coding region derived from Peridinium sp. CCMP626 (U.S. Pat. No. 7,695,950); PaD17 is a Pythium aphanidermatum delta-17 desaturase coding region (U.S. Pat. No. 7,556,949); PaD17S is a codon-optimized delta-17 desaturase coding region derived from Pythium aphanidermatum (U.S. Pat. No. 7,556,949); and, YICPT1 is a Yarrowia lipolytica diacylglycerol cholinephosphotransferase coding region (U.S. Pat. No. 7,932,077).

Total fatty acid content of the Y4305 cells was 27.5% of dry cell weight [“TFAs % DCW”], and the lipid profile was as follows, wherein the concentration of each fatty acid is as a weight percent of TFAs [“% TFAs”]: 16:0 (palmitate)—2.8, 16:1 (palmitoleic acid)—0.7, 18:0 (stearic acid)—1.3, 18:1 (oleic acid)-4.9, 18:2 (LA)—17.6, ALA—2.3, EDA—3.4, DGLA—2.0, ARA—0.6, ETA—1.7 and EPA—53.2.

Yarrowia lipolytica strain Y4305 F1B1 was derived from Y. lipolytica strain Y4305, as described in U.S. Pat. Appl. Pub. No. 2011-0059204-A1, hereby incorporated herein by reference in its entirety. Specifically, strain Y4305 was subjected to transformation with a dominant, non-antibiotic marker for Y. lipolytica based on sulfonylurea resistance [“SU^{R}”]. More specifically, the marker gene was a native acetohydroxyacid synthase (“AHAS” or acetolactate synthase; E.C. 4.1.3.18) that has a single amino acid change, i.e., W497L, that confers sulfonylurea herbicide resistance (SEQ ID NO:292 of Intl. App. Pub. No. WO 2006/052870). The random integration of the SU^{R} genetic marker into Yarrowia strain Y4305 was used to identify those cells having increased lipid content when grown under oleaginous conditions relative to the parent Y4305 strain, as described in U.S. Pat. App. Pub. No. 2011-0059204-A1.

When evaluated under two liter fermentation conditions, average EPA productivity [“EPA % TFAs”] for strain Y4305 was 50-56, as compared to 50-52 for mutant SU^{R} strain Y4305-F1B1. Average lipid content [“TFAs % DCW”] for strain Y4305 was 20-25, as compared to 28-32 for strain Y4305-F1B1. Thus, lipid content was increased 29-38% in strain Y4503-F1B1, with minimal impact upon EPA productivity.

The yeast biomass used in Example 7 utilized Y. lipolytica strain Y8672. The generation of strain Y8672 is described in U.S. Pat. Appl. Pub. No. 2010-0317072-A1. Strain Y8672, derived from Y. lipolytica ATCC #20362, was capable of producing about 61.8% EPA relative to the total lipids via expression of a delta-9 elongase/delta-8 desaturase pathway.

The final genotype of strain Y8672 with respect to wild type Y. lipolytica ATCC #20362 was Ura+, Pex3-, unknown 1-, unknown 2-, unknown 3-, unknown 4-, unknown 5-, unknown 6-, unknown 7-, unknown 8-, Leu+, Lys+, YAT1::ME3S::Pex16, GPD::ME3S::Pex20, GPD::FmD12::Pex20, YAT1::FmD12::Oct, EXP1::FmD12S::ACO, GPAT::EgD9e::Lip2, FBAINm::EgD9eS::Lip2, EXP1::EgD9eS::Lip1, YAT1::EgD9eS::Lip2, FBAINm::EgD8M::Pex20, FBAIN::EgD8M::Lip1, EXP1::EgD8M::Pex16, GPD::EaD8S::Pex16 (2 copies), YAT1::E389D9eS/EgD8M::Lip1, YAT1::EgD9eS/EgD8M::Aco, FBAIN::EgD5SM::Pex20, YAT1::EgD5SM::Aco, GPM::EgD5SM::Oct, EXP1::EgD5M::Pex16, EXP1::EgD5SM::Lip1, YAT1::EaD5SM::Oct, YAT1::PaD17S::Lip1, EXP1::PaD17::Pex16, FBAINm::PaD17::Aco, GPD::YICPT1::Aco, and YAT1::MCS::Lip1.

Abbreviations not set forth above are as follows: EaD8S is a codon-optimized delta-8 desaturase gene, derived from Euglena anabaena [U.S. Pat. No. 7,790,156]; E389D9eS/EgD8M is a DGLA synthase created by linking a codon-optimized delta-9 elongase gene (“E389D9eS”), derived from Eutreptiella sp. CCMP389 delta-9 elongase (U.S. Pat. No. 7,645,604) to the delta-8 desaturase “EgD8M” (supra) [U.S. Pat. Appl. Pub. No. 2008-0254191-A1]; EgD9ES/EgD8M is a DGLA synthase created by linking the delta-9 elongase “EgD9eS” (supra) to the delta-8 desaturase “EgD8M” (supra) [U.S. Pat. Appl. Pub. No. 2008-0254191-A1]; EgD5M and EgD5SM are synthetic mutant delta-5 desaturase genes [U.S. Pat. App. Pub. 2010-0075386-A1], derived from Euglena gracilis [U.S. Pat. No. 7,678,560]; EaD5SM is a synthetic mutant delta-5 desaturase gene [U.S. Pat. App. Pub. 2010-0075386-A1], derived from Euglena anabaena [U.S. Pat. No. 7,943,365]; and, MCS is a codon-optimized malonyl-CoA synthetase gene, derived from Rhizobium leguminosarum bv. viciae 3841 [U.S. Pat. App. Pub. 2010-0159558-A1].

For a detailed analysis of the total lipid content and composition in strain Y8672, a flask assay was conducted wherein cells were grown in 2 stages for a total of 7 days. Based on analyses, strain Y8672 produced 3.3 g/L dry cell weight [“DCW”], total lipid content of the cells was 26.5 [“TFAs % DCW”], the EPA content as a percent of the dry cell weight [“EPA % DCW”] was 16.4, and the lipid profile was as follows, wherein the concentration of each fatty acid is as a weight percent of TFAs [“% TFAs”]: 16:0 (palmitate)—2.3, 16:1 (palmitoleic acid)—0.4, 18:0 (stearic acid)—2.0, 18:1 (oleic acid)—4.0, 18:2 (LA)—16.1, ALA—1.4, EDA—1.8, DGLA—1.6, ARA—0.7, ETrA—0.4, ETA—1.1, EPA—61.8, other—6.4.

The yeast biomass used in Example 8 herein utilized Y. lipolytica strain Y9502. The generation of strain Y9502 is described in U.S. Pat. Appl. Pub. No. 2010-0317072-A1, hereby incorporated herein by reference in its entirety. Strain Y9502, derived from Y. lipolytica ATCC #20362, was capable of producing about 57.0% EPA relative to the total lipids via expression of a delta-9 elongase/delta-8 desaturase pathway.

The final genotype of strain Y9502 with respect to wildtype Y. lipolytica ATCC #20362 was Ura+, Pex3-, unknown 1-, unknown 2-, unknown 3-, unknown 4-, unknown 5-, unknown 6-, unknown 7-, unknown 8-, unknown 9-, unknown 10-, YAT1::ME3S::Pex16, GPD::ME3S::Pex20, YAT1::ME3S::Lip1, FBAINm::EgD9eS::Lip2, EXP1::EgD9eS::Lip1, GPAT::EgD9e::Lip2, YAT1::EgD9eS::Lip2, FBAINm::EgD8M::Pex20, EXP1::EgD8M::Pex16, FBAIN::EgD8M::Lip1, GPD::EaD8S::Pex16 (2 copies), YAT1::E389D9eS/EgD8M::Lip1, YAT1::EgD9eS/EgD8M::Aco, FBAINm::EaD9eS/EaD8S::Lip2, GPD::FmD12::Pex20, YAT1::FmD12::Oct, EXP1::FmD12S::Aco, GPDIN::FmD12::Pex16, EXP1::EgD5M::Pex16, FBAIN::EgD5SM::Pex20, GPDIN::EgD5SM::Aco, GPM::EgD5SM::Oct, EXP1::EgD5SM::Lip1, YAT1::EaD5SM::Oct, FBAINm::PaD17::Aco, EXP1::PaD17::Pex16, YAT1::PaD17S::Lip1, YAT1::YICPT::Aco, YAT1::MCS::Lip1, FBA::MCS::Lip1, YAT1::MaLPAAT1S::Pex16.

Abbreviations not previously defined are as follows:

EaD9eS/EgD8M is a DGLA synthase created by linking a codon-optimized delta-9 elongase gene (“EaD9eS”), derived from Euglena anabaena delta-9 elongase [U.S. Pat. No. 7,794,701] to the delta-8 desaturase “EgD8M” (supra) [U.S. Pat. Appl. Pub. No. 2008-0254191-A1]; and, MaLPAAT1S is a codon-optimized lysophosphatidic acid acyltransferase gene, derived from Mortierella alpina [U.S. Pat. No. 7,879,591].

For a detailed analysis of the total lipid content and composition in strain Y9502, a flask assay was conducted wherein cells were grown in 2 stages for a total of 7 days. Based on analyses, strain Y9502 produced 3.8 g/L dry cell weight [“DCW”], total lipid content of the cells was 37.1 [“TFAs % DCW”], the EPA content as a percent of the dry cell weight [“EPA % DCW”] was 21.3, and the lipid profile was as follows, wherein the concentration of each fatty acid is as a weight percent of TFAs [“% TFAs”]: 16:0 (palmitate)—2.5, 16:1 (palmitoleic acid)—0.5, 18:0 (stearic acid)—2.9, 18:1 (oleic acid)—5.0, 18:2 (LA)-12.7, ALA—0.9, EDA—3.5, DGLA—3.3, ARA—0.8, ETrA—0.7, ETA—2.4, EPA—57.0, other—7.5.

Yarrowia Biomass Preparation: Inocula were prepared from frozen cultures of Yarrowia lipolytica in a shake flask. After an incubation period, the culture was used to inoculate a seed fermenter. When the seed culture reached an appropriate target cell density, it was then used to inoculate a larger fermenter. The fermentation was run as a 2-stage fed-batch process. In the first stage, the yeast were cultured under conditions that promoted rapid growth to a high cell density; the culture medium comprised glucose, various nitrogen sources, trace metals and vitamins. In the second stage, the yeast were starved for nitrogen and continuously fed glucose to promote lipid and PUFA accumulation. Process variables including temperature (controlled between 30-32° C.), pH (controlled between 5-7), dissolved oxygen concentration and glucose concentration were monitored and controlled per standard operating conditions to ensure consistent process performance and final PUFA oil quality.

One of skill in the art of fermentation will know that variability will occur in the oil profile of a specific Yarrowia strain, depending on the fermentation run itself, media conditions, process parameters, scale-up, etc., as well as the particular time-point in which the culture is sampled (see, e.g., U.S. Pat. Appl. Pub. No. 2009-0093543-A1).

Antioxidants were optionally added to the fermentation broth prior to processing to ensure the oxidative stability of the EPA oil. After fermentation, the yeast biomass was dewatered and washed to remove salts and residual medium, and to minimize lipase activity. Ethoxyquin (600 ppm) was added to the biomass prior to drying.

Either drum-drying (typically with 80 psig steam) or spray-drying was then performed, to reduce moisture level to less than 5% to ensure oil stability during short term storage and transportation. The drum dried biomass was in the form of flakes. In contrast, spray dried powder had a particle size distribution in range of about 10 to 100 microns.

Extrusion Of Yarrowia Biomass Flakes: Dried biomass flakes were fed into an extruder, preferably a twin screw extruder with a length suitable for accomplishing the operations described below, normally having a length to diameter [“L/D”] ratio between 21-39 (although this particular L/D ratio should not be considered a limitation herein). The first section of the extruder was used to feed and transport the biomass. The following section served as a compaction zone designed to compact the biomass using bushing elements with progressively shorter pitch length. After the compaction zone, a compression zone followed, which served to impart most of the mechanical energy required for cell disruption. This zone was created using flow restriction, either in the form of reverse screw elements, restriction/blister ring elements or kneading elements. Finally, the disrupted biomass was discharged through the last barrel which is open at the end, thus producing little or no backpressure in the extruder.

Feed Formulation: The extruded biomass was then formulated with other feed ingredients (infra) and extruded into pellets using a 4.5 mm die opening, giving approximately 5.5 mm pellets after expansion. Yttrium oxide [Y₂O₃] (100 ppm) was added to all diets as an inert marker for digestibility determination. Vegetable oil was added post-extrusion to the pellets in accordance with the diet composition.

### Example 1

### Oil Composition of Yarrowia lipolytica Strain Y4305 F1B1 Biomass in Comparison to Fishmeal, Fish Oil and Rapeseed Oil

Yarrowia lipolytica strain Y4305 F1B1 biomass was prepared and made into flakes, as described in General Methods. Oil was extracted from the whole dried flakes by placing 7 g of dried flakes and 20 mL of hexane in a 35 mL steel cylinder. Three steel ball bearings (0.5 cm diameter) were then added to the cylinder and the cylinder was placed on a vibratory shaker. After 1 hr of vigorous shaking, the disrupted biomass was allowed to settle and the solution of oil in hexane was poured off to yield a clear yellow liquid. This liquid was then poured into a separate tube and subjected to a nitrogen stream to evaporate the hexane, thereby leaving the oil phase in the tube. It was determined that about 34% of the biomass was oil. The composition of the oil was analyzed by GC, as described in General Methods.

In addition, the fatty acid composition of fish meal oil, fish oil and rapeseed oil was similarly analyzed by GC.

Lipids were extracted as described in General Methods above.

A comparison of fatty acids present in the Yarrowia Y4305 F1B1 biomass, fish meal, fish oil, and rapeseed oil is shown in Table 3. The concentration of each fatty acid is presented as a weight percent of total fatty acids [“% TFAs”]. EPA is identified as 20:5, n-3, while DHA is identified as 22:6, n-3.

TABLE 3
Lipid Composition Of Various Oils

| | Fatty Acid | Fish | | Rape- | Yarrowia |
|---|---|---|---|---|---|
| | Common | meal | Fish | seed | Y4305 |
| Fatty acid | Name | oil | oil | oil | F1B1 oil |
| C14:0 | Myristic | 3.7 | 6.8 | 0.1 | 0.1 |
| | acid | | | | |
| C16:0 | Palmitic | 10.8 | 10.5 | 4.4 | 2.8 |
| | Acid | | | | |
| C17:0 | — | nd | nd | nd | 0.3 |
| C18:0 | Stearic | 1.7 | 1.1 | 1.8 | 2.5 |
| | acid | | | | |
| C20:0 | — | 0.1 | 0.1 | 0.6 | 0.8 |
| C22:0 | — | <0.1 | 0.1 | 0.3 | 1.1 |
| C24:0 | — | nd | nd | nd | 0.6 |
| C16:1, n-7 | — | 3.2 | 4.4 | 0.2 | 0.5 |
| C18:1, n-9 | — | nd | nd | nd | 4.7 |
| C18:1, n-7 | — | nd | nd | nd | 0.4 |
| C18:1, | — | 9.4 | 11.9 | 59.1 | nd |
| (n-9) + (n-7) + (n-5) | | | | | |
| C20:1, (n-9) + (n-7) | — | 7.6 | 13.9 | 1.7 | nd |
| C22:1, | — | 9.4 | 20.6 | 0.9 | nd |
| (n-11) + (n-9) + (n-7) | | | | | |
| C24:1, n-9 | — | 0.8 | 0.9 | 0.1 | nd |
| C16:2, n-4 | — | 0.3 | 0.3 | <0.1 | nd |
| C16:3, n-4 | — | 0.3 | 0.2 | <0.1 | nd |
| C16:4, n-1 | — | 0.1 | 0.1 | <0.1 | nd |
| C18:2, n-6 | LA | 1.1 | 1.1 | 19.3 | 20.3 |
| C18:3, n-6 | GLA | 0.1 | 0.1 | <0.1 | 1.0 |
| C18:3, n-4 | — | nd | nd | nd | 0.2 |
| C20:2, n-6 | EDA | 0.2 | 0.2 | 0.1 | 3.2 |
| C20:3, n-6 | DGLA | 0.1 | 0.1 | <0.1 | 1.9 |
| C20:4, n-6 | ARA | 0.6 | 0.3 | <0.1 | 0.5 |
| C22:4, n-6 | DTA | <0.1 | <0.1 | <0.1 | nd |
| C18:3, n-3 | ALA | 0.7 | 0.8 | 8.4 | 3.4 |
| C18:4, n-3 | STA | 2 | 1.9 | <0.1 | nd |
| C20:1, n-9 | — | nd | nd | nd | 0.2 |
| C20:1, n-7 | — | nd | nd | nd | 0.6 |
| C20:3, n-3 | ETrA | 0.1 | 0.1 | <0.1 | 0.8 |
| C20:3, n-9 | — | nd | nd | nd | 0.3 |
| C20:4, n-3 | ETA | 0.5 | 0.5 | <0.1 | 0.0 |
| C20:5, n-3 | EPA | 7.4 | 5.2 | <0.1 | 46.8 |
| C21:5, n-3 | — | 0.3 | 0.3 | <0.1 | nd |
| C22:1, n-7 | — | nd | nd | nd | 2.0 |
| C22:1, n-11 | — | nd | nd | nd | 0.5 |
| C22:5, n-3 | DPA | 0.6 | 0.6 | <0.1 | 2.3 |
| C22:6, n-3 | DHA | 10.6 | 5.7 | <0.1 | nd |

*nd = not detected

The EPA:DHA ratios for the fishmeal and fish oil samples were calculated to be 0.7 and 0.9, respectively. In rapeseed oil, the ratio of EPA and DHA was not determined since EPA and DHA levels were below detection limits of the analysis. In the Yarrowia Y4305 F1B1 oil, EPA was very high at 46.8% of total fatty acids, while DHA was not detected.

EPA was determined to be about 15% of the Yarrowia Y4305 F1B1 biomass, since EPA constituted 46.8% of the TFAs and fatty acids (i.e., oil) constituted about 34% of the biomass. Thus, 20% of Yarrowia Y4305 F1B1 biomass in an aquaculture feed composition formulation would provide about 3% of EPA by weight in the aquaculture feed composition.

### Example 2

### Comparison of a Standard Aquaculture Feed Formulation to an Aquaculture Feed Formulation Including Yarrowia lipolytica Y4305 F1B1 Biomass

A standard aquaculture feed formulation was compared to an aquaculture feed formulation containing Yarrowia Y4305 F1B1 biomass.

The Yarrowia Y4305 F1B1 biomass-containing aquaculture feed was formulated using extruded Yarrowia Y4305 F1B1 biomass, prepared as described in the General Methods (supra). Specifically, a portion of the fish oil that is typically present in a standard fish aquaculture feed formulation was replaced with a combination of Yarrowia Y4305 F1B1 biomass and soybean oil. The prepared Yarrowia Y4305 F1B1 biomass, which contained about 34% oil (Example 1), was included as 20% of the total feed on a weight basis. Soybean oil is devoid of EPA and DHA. Fishmeal included in the aquaculture feed formulation was expected to contribute some EPA and DHA. Other standard industry ingredients that provide nutritional benefit in terms of protein, amino acids, fat, carbohydrate, minerals, energy and astaxanthin were added. Components of the Yarrowia Y4305 F1B1 biomass-containing aquaculture feed and the standard aquaculture feed (“control”) are given in Table 4.

The standard aquaculture feed and Yarrowia Y4305 F1B1 biomass-containing aquaculture feed were produced by extrusion using 4.5 mm die opening, giving approximately 5.5 mm pellets after expansion. All aquaculture feed contained 100 ppm Y₂O₃ as an inert marker for digestibility determination.

Aquaculture feed samples were analysed for dry matter [“DM”] (heated at 105° C., until weight was constant), crude protein (N×6.25, Kjeltech Auto System, Tecator, Höganäs, Sweden), ash (heated at 550° C., until weight was constant), energy (adiabatic bomb calorimetry) and astaxanthin (as described by Schierle and Härdi, “Analytical Methods for Vitamins and Carotenoids in Feeds” In: Hoffmann, Keller, Schierle, Schuep, Eds. (1994)) (Table 4).

Additionally, aquaculture feed samples were analysed for lipids (Soxtec System HT 6 and Soxtec System 1047 Hydrolyzing Unit; Tecator, Höganäs, Sweden) (Table 4). In addition to the Soxtec lipid extraction, lipids were extracted by the Folch method (supra) and fatty acid compositions were analysed by GC. The fatty acid profiles of the aquaculture feed samples, wherein the concentration of each fatty acid is presented as a weight percent of total fatty acids [“% TFAs”], is shown in Table 5. EPA is identified as 20:5, n-3, while DHA is identified as 22:6, n-3.

The aquaculture feed samples were also subjected to a water stability test, using a reduced methodology of the test as described by G. Baeverfjord et al. (Aquaculture, 261(4):1335-1345 (2006)). Duplicate samples of each diet (10 g each) were placed in custom made steel-mesh buckets placed inside glass beakers filled with 300 mL distilled water. The beakers were shaken (100/min) in a thermostat-controlled water bath (23° C.) for 120 min, and the remaining amount of dry matter was determined (Table 4).

TABLE 4
Components And Chemical Compositions In A Standard
Aquaculture Feed Formulation And In Aquaculture Feed Formulation
Including Yarrowia Y4305 F1B1 Biomass

| | |
|---|---|
| | Yarrowia Y4305 |
| Standard Feed | F1B1 Feed |

Component, %

| | | |
|---|---|---|
| Fish meal | 20.2 | 20.2 |
| Sunflower meal, extracted | 11.7 | 3.6 |
| Hydrolyzed feather meal | 11.0 | 13.0 |
| Corn gluten | 9.0 | 8.9 |
| Yarrowia Y4305 F1B1 biomass | 0 | 20.0 |
| Fish oil | 26.0 | 0 |
| Soybean oil | 0 | 21.0 |
| Soybean meal | 4.0 | 2.0 |
| Wheat | 13.5 | 6.7 |
| Monocalcium phosphate | 1.4 | 1.4 |
| Vitamin mix | 2.0 | 2.0 |
| Mineral mix | 0.4 | 0.4 |
| L-Lysine HCl | 0.5 | 0.5 |
| DL-Methionine | 0.2 | 0.2 |
| Carophyll Pink (10% | 0.055 | 0.055 |
| astaxanthin) | | |
| Yttrium oxide | 0.01 | 0.01 |

Chemical composition, %

| | | |
|---|---|---|
| Dry matter | 93.6 | 94.1 |
| Crude fat* | 31.1 | 31.3 |
| Crude protein, N × 6.25 | 37.5 | 38.7 |
| Ash | 5.2 | 5.9 |
| Energy, MJ/kg | 24.5 | 24.7 |
| Astaxanthin, mg/kg | 54.2 | 58.6 |
| Yttrium, % | 0.010 | 0.010 |

Minerals

| | | |
|---|---|---|
| P, mg/kg | 10471 | 10775 |
| Ca, mg/kg | 8169 | 8349 |
| Na, mg/kg | 2977 | 2999 |
| Mg, mg/kg | 2519 | 2048 |
| Zn, mg/kg | 160 | 149 |
| Fe, mg/kg | 195 | 201 |
| Cu, mg/kg | 13 | 12 |

*See Table 5 for lipid composition of crude fat.

TABLE 5
Lipid Composition In A Standard Aquaculture Feed
Formulation And In Aquaculture Feed Formulation
Including Yarrowia Y4305 F1B1 Biomass

| | | Yarrowia |
|---|---|---|
| | Standard | Y4305 |
| Fatty acid | Feed | F1B1 Feed |
| 14:0 | 7.4 | 0.5 |
| 14:1, n-5 | 0.4 | *nd |
| 15:0 | 0.3 | 0.1 |
| 16:0 | 12.3 | 10.0 |
| 16:1, n-5 | 0.1 | 0.1 |
| 16:1, n-7 | 4.1 | 0.5 |
| 16:1, n-9 | 0.2 | 0.1 |
| 16:2, n-6 | 0.3 | 0.1 |
| 17:0 | 0.5 | 0.1 |
| 18:0 | 1.4 | 3.4 |
| 18:1, n-11 | 0.7 | 0.1 |
| 18:1, n-7 | 1.6 | 1.1 |
| 18:1, n-9 | 11.0 | 17.1 |
| 18:2, n-6 | 4.5 | 43.8 |
| 18:3, n-3 | 1.0 | 5.6 |
| 18:3, n-4 | 0.1 | 0.2 |
| 18:3, n-6 | 0.1 | 0.1 |
| 18:4, n-3 | 0.2 | 0.1 |
| 20:0 | 0.2 | 0.3 |
| 20:1, n-11 | 1.8 | 0.2 |
| 20:1, n-9 | 14.1 | 0.8 |
| 20:2, n-6 | 0.2 | 0.7 |
| 20:3, n-3 | 0.2 | 0.2 |
| 20:3, n-6 | 0.0 | 0.4 |
| 20:4, n-3 | 0.0 | 0.1 |
| 20:4, n-6 | 0.2 | 0.1 |
| 20:5, n-3 | 5.1 | 9.1 |
| 22:0 | 0.1 | 0.5 |
| 22:1, n-11 | 21.5 | 1.1 |
| 22:1, n-7 | 0.4 | 0.4 |
| 22:5, n-3 | 0.6 | 0.5 |
| 22:6, n-3 | 5.2 | 1.0 |
| 24:0 | 0.2 | 0.3 |
| EPA:DHA | 0.98:1 | 9:1 |
| Ratio | | |

*nd = not detected.

Although the EPA:DHA ratio of the aquaculture feed formulations are dramatically different (i.e., 0.98:1 for the standard aquaculture feed formation versus 9:1 for the aquaculture feed formulation including Yarrowia Y4305 F1B1 biomass, wherein the biomass was included as 20% of the total aquaculture feed on a weight basis), the concentration of EPA plus DHA as a weight percent of total fatty acids [“EPA+DHA % TFAs”] in both aquaculture feed formulations was similar: 10.3 EPA+DHA % TFAs for the standard feed formation versus 10.1 EPA+DHA % TFAs for the aquaculture feed formulation including Yarrowia Y4305 F1B1 biomass.

The total amount of EPA plus DHA, measured as a weight percent of each aquaculture feed formulation (i.e., “EPA+DHA %”), can also be calculated by multiplying (EPA+DHA % TFAs)*(total fat in the aquaculture feed formulation). Thus, the standard aquaculture feed formulation contained 3.19% EPA+DHA (i.e., [10.3 EPA+DHA % TFAs]*0.31), while the aquaculture feed formulation including Yarrowia Y4305 F1B1 biomass contained 3.13% EPA+DHA (i.e., [10.1 EPA+DHA % TFAs]*0.31).

### Example 3

### Comparison of Standard Feed Formulations to Feed Formulations Including Variable Percentages of Yarrowia lipolytica Y4305 Biomass

Two different standard aquaculture feed formulations, comprising rapeseed oil or a combination of rapeseed and fish oil, were compared to three different aquaculture feed formulations containing Yarrowia lipolytica Y4305 biomass.

As described in the General Methods, while Y. lipolytica strain Y4305 F1B1 (used in Example 2) contains approximately 28-38% fat (i.e., measured as average lipid content [“TFAs % DCW”]) and approximately 15% EPA (i.e., measured EPA content as a percent of the dry cell weight [“EPA % DCW”]), Y. lipolytica strain Y4305 contains approximately 20-28 TFAs % DCW and approximately 13 EPA % DCW/. Aquaculture feed formulations comprising the Yarrowia Y4305 biomass, as described in the present Example, were therefore expected to have different compositions than the aquaculture feed formulations prepared in Example 2, comprising the Yarrowia Y4305 F1B1 biomass. Additionally, the present Example compares aquaculture feed formulation components and chemical/lipid compositions when the Yarrowia Y4305 biomass was included as 10%, 20% or 30% of the total aquaculture feed on a weight basis, i.e., designated as “Yarrowia Y4305 Feed-10%”, “Yarrowia Y4305 Feed-20%” and “Yarrowia Y4305 Feed-30%”.

Salmon aquaculture feeds commonly contain either 100% fish oil or mixtures of vegetable oils and fish oils to achieve sufficient caloric value and total omega-3 fatty acid content in the feed formulation. Thus, two standard aquaculture feeds (“control”) were prepared in the present Example, the first comprising 100% rapeseed oil and designated as “Standard Feed-Rapeseed oil”, and the second comprising a mixture of rapeseed oil and fish oil (1.7:1 ratio) and designated as “Standard Feed-Fish oil”.

In contrast, each of the aquaculture feed formulations containing Yarrowia lipolytica Y4305 biomass were prepared with a mixture of rapeseed oil and Yarrowia Y4305 biomass.

Yarrowia Y4305 biomass-containing aquaculture feeds were formulated using extruded Yarrowia Y4305 biomass, prepared as described in the General Methods (supra). As mentioned above, the prepared Yarrowia Y4305 biomass was included as either 10%, 20% or 30% of the total feed on a weight basis. Rapeseed oil is effectively devoid of EPA and DHA. Fishmeal included in the aquaculture feed formulation was expected to contribute some EPA and DHA. Other standard industry ingredients of commercial fish aquaculture feeds that provide nutritional benefit in terms of protein, amino acids, fat, carbohydrate, minerals, energy and astaxanthin were added, as in Example 2 and the final formulation was similarly extruded. The other aquaculture feed components were balanced across the aquaculture feeds in order to provide identical levels of protein, fat carbohydrate and energy. Components of the three Yarrowia Y4305 biomass-containing aquaculture feeds and the two standard aquaculture feeds (“control”) are given in Table 6.

Following extrusion of the two standard aquaculture feeds and three Yarrowia Y4305 biomass-containing aquaculture feeds, aquaculture feed samples were analysed for dry matter [“DM”], crude protein, ash, energy, astaxanthin and lipids (both by Soxhlet lipid extraction and by the Folch method) and subjected to a water stability test, according to the methodologies of Example 2. This data is summarized in Table 6, while the fatty acid profiles of the feed samples are shown in Table 7. The concentration of each fatty acid is presented as a weight percent of total fatty acids [“% TFAs”]; EPA is identified as 20:5, n-3, while DHA is identified as 22:6, n-3.

TABLE 6
Components And Chemical Compositions In Two Alternate
Standard Aquaculture Feed Formulations And In Three Alternate
Aquaculture Feed Formulations Including Yarrowia Y4305 Biomass

| Standard | Yarrowia | Yarrowia | Yarrowia | |
|---|---|---|---|---|
| Feed- | Y4305 | Y4305 | Y4305 | Standard |
| Rapeseed | Feed- | Feed- | Feed- | Feed- |
| oil | 10% | 20% | 30% | Fish oil |

Formulation, %

| | | | | | |
|---|---|---|---|---|---|
| LT fish meal | 48.9 | 46.1 | 43.2 | 40.3 | 48.9 |
| Wheat gluten | 10 | 10 | 10 | 10 | 10 |
| Yarrowia | 0 | 10 | 20 | 30 | 0 |
| Y4305 biomass | | | | | |
| Fish oil | 0 | 0 | 0 | 0 | 7.34 |
| Rapeseed oil | 19.9 | 18.3 | 16.7 | 15.1 | 12.56 |
| Wheat | 18.7 | 13.1 | 7.6 | 2.1 | 18.7 |
| Vitamin mix | 2 | 2 | 2 | 2 | 2 |
| Mineral mix | 0.4 | 0.4 | 0.4 | 0.4 | 0.4 |
| Carophyll | 0.055 | 0.055 | 0.055 | 0.055 | 0.055 |
| Pink (10% | | | | | |
| astaxanthin) | | | | | |
| Yttrium oxide | 0.01 | 0.01 | 0.01 | 0.01 | 0.01 |

Chemical composition, %

| | | | | | |
|---|---|---|---|---|---|
| Dry matter | 93.6 | 91.3 | 92.7 | 92.8 | 93.7 |
| Crude fat* | 25.3 | 24.8 | 24.7 | 23.8 | 25.8 |
| Crude protein, | 46.5 | 43.9 | 45.3 | 44.9 | 45.1 |
| N × 6.25 | | | | | |
| Ash | 7.9 | 7.5 | 7.3 | 6.9 | 8.0 |
| Energy, MJ/kg | 23.2 | 22.8 | 23.1 | 23.1 | 23.5 |
| Astaxanthin, | 52.7 | 48.8 | 49.2 | 47.5 | 56.1 |
| mg/kg | | | | | |
| Yttrium, mg/kg | 98 | 98 | 102 | 99 | 99 |

Minerals

| | | | | | |
|---|---|---|---|---|---|
| P, % | 1.18 | 1.12 | 1.04 | 1.02 | 1.16 |
| Ca, % | 1.46 | 1.36 | 1.28 | 1.17 | 1.39 |
| Mg, mg/kg | 1839 | 1784 | 1597 | 1852 | 1818 |
| Na, mg/kg | 7214 | 5412 | 5468 | 6033 | 5892 |
| Fe, mg/kg | 108 | 127 | 147 | 144 | 112 |
| Mn, mg/kg | 32 | 32 | 30 | 39 | 45 |
| Zn, mg/kg | 148 | 143 | 143 | 146 | 160 |
| Cu, mg/kg | 9.3 | 10.0 | 10.9 | 11.3 | 9.8 |

*See Table 7 for lipid composition of crude fat.

TABLE 7
Lipid Composition In Two Alternate Standard Aquaculture
Feed Formulations And In Three Alternate Aquaculture Feed
Formulations Including Yarrowia Y4305 F1B1 Biomass

| | Standard | Yarrowia | Yarrowia | Yarrowia | |
|---|---|---|---|---|---|
| | Feed- | Y4305 | Y4305 | Y4305 | Standard |
| | Rapeseed | Feed- | Feed- | Feed- | Feed- |
| | oil | 10% | 20% | 30% | Fish oil |
| Fatty acid | | | | | |
| composition, % | | | | | |
| 12:0 | 0.1 | *nd | *nd | *nd | *nd |
| 14:0 | 1.0 | 0.8 | 0.8 | 0.8 | 2.4 |
| 14:1, n-5 | *nd | *nd | *nd | *nd | 0.1 |
| 15:0 | *nd | 0.1 | 0.1 | 0.1 | 0.2 |
| 16:0 | 6.8 | 6.6 | 6.9 | 7.3 | 8.0 |
| 16:1, n-5 | 0.1 | nd | 0.1 | 0.1 | 0.1 |
| 16:1, n-7 | 1.1 | 1.0 | 1.0 | 1.0 | 2.0 |
| 16:1, n-9 | 0.1 | 0.1 | *nd | 0.1 | 0.1 |
| 16:2, n-3 | 0.1 | 0.1 | 0.1 | 0.1 | 0.1 |
| 16:3, n-4 | 0.1 | 0.1 | 0.0 | 0.0 | 0.1 |
| 17:0 | 0.1 | 0.1 | 0.1 | 0.2 | 0.2 |
| 17:1, n-7 | 0.1 | 0.1 | 0.1 | 0.1 | 0.1 |
| 18:0 | 1.9 | 2.1 | 2.4 | 2.7 | 1.8 |
| 18:1, n-11 | 0.1 | 0.1 | 0.1 | 0.1 | 0.3 |
| 18:1, n-7 | 2.9 | 2.7 | 2.6 | 2.5 | 2.6 |
| 18:1, n-9 | 46.7 | 46.0 | 43.5 | 40.6 | 37.4 |
| 18:2, n-6 | 17.5 | 18.1 | 18.2 | 18.3 | 13.8 |
| 18:3, n-3 | 7.1 | 7.1 | 6.8 | 6.4 | 5.5 |
| 18:3, n-4 | 0.1 | 0.1 | 0.1 | 0.1 | 0.1 |
| 18:3, n-6 | 0.1 | 0.1 | 0.1 | 0.1 | 0.1 |
| 20:0 | 0.5 | 0.5 | 0.6 | 0.6 | 0.4 |
| 20:1, n-11 | 0.5 | 0.5 | 0.5 | 0.5 | 1.0 |
| 20:1, n-7 | 0.1 | 0.1 | 0.1 | 0.1 | 0.2 |
| 20:1, n-9 | 3.2 | 2.8 | 2.7 | 2.6 | 5.6 |
| 20:2, n-6 | 0.1 | 0.3 | 0.4 | 0.6 | 0.2 |
| 20:3, n-3 | 0.1 | 0.1 | 0.1 | 0.1 | *nd |
| 20:3, n-6 | *nd | 0.2 | 0.4 | 0.6 | *nd |
| 20:4, n-3 | 0.3 | 0.2 | 0.2 | 0.2 | 0.6 |
| 20:4, n-6 | 0.1 | 0.1 | 0.1 | 0.2 | 0.2 |
| 20:5, n-3 | 1.8 | 3.0 | 4.7 | 6.5 | 3.1 |
| 22:0 | 0.3 | 0.3 | 0.3 | 0.4 | 0.2 |
| 22:1, n-11 | 2.4 | 2.0 | 1.9 | 1.9 | 6.9 |
| 22:1, n-7 | 0.1 | 0.3 | 0.5 | 0.7 | 0.2 |
| 22:1, n-9 | 0.9 | 0.9 | 0.8 | 0.8 | 1.1 |
| 22:4, n-6 | 0.3 | 0.2 | 0.3 | 0.5 | 0.1 |
| 22:5, n-3 | 0.2 | 0.2 | 0.2 | 0.3 | 0.3 |
| 22:6, n-3 | 2.4 | 2.2 | 2.1 | 2.1 | 3.6 |
| 24:1, n-9 | *nd | 0.3 | 0.2 | 0.2 | 0.4 |
| EPA:DHA | 0.75:1 | 1.36:1 | 2.23:1 | 3.1:1 | 0.86:1 |
| Ratio | | | | | |

*nd = not detected

As seen in Table 7, the EPA:DHA ratio of the aquaculture feed formulations are dramatically different. Each of the aquaculture feed formulations including Yarrowia Y4305 biomass as a substitute for fish oil had a higher EPA:DHA ratio than either of the standard aquaculture feeds comprising 100% rapeseed oil or the mixture of rapeseed oil and fish oil (i.e., 1.36:1, 2.23:1 and 3.1:1, respectively, versus 0.75:1 and 0.86:1, respectively). Notably, the Yarrowia Y4305 Aquaculture Feed-20% formulation and the Yarrowia Y4305 Aquaculture Feed-30% formulation both had EPA:DHA ratios greater than 2:1.

The EPA+DHA % TFAs in each of the aquaculture feed formulations was determined, as described in Example 2. Specifically, the Standard Feed-Rapeseed Oil formulation had 4.2 EPA+DHA % TFAs or 1.06 EPA+DHA % in the feed, while the Standard Feed-Fish Oil formulation had 6.7 EPA+DHA % TFAs or 1.73 EPA+DHA % in the feed. The Yarrowia Y4305 Feed-10% formulation had 5.2 EPA+DHA % TFAs or 1.29 EPA+DHA % in the feed, the Yarrowia Y4305 Feed-20% formulation had 6.8 EPA+DHA % TFAs or 1.68 EPA+DHA % in the feed and the Yarrowia Y4305 Feed-30% formulation had 8.6 EPA+DHA % TFAs or 2.05 EPA+DHA % in the feed.

### Example 4

### Comparison of EPA:DHA Ratios in Alternate Aquaculture Feed Formulations Including Variable Percentages of Yarrowia lipolytica Y4305 F1B1 Biomass

A multi-variant analysis was performed to analyze the total EPA content, total DHA content and ratio of EPA:DHA in a variety of different model aquaculture feed formulations, wherein the aquaculture feed formulations comprised: a) either anchovy oil or menhaden oil, included as 0%, 2%, 5%, 10% or 20% of the total feed on a weight basis; and, b) Yarrowia lipolytica Y4305 F1B1 biomass, included as 10%, 20% or 30% of the total feed on a weight basis.

As previously noted, salmon aquaculture feeds commonly contain either 100% fish oil or mixtures of vegetable oils and fish oils to achieve sufficient caloric value and total omega-3 fatty acid content in the feed formulation. The fish oil can be purified from a variety of different fish species, such as anchovy, capelin, menhaden, herring and cod, and each oil has its own unique fatty acid lipid profile. For example, anchovy oil was assumed herein to comprise 17 EPA % TFAs and 8.8 DHA % TFAs, producing a EPA:DHA ratio of 1.93:1. In contrast, menhaden oil was assumed herein to comprise 11 EPA % TFAs and 9.1 DHA % TFAs, producing a EPA:DHA ratio of 1.21:1.

For the purposes of the calculations herein, the Yarrowia lipolytica Y4305 F1B1 biomass was assumed to comprise 15 EPA % DCW, with no DHA, and biomass of strain Y4305 F1B1 typically contains an average lipid content of about 28-32 TFAs % DCW (see General Methods). Both the concentration of EPA as a percent of the total fatty acids [“EPA TFAs”] and total lipid content [“TFAs % DCW”] affect the cellular content of EPA as a percent of the dry cell weight [“EPA % DCW”]. That is, EPA % DCW is calculated as: (EPA % TFAs)*(TFAs % DCW)]/100. Based on the assumptions provided above with respect to TFAs % DCW and EPA % DCW, the EPA % TFAs for Yarrowia lipolytica Y4305 F1B1 biomass was calculated to be 50 and DHA % TFAs was zero.

Finally, it was necessary to calculate the total EPA content and total DHA content in the fish meal provided in each aquaculture feed formulation. It was assumed that the aquaculture feed formulations containing menhaden oil also included menhaden fish meal, while the aquaculture feed formulations containing anchovy oil also included anchovy fish meal. The following set of assumptions were utilized in the EPA and DHA calculations:

### For Anchovy Fish Meal:

1. Anchovy fish meal will be included in the final aquaculture feed formulation as 25% of the total feed on a weight basis;
2. Anchovy fish meal is assumed to have a total fat content of 6%;
3. One-quarter (25%) of the total fat content is assumed to be EPA and DHA;
4. For every 100 g of aquaculture feed formulation produced, 1.5% of the total aquaculture feed formulation on a weight basis is total fat content derived from anchovy fish meal (i.e., 0.25*6).
5. Since 25% of total fat content derived from anchovy fish meal in the aquaculture feed formulation is EPA and DHA, it is assumed that 0.375% of the total aquaculture feed formulation on a weight basis is EPA and DHA derived from the anchovy fish meal.
6. Of the Total EPA+DHA in Anchovy oil, 72% is EPA and 28% is DHA.
7. Thus, for every 100 g of aquaculture feed formulation produced, 0.27% is EPA derived from the anchovy fish meal (i.e., 0.375%*0.72) and 0.1% is DHA derived from the anchovy fish meal (i.e., 0.375%*0.28).

### For Menhaden Fish Meal:

1. Menhaden fish meal will be included in the final aquaculture feed formulation as 25% of the total feed on a weight basis;
2. Menhaden fish meal is assumed to have a total fat content of 6%;
3. One-fifth (20%) of the total fat content is assumed to be EPA and DHA;
4. For every 100 g of aquaculture feed formulation produced, 1.5% of the total aquaculture feed formulation on a weight basis is total fat content derived from menhaden fish meal (i.e., 0.25*6).
5. Since 20% of total fat content derived from menhaden fish meal in the feed formulation is EPA and DHA, it is assumed that 0.30% of the total aquaculture feed formulation on a weight basis is EPA and DHA derived from the menhaden fish meal.
6. Of the Total EPA+DHA in Menhaden oil, 55% is EPA and 45% is DHA.
7. Thus, for every 100 g of aquaculture feed formulation produced, 0.165% is EPA derived from the menhaden fish meal (i.e., 0.30%*0.55) and 0.135% is DHA derived from the menhaden fish meal (i.e., 0.30%*0.45).

Based on the assumptions above, it was possible to calculate the total EPA content, total DHA content and ratio of EPA:DHA in five different aquaculture feed formulations comprising anchovy oil (included as 0%, 2%, 5%, 10% or 20% of the total feed on a weight basis) and Yarrowia lipolytica Y4305 F1B1 biomass (included as 10%, 20% or 30% of the total aquaculture feed on a weight basis) (Table 8). Similarly, total EPA content, total DHA content and ratio of EPA:DHA in five different aquaculture feed formulations comprising menhaden oil (included as 0%, 2%, 5%, 10% or 20% of the total aquaculture feed on a weight basis) and Yarrowia lipolytica Y4305 F1B1 biomass (included as 10%, 20% or 30% of the total aquaculture feed on a weight basis) were calculated (Table 9).

TABLE 8
EPA And DHA Content In Aquaculture Feed Formulations Comprising Variable
Concentrations Of Yarrowia Y4305 F1B1 Biomass (10%, 20% And 30%) And
Variable Concentrations Of Anchovy Oil (0%, 2%, 5%, 10% And 20%)

| | | | | | | | | |
|---|---|---|---|---|---|---|---|---|
| % Yarrowia* | 30 | 30 | 30 | 30 | 30 | 20 | 20 | 20 |
| % EPA in | 4.50 | 4.50 | 4.50 | 4.50 | 4.50 | 3.00 | 3.00 | 3.00 |
| Yarrowia* | | | | | | | | |
| % DHA in | 0.00 | 0.00 | 0.00 | 0.00 | 0.00 | 0.00 | 0.00 | 0.00 |
| Yarrowia* | | | | | | | | |
| % anchovy oil | 0.00 | 2.00 | 5.00 | 10.00 | 20.00 | 0.00 | 2.00 | 5.00 |
| % EPA in | 0.00 | 0.34 | 0.84 | 1.68 | 3.35 | 0.00 | 0.34 | 0.84 |
| anchovy oil | | | | | | | | |
| % DHA in | 0.00 | 0.18 | 0.45 | 0.90 | 1.80 | 0.00 | 0.18 | 0.45 |
| anchovy oil | | | | | | | | |
| % Fish meal | 25.00 | 25.00 | 25.00 | 25.00 | 25.00 | 25.00 | 25.00 | 25.00 |
| % EPA in | 0.27 | 0.27 | 0.27 | 0.27 | 0.27 | 0.27 | 0.27 | 0.27 |
| Fish meal | | | | | | | | |
| % DHA in | 0.10 | 0.10 | 0.10 | 0.10 | 0.10 | 0.10 | 0.10 | 0.10 |
| Fish meal | | | | | | | | |
| Total EPA in | 4.77 | 5.11 | 5.61 | 6.45 | 8.12 | 3.27 | 3.61 | 4.11 |
| Formulation | | | | | | | | |
| Total DHA in | 0.10 | 0.28 | 0.55 | 1.00 | 1.90 | 0.10 | 0.28 | 0.55 |
| Formulation | | | | | | | | |
| Total EPA + | 4.87 | 5.39 | 6.16 | 7.45 | 10.02 | 3.37 | 3.89 | 4.66 |
| DHA in | | | | | | | | |
| Formulation | | | | | | | | |
| EPA:DHA | 47.70:1 | 18.25:1 | 10.20:1 | 6.45:1 | 4.27:1 | 32.70:1 | 12.89:1 | 7.47:1 |
| Ratio | | | | | | | | |

| | | | | | | | |
|---|---|---|---|---|---|---|---|
| % Yarrowia* | 20 | 20 | 10 | 10 | 10 | 10 | 10 |
| % EPA in | 3.00 | 3.00 | 1.50 | 1.50 | 1.50 | 1.50 | 1.50 |
| Yarrowia* | | | | | | | |
| % DHA in | 0.00 | 0.00 | 0.00 | 0.00 | 0.00 | 0.00 | 0.00 |
| Yarrowia* | | | | | | | |
| % anchovy oil | 10.00 | 20.00 | 0.00 | 2.00 | 5.00 | 10.00 | 20.00 |
| % EPA in | 1.68 | 3.35 | 0.00 | 0.34 | 0.84 | 1.68 | 3.35 |
| anchovy oil | | | | | | | |
| % DHA in | 0.90 | 1.80 | 0.00 | 0.18 | 0.45 | 0.90 | 1.80 |
| anchovy oil | | | | | | | |
| % Fish meal | 25.00 | 25.00 | 25.00 | 25.00 | 25.00 | 25.00 | 25.00 |
| % EPA in | 0.27 | 0.27 | 0.27 | 0.27 | 0.27 | 0.27 | 0.27 |
| Fish meal | | | | | | | |
| % DHA in | 0.10 | 0.10 | 0.10 | 0.10 | 0.10 | 0.10 | 0.10 |
| Fish meal | | | | | | | |
| Total EPA in | 4.95 | 6.62 | 1.77 | 2.11 | 2.61 | 3.45 | 5.12 |
| Formulation | | | | | | | |
| Total DHA in | 1.00 | 1.90 | 0.10 | 0.28 | 0.55 | 1.00 | 1.90 |
| Formulation | | | | | | | |
| Total EPA + | 5.95 | 8.52 | 1.87 | 2.39 | 3.16 | 4.45 | 7.02 |
| DHA in | | | | | | | |
| Formulation | | | | | | | |
| EPA:DHA | 4.95:1 | 3.48:1 | 17.70:1 | 7.54:1 | 4.75:1 | 3.45:1 | 2.69:1 |
| Ratio | | | | | | | |

*Yarrowia refers to Yarrowia lipolytica strain Y4305 F1B1 biomass.

TABLE 9
EPA And DHA Content In Aquaculture Feed Formulations Comprising Variable
Concentrations Of Yarrowia Y4305 F1B1 Biomass (10%, 20% And 30%)
And Variable Concentrations Of Menhaden Oil (0%, 2%, 5%, 10% And 20%)

| | | | | | | | | |
|---|---|---|---|---|---|---|---|---|
| % Yarrowia* | 30 | 30 | 30 | 30 | 30 | 20 | 20 | 20 |
| % EPA in | 4.50 | 4.50 | 4.50 | 4.50 | 4.50 | 3.00 | 3.00 | 3.00 |
| Yarrowia* | | | | | | | | |
| % DHA in | 0.00 | 0.00 | 0.00 | 0.00 | 0.00 | 0.00 | 0.00 | 0.00 |
| Yarrowia* | | | | | | | | |
| % menhaden | 0.00 | 2.00 | 5.00 | 10.00 | 20.00 | 0.00 | 2.00 | 5.00 |
| oil | | | | | | | | |
| % EPA in | 0.00 | 0.22 | 0.54 | 1.08 | 2.16 | 0.00 | 0.22 | 0.54 |
| menhaden oil | | | | | | | | |
| % DHA in | 0.00 | 0.18 | 0.46 | 0.92 | 1.84 | 0.00 | 0.18 | 0.46 |
| menhaden oil | | | | | | | | |
| % Fish meal | 25.00 | 25.00 | 25.00 | 25.00 | 25.00 | 25.00 | 25.00 | 25.00 |
| % EPA in | 0.17 | 0.17 | 0.17 | 0.17 | 0.17 | 0.17 | 0.17 | 0.17 |
| Fish meal | | | | | | | | |
| % DHA in | 0.13 | 0.13 | 0.13 | 0.13 | 0.13 | 0.13 | 0.13 | 0.13 |
| Fish meal | | | | | | | | |
| Total EPA in | 4.67 | 4.89 | 5.21 | 5.75 | 6.83 | 3.17 | 3.39 | 3.71 |
| Formulation | | | | | | | | |
| Total DHA in | 0.13 | 0.31 | 0.59 | 1.05 | 1.97 | 0.13 | 0.31 | 0.59 |
| Formulation | | | | | | | | |
| Total EPA + | 4.80 | 5.20 | 5.80 | 6.80 | 8.80 | 3.30 | 3.70 | 4.30 |
| DHA in | | | | | | | | |
| Formulation | | | | | | | | |
| EPA:DHA | 35.92:1 | 15.77:1 | 8.83:1 | 5.48:1 | 3.47:1 | 24.38:1 | 10.94:1 | 6.29:1 |
| Ratio | | | | | | | | |

| | | | | | | | |
|---|---|---|---|---|---|---|---|
| % Yarrowia* | 20 | 20 | 10 | 10 | 10 | 10 | 10 |
| % EPA in | 3.00 | 3.00 | 1.50 | 1.50 | 1.50 | 1.50 | 1.50 |
| Yarrowia* | | | | | | | |
| % DHA in | 0.00 | 0.00 | 0.00 | 0.00 | 0.00 | 0.00 | 0.00 |
| Yarrowia* | | | | | | | |
| % menhaden | 10.00 | 20.00 | 0.00 | 2.00 | 5.00 | 10.00 | 20.00 |
| oil | | | | | | | |
| % EPA in | 1.08 | 2.16 | 0.00 | 0.22 | 0.54 | 1.08 | 2.16 |
| menhaden oil | | | | | | | |
| % DHA in | 0.92 | 1.84 | 0.00 | 0.18 | 0.46 | 0.92 | 1.84 |
| menhaden oil | | | | | | | |
| % Fish meal | 25.00 | 25.00 | 25.00 | 25.00 | 25.00 | 25.00 | 25.00 |
| % EPA in | 0.17 | 0.17 | 0.17 | 0.17 | 0.17 | 0.17 | 0.17 |
| Fish meal | | | | | | | |
| % DHA in | 0.13 | 0.13 | 0.13 | 0.13 | 0.13 | 0.13 | 0.13 |
| Fish meal | | | | | | | |
| Total EPA in | 4.25 | 5.33 | 1.67 | 1.89 | 2.21 | 2.75 | 3.83 |
| Formulation | | | | | | | |
| Total DHA in | 1.05 | 1.97 | 0.13 | 0.31 | 0.59 | 1.05 | 1.97 |
| Formulation | | | | | | | |
| Total EPA + | 5.30 | 7.30 | 1.80 | 2.20 | 2.80 | 3.80 | 5.80 |
| DHA in | | | | | | | |
| Formulation | | | | | | | |
| EPA:DHA | 4.05:1 | 2.71:1 | 12.85:1 | 6.10:1 | 3.75:1 | 2.62:1 | 1.94:1 |
| Ratio | | | | | | | |

*Yarrowia refers to Yarrowia lipolytica strain Y4305 F1B1 biomass.

EPA:DHA ratios in the aquaculture feed composition that are greater than 2:1 were obtained for all combinations of fish oil and Yarrowia lipolytica Y4305 F1B1 biomass, except in the one case of the aquaculture feed composition containing 20% menhaden oil in combination with 10% Yarrowia lipolytica Y4305 F1B1 biomass.

### Example 5

### Aquaculture of Salmon Using a Standard Aquaculture Feed Formulation and a Feed Formulation Including Yarrowia lipolytica Y4305 F1B1 Biomass

The efficacies of the aquaculture feed formulations of Example 2 were compared in the present Example when used in salmon aquaculture. Specifically, the effects of the standard aquaculture feed formulation and the aquaculture feed formulation including 20% Yarrowia Y4305 F1B1 biomass were compared with respect to total fish biomass, biomass increase, average body weight, individual weight gain, pigmentation, dry matter content, crude protein content, total lipid content and fatty acid profile.

The experiment was carried out in 15 indoor tanks at Nofima Marine, Sunndalsøra, Norway. Each tank (2 m² surface area, 0.6 m water depth) was supplied with seawater (i.e., approximately 33 ppt salinity, at ambient temperature) and stocked with 42 Atlantic salmon (Salmo salar) of the SalmoBreed strain, mean weight approximately 495 g. Prior to the experiment, the fish had been stocked in larger groups in 1 m² tanks with similar conditions. The fish were kept under constant photoperiod during the experimental period.

Triplicate tanks of fish were fed by automatic feeders, aiming at an overfeeding of about 20% to allow maximum feed intake by the fish. The fish were counted and bulk weighed at the start of the experiment [“Day 0”], and bulk weighed after 4 weeks [“Day 28”] of feeding the experimental diets. Any dead fish were removed from the tanks and weighed immediately.

At the start of the experiment, fillets were sampled from 3 tanks at 10 fish per tank. This analysis was also performed after 8 and 16 weeks [“Day 53” and “Day 112”, respectively] (using 8 fish per tank at each time period). The color was first measured in the fresh fillets by a Minolta Chromameter, providing L*a*b values (wherein “L” is a measure of lightness, “a” is a measure of red color and “b” is a measure of yellow color). The fillets were frozen for subsequent analyses of carotenoids, as described by Bjerkeng et al. (Aquaculture, 157(1-2):63-82 (1997)). Fillets were also analyzed for dry matter content, crude protein content, total lipid content and fatty acids. Methods for analyses of fillet, whole body homogenates and faeces were as described in Example 2 for analyses of feeds.

Additionally, whole fish were sampled (10 fish per tank) at the start of the experiment, and homogenized pooled samples of fish were frozen. After 16 weeks an additional 5 fish per tank were sampled and homogenized pooled samples of fish were frozen. All whole body homogenates were analyzed for dry matter content, crude protein content, total lipid content and fatty acids.

Results of feeding trials are shown below in Table 10 and Table 11, with all data reported as the mean, plus or minus standard error of the mean [“±S.E.M”]. Specifically, Table 10 shows total fish biomass (at Days 0, 28, 53 and 112), biomass [“BM”] increases (between Days 0-28, Days 29-53 and Days 54-112), average body weight (at Days 0, 28, 53 and 112) and individual weight gain (between Days 0-28, Days 29-53 and Days 54-112). No unusual mortality was observed during the 112 day trial, evidenced by comparable weight gains (measured as both biomass per tank of fish and measured as weight per fish) for fish fed either the standard feed formulation or the feed formulation including 20% Yarrowia Y4305 F1B1 biomass.

TABLE 10
Total Tank Biomass And Fish Weight In Groups Of Fish Fed A
Standard Aquaculture Feed Formulation And An Aquaculture Feed
Formulation Including Yarrowia lipolytica Y4305 F1B1 Biomass

| | |
|---|---|
| | Yarrowia |
| Standard Feed | Y4305 F1B1 Feed |

Biomass, kg/tank

| | | |
|---|---|---|
| Day 0 | 20788 ± 19 | 20801 ± 17 |
| Day 28 | 23240 ± 440 | 24763 ± 168 |
| Day 53 | 27997 ± 490 | 29132 ± 392 |
| Day 112 | 34342 ± 839 | 35078 ± 462 |
| BM Increase, 0-28 days | 2452 ± 445 | 3963 ± 180 |
| BM Increase, 29-53 days | 4757 ± 78 | 4369 ± 225 |
| BM Increase, 54-112 days | 11869 ± 520 | 11241 ± 194 |

Average body weight, g

| | | |
|---|---|---|
| Day 0 | 495.0 ± 0.6 | 495.3 ± 0.7 |
| Day 28 | 553.3 ± 10.7 | 589.7 ± 3.8 |
| Day 53 | 671.7 ± 6.4 | 688.0 ± 7.8 |
| Day 112 | 1021 ± 32 | 1032 ± 14 |
| Weight gain, 0-28 days | 58.3 ± 10.7 | 94.3 ± 4.3 |
| Weight gain, 29-53 days | 118.3 ± 4.7 | 98.3 ± 5.3 |
| Weight gain, 54-112 days | 349.0 ± 28.6 | 343.5 ± 12.2 |

Table 11 reports the overall composition of the sample fish fillets (in terms of total protein content, dry matter content, fat content, pigmentation and fatty acid profile), wherein the fillets were sampled from fish that were fed either the standard aquaculture feed formulation or the aquaculture feed formulation including 20% Yarrowia Y4305 F1B1 biomass. All data is with respect to grams per 100 grams wet weight of the fish fillet. Values are reported at Day 0 and at Day 112. EPA is identified as 20:5, n-3, while DHA is identified as 22:6, n-3.

TABLE 11
Fatty Acid Composition And Carotenoid Content Of Salmon Fed
Either A Standard Aquaculture Feed Formulation Or An Aquaculture Feed
Formulation Including Yarrowia lipolytica Y4305 F1B1 Biomass

| | | |
|---|---|---|
| | | Yarrowia |
| | Standard Feed: | Y4305 F1B1 Feed: |
| Day 0 | Day 112 | Day 112 |

Gross Parameters

| | | | |
|---|---|---|---|
| Dry Matter | 28.7 ± 0.3 | 29.7 ± 0.4 | 28.9 ± 0.1 |
| Protein | 21.7 ± 0.2 | 19.5 ± 0.3 | 19.9 ± 0.2 |
| Fat | 8.1 ± 0.8 | 10.0 ± 0.37 | 8.8 ± 0.14 |

Carotenoid Content (mg/kg)

| | | | |
|---|---|---|---|
| Astaxanthin | 0.5 ± 0 | 1.87 ± 0.12 | 1.05 ± 0.08 |
| Idoxanthin | 0.2 ± 0.03 | 0.47 ± 0.12 | 0.73 ± 0.13 |

Fatty Acid Composition

| | | | |
|---|---|---|---|
| 14:0 | 0.33 ± 0.03 | 0.28 ± 0.01 | 0.17 ± 0.01 |
| 14:1, n-5 | 0.02 ± 0.00 | 0.01 ± 0.001 | 0.01 ± 0.001 |
| 15:0 | 0.03 ± 0.00 | 0.02 ± 0.002 | 0.02 ± 0.001 |
| 16:0 | 1.06 ± 0.1 | 1.14 ± 0.04 | 1.00 ± 0.01 |
| 16:1,n-5 | nd | 0.01 ± 0.0 | 0.01 ± 0.001 |
| 16:1, n-7 | 0.32 ± 0.04 | 0.24 ± 0.01 | 0.16 ± 0.008 |
| 16:1, n-9 | 0.03 ± 0.01 | 0.03 ± 0.002 | 0.02 ± 0.001 |
| 16:3, n-4 | 0.03 ± 0.00 | 0.02 ± 0.001 | 0.01 ± 0.001 |
| 17:0 | nd | 0.02 ± 0.001 | 0.02 ± 0.002 |
| 17:1, n-7 | nd | 0.02 ± 0.001 | 0.01 ± 0.001 |
| 18:0 | 0.21 ± 0.02 | 0.28 ± 0.01 | 0.28 ± 0.004 |
| 18:1, n-11 | 0.09 ± 0.01 | 0.10 ± 0.005 | 0.05 ± 0.01 |
| 18:1, n-7 | 0.21 ± 0.02 | 0.19 ± 0.01 | 0.17 ± 0.004 |
| 18:1, n-9 | 1.15 ± 0.10 | 1.45 ± 0.04 | 1.37 ± 0.01 |
| 18:2, n-6 | 0.30 ± 0.03 | 1.69 ± 0.05 | 1.99 ± 0.08 |
| 18:3, n-3 | 0.13 ± 0.01 | 0.22 ± 0.01 | 0.25 ± 0.01 |
| 18:3, n-4 | 0.02 ± 0.00 | 0.01 ± 0.001 | 0.01 ± 0.001 |
| 18:3, n-6 | nd | 0.06 ± 0.003 | 0.06 ± 0.004 |
| 20:0 | 0.01 ± 0.00 | 0.02 ± 0.001 | 0.02 ± 0.001 |
| 20:1, n-11 | 0.14 ± 0.01 | 0.12 ± 0.003 | 0.10 ± 0.003 |
| 20:1, n-7 | nd | 0.02 ± 0.001 | 0.01 ± 0.001 |
| 20:1, n-9 | 0.46 ± 0.04 | 0.46 ± 0.02 | 0.25 ± 0.01 |
| 20:2, n-6 | 0.04 ± 0.00 | 0.10 ± 0.01 | 0.11 ± 0.01 |
| 20:3, n-3 | 0.02 ± 0.00 | 0.02 ± 0.001 | 0.02 ± 0.002 |
| 20:3, n-6 | 0.02 ± 0.00 | 0.07 ± 0.001 | 0.08 ± 0.002 |
| 20:4, n-3 | 0.08 ± 0.01 | 0.08 ± 0.004 | 0.04 ± 0.002 |
| 20:4, n-6 | 0.04 ± 0.00 | 0.04 ± 0.001 | 0.04 ± 0.001 |
| 20:5, n-3 | 0.39 ± 0.04 | 0.41 ± 0.04 | 0.34 ± 0.03 |
| 22:1, n-11 | 0.52 ± 0.05 | 0.57 ± 0.02 | 0.27 ± 0.01 |
| 22:1, n-7 | 0.09 ± 0.01 | 0.07 ± 0.004 | 0.06 ± 0.002 |
| 22:1, n-9 | 0.06 ± 0.00 | 0.06 ± 0.002 | 0.03 ± 0.001 |
| 22:4, n-6 | 0.03 ± 0.00 | 0.02 ± 0.001 | 0.02 ± 0.001 |
| 22:5, n-3 | 0.16 ± 0.02 | 0.15 ± 0.01 | 0.13 ± 0.01 |
| 22:6, n-3 | 1.02 ± 0.08 | 0.76 ± 0.03 | 0.63 ± 0.03 |
| 24:0 | 0.01 ± 0.01 | 0.02 ± 0.002 | 0.02 ± 0.001 |
| 24:1, n-9 | 0.05 ± 0.01 | 0.04 ± 0.002 | 0.03 ± 0.001 |
| EPA + DHA | 1.41 ± 0.12 | 1.20 ± 0.05 | 1.00 ± 0.02 |
| Sum of n-3 | 1.82 ± 0.16 | 1.53 ± 0.07 | 1.41 ± 0.03 |
| Sum of n-6 | 0.45 ± 0.04 | 1.23 ± 0.04 | 2.26 ± 0.07 |
| Saturated | 1.67 ± 0.16 | 1.79 ± 0.06 | 1.52 ± 0.02 |
| fatty acids | | | |

*nd = not detected

The gross parameters of protein, dry matter, and fat were very comparable between fish fed the two aquaculture feed formulations. Astaxanthin was slightly less in fish fed the aquaculture feed formulation including 20% Yarrowia Y4305 F1B1 biomass.

With respect to fatty acids, the dominant fatty acids are identified in bold font in Table 11. The sum of EPA plus DHA [“EPA+DHA”] in the fish at 112 days was similar in fish fed the standard feed formulation and in fish fed the feed formulation including 20% Yarrowia Y4305 F1B1 biomass at (i.e., 1.2 g/100 g and 1 g/100 g, respectively).

Overall, the data suggest that the EPA available in the Yarrowia Y4305 F1B1 biomass is being adsorbed by the fish and converted to DHA. This demonstrates that Yarrowia Y4305 F1B1 biomass can be used in place of fish oil in aquaculture feed formulations for salmon with minimal impact on the health and growth of the cultured animal.

Finally, it is noted that the level of 18:2, n-6 (linoleic acid) in the Yarrowia Y4305 F1B1 biomass results in a significantly higher total omega-6 content [“Sum of n-6”] in fish fed the feed formulation including 20% Yarrowia Y4305 F1B1 biomass, as opposed to in fish fed the standard aquaculture feed formulation. In commercial practice, fish oil is typically blended with vegetable oils (e.g., soybean oil or rapeseed oil), which also have higher levels of 18:2, n-6. Thus, it is anticipated that a less significant difference would be noted in the 18:2, n-6 content in fish fed a commercial feed containing soybean or rapeseed oil as opposed to in fish fed the aquaculture feed formulation including 20% Yarrowia Y4305 F1B1 biomass.

Based on the results herein, wherein Yarrowia Y4305 F1B1 biomass was successfully used in place of fish oil in aquaculture feed formulations for salmon, and the calculations set forth in Example 4, one of skill in the art could readily determine the appropriate amount of Yarrowia Y4305 biomass or Yarrowia Y4305 F1B1 biomass to be included in various other aquaculture feed formulations suitable for culture of other fin fish species. The Yarrowia Y4305 or Y4305 F1B1 biomass could be used to reduce or replace the total fish oil content in any desired aquaculture feed formulation. If all other components of the aquaculture feed formulation containing the Yarrowia Y4305 or Y4305 F1B1 biomass were comparable to those of the standard feed formulation for a particular fin fish (i.e., in terms of nutritional benefit, digestability, palatability, etc.), with the exception of the Yarrowia Y4305 or Y4305 F1B1 biomass, one of skill in the art would predict that the modified aquaculture feed formulations containing the Yarrowia Y4305 or Y4305 F1B1 biomass would be suitable for the health and growth of the fin fish.

### Example 6

### Alternate Strains of Yarrowia lipolytica Suitable for Aquaculture Feed Formulations

The purpose of this Example is to provide alternate microbial biomass that could be used as a source of EPA and optionally DHA, for incorporation into an aquaculture feed formulation that provides a ratio of concentration of EPA to concentration of DHA which is greater than 2:1 based on the individual concentrations of EPA and DHA, each measured as a weight percent of total fatty acids in the aquaculture feed formulation. One skilled in the art of aquaculture feed formulation would readily be able to determine the appropriate amount of biomass (or, e.g., biomass and oil supplement) to include in the aquaculture feed formulation, to achieve the desired level of EPA and, optionally, DHA.

Although Examples 1-5 demonstrate production and use of aquaculture feed formulations including Yarrowia lipolytica Y4305 and Yarrowia lipolytica Y4305 F1B1 biomass, the present disclosure is by no means limited to aquaculture feed formulations comprising this particular biomass. Numerous other species and strains of oleaginous yeast genetically engineered for production of ω-3 PUFAs are suitable sources of microbial oils comprising EPA. As an example, one is referred to the representative strains of the oleaginous yeast Yarrowia lipolytica described in Table 12. These include the following strains that have been deposited with the ATCC: Y. lipolytica strain Y2096 (producing EPA; ATCC Accession No. PTA-7184); Y. lipolytica strain Y2201 (producing EPA; ATCC Accession No. PTA-7185); Y. lipolytica strain Y3000 (producing DHA; ATCC Accession No. PTA-7187); Y. lipolytica strain Y4128 (producing EPA; ATCC Accession No. PTA-8614); Y. lipolytica strain Y4127 (producing EPA; ATCC Accession No. PTA-8802).

Additionally, Y. lipolytica strain Y8406 (producing EPA; ATCC Accession No. PTA-10025), Y. lipolytica strain Y8412 (producing EPA; ATCC Accession No. PTA-10026) and Y. lipolytica strain Y8259 (producing EPA; ATCC Accession No. PTA-10027) are described in U.S. Pat. Appl. Pub. No. 2010-0317072-A1.

Thus, for example, Table 12 shows microbial hosts producing from 4.7% to 61.8% EPA of total fatty acids, and optionally, 5.6% DHA of total fatty acids.

TABLE 12
Lipid Profiles of Representative Yarrowia lipolytica Strains Engineered to Produce Omega-3/Omega-6 PUFAs

| | | ATCC | Fatty Acid Content (As A Percent [%] of Total Fatty Acids) | | | | | | | | | | | | | | TFAs |
|---|---|---|---|---|---|---|---|---|---|---|---|---|---|---|---|---|---|
| | | Deposit | | | | | | 18:3 | | 20:2 | | | | | DPAn- | | % |
| Strain | Reference | No. | 16:0 | 16:1 | 18:0 | 18:1 | 18:2 | (ALA) | GLA | (EDA) | DGLA | ARA | ETA | EPA | 3 | DHA | DCW |
| EU | U.S. Pat. | — | 19 | 10.3 | 2.3 | 15.8 | 12 | 0 | 18.7 | — | 5.7 | 0.2 | 3 | 10.3 | — | — | 36 |
| Y2072 | No. | — | 7.6 | 4.1 | 2.2 | 16.8 | 13.9 | 0 | 27.8 | — | 3.7 | 1.7 | 2.2 | 15 | — | — | — |
| Y2102 | 7,932,077 | — | 9 | 3 | 3.5 | 5.6 | 18.6 | 0 | 29.6 | — | 3.8 | 2.8 | 2.3 | 18.4 | — | — | — |
| Y2088 | | — | 17 | 4.5 | 3 | 2.5 | 10 | 0 | 20 | — | 3 | 2.8 | 1.7 | 20 | — | — | — |
| Y2089 | | — | 7.9 | 3.4 | 2.5 | 9.9 | 14.3 | 0 | 37.5 | — | 2.5 | 1.8 | 1.6 | 17.6 | — | — | — |
| Y2095 | | — | 13 | 0 | 2.6 | 5.1 | 16 | 0 | 29.1 | — | 3.1 | 1.9 | 2.7 | 19.3 | — | — | — |
| Y2090 | | — | 6 | 1 | 6.1 | 7.7 | 12.6 | 0 | 26.4 | — | 6.7 | 2.4 | 3.6 | 26.6 | — | — | 22.9 |
| Y2096 | | PTA- | 8.1 | 1 | 6.3 | 8.5 | 11.5 | 0 | 25 | — | 5.8 | 2.1 | 2.5 | 28.1 | — | — | 20.8 |
| | | 7184 | | | | | | | | | | | | | | | |
| Y2201 | | PTA- | 11 | 16.1 | 0.7 | 18.4 | 27 | 0 | — | 3.3 | 3.3 | 1 | 3.8 | 9 | — | — | — |
| | | 7185 | | | | | | | | | | | | | | | |
| Y3000 | U.S. Pat. | PTA- | 5.9 | 1.2 | 5.5 | 7.7 | 11.7 | 0 | 30.1 | — | 2.6 | 1.2 | 1.2 | 4.7 | 18.3 | 5.6 | — |
| | No. | 7187 | | | | | | | | | | | | | | | |
| | 7,550,286 | | | | | | | | | | | | | | | | |
| Y4001 | U.S. Pat. | — | 4.3 | 4.4 | 3.9 | 35.9 | 23 | 0 | — | 23.8 | 0 | 0 | 0 | — | — | — | — |
| Y4036 | Appl. Pub. | — | 7.7 | 3.6 | 1.1 | 14.2 | 32.6 | 0 | — | 15.6 | 18.2 | 0 | 0 | — | — | — | — |
| Y4070 | No. 2009- | — | 8 | 5.3 | 3.5 | 14.6 | 42.1 | 0 | — | 6.7 | 2.4 | 11.9 | — | — | — | — | — |
| Y4086 | 0093543-A1 | — | 3.3 | 2.2 | 4.6 | 26.3 | 27.9 | 6.9 | — | 7.6 | 1 | 0 | 2 | 9.8 | — | — | 28.6 |
| Y4128 | | PTA- | 6.6 | 4 | 2 | 8.8 | 19 | 2.1 | — | 4.1 | 3.2 | 0 | 5.7 | 42.1 | — | — | 18.3 |
| | | 8614 | | | | | | | | | | | | | | | |
| Y4158 | | — | 3.2 | 1.2 | 2.7 | 14.5 | 30.4 | 5.3 | — | 6.2 | 3.1 | 0.3 | 3.4 | 20.5 | — | — | 27.3 |
| Y4184 | | — | 3.1 | 1.5 | 1.8 | 8.7 | 31.5 | 4.9 | — | 5.6 | 2.9 | 0.6 | 2.4 | 28.9 | — | — | 23.9 |
| Y4217 | | — | 3.9 | 3.4 | 1.2 | 6.2 | 19 | 2.7 | — | 2.5 | 1.2 | 0.2 | 2.8 | 48.3 | — | — | 20.6 |
| Y4259 | | — | 4.4 | 1.4 | 1.5 | 3.9 | 19.7 | 2.1 | — | 3.5 | 1.9 | 0.6 | 1.8 | 46.1 | — | — | 23.7 |
| Y4305 | | — | 2.8 | 0.7 | 1.3 | 4.9 | 17.6 | 2.3 | — | 3.4 | 2 | 0.6 | 1.7 | 53.2 | — | — | 27.5 |
| Y4127 | Int'l. App. | PTA- | 4.1 | 2.3 | 2.9 | 15.4 | 30.7 | 8.8 | — | 4.5 | 3.0 | 3.0 | 2.8 | 18.1 | — | — | — |
| | Pub. No. | 8802 | | | | | | | | | | | | | | | |
| Y4184 | WO | — | 2.2 | 1.1 | 2.6 | 11.6 | 29.8 | 6.6 | — | 6.4 | 2.0 | 0.4 | 1.9 | 28.5 | — | — | 24.8 |
| | 2008/073367 | | | | | | | | | | | | | | | | |
| Y8406 | U.S. Pat. | PTA- | 2.6 | 0.5 | 2.9 | 5.7 | 20.3 | 2.8 | — | 2.8 | 2.1 | 0.5 | 2.1 | 51.2 | — | — | 30.7 |
| | Appl. Pub. | 10025 | | | | | | | | | | | | | | | |
| Y8412 | No. 2010- | PTA- | 2.5 | 0.4 | 2.6 | 4.3 | 19.0 | 2.4 | — | 2.2 | 2.0 | 0.5 | 1.9 | 55.8 | — | — | 27.0 |
| | 0317072-A1 | 10026 | | | | | | | | | | | | | | | |
| Y8647 | | — | 1.3 | 0.2 | 2.1 | 4.7 | 20.3 | 1.7 | — | 3.3 | 3.6 | 0.7 | 3.0 | 53.6 | — | — | 37.6 |
| Y9028 | | — | 1.3 | 0.2 | 2.1 | 4.4 | 19.8 | 1.7 | — | 3.2 | 2.5 | 0.8 | 1.9 | 54.5 | — | — | 39.6 |
| Y9481 | | — | 2.5 | 0.5 | 3.1 | 4.7 | 11.0 | 0.6 | — | 2.6 | 3.6 | 0.9 | 2.1 | 60.9 | — | — | 35.0 |
| Y9502 | | — | 2.5 | 0.5 | 2.9 | 5.0 | 12.7 | 0.9 | — | 3.5 | 3.3 | 0.8 | 2.4 | 57.0 | — | — | 37.1 |
| Y8145 | | — | 4.3 | 1.7 | 1.4 | 4.8 | 18.6 | 2.8 | — | 2.2 | 1.5 | 0.6 | 1.5 | 48.5 | — | — | 23.1 |
| Y8259 | | PTA- | 3.5 | 1.3 | 1.3 | 4.8 | 16.9 | 2.3 | — | 1.9 | 1.7 | 0.6 | 1.6 | 53.9 | — | — | 20.5 |
| | | 10027 | | | | | | | | | | | | | | | |
| Y8367 | | — | 3.7 | 1.2 | 1.1 | 3.4 | 14.2 | 1.1 | — | 1.5 | 1.7 | 0.8 | 1.0 | 58.3 | — | — | 18.4 |
| Y8672 | | — | 2.3 | 0.4 | 2.0 | 4.0 | 16.1 | 1.4 | — | 1.8 | 1.6 | 0.7 | 1.1 | 61.8 | — | — | 26.5 |

### Example 7

### Means to Disrupt Drum-Dried Flakes of Yarrowia lipolytica

A series of comparative tests were performed to optimize disruption of drum dried flakes of yeast (i.e., Yarrowia lipolytica strain Y8672). Specifically, hammer milling was examined, as well as use of either a single screw or twin screw extruder. Results are compared based on the total free microbial oil and disruption efficiency of the microbial cells, as well as the total extraction yield (based on supercritical CO₂ extraction). The present work is also described in U.S. Pat. Application No. 61/441,836 (Attorney Docket Number CL5053USPRV, filed Feb. 11, 2011), hereby incorporated herein by reference.

### Test #1: Hammer-Milled Yeast Powder

Drum dried flakes of yeast (Yarrowia lipolytica strain Y8672) biomass containing 24.2% total oil (dry weight) were hammer-milled (Mikropul Bantam mill at a feed rate of 12 Kg/h) at ambient temperature using a jump-gap separator at 16,000 rpm with three hammers to provide milled powder. Particle size of the milled powder was dl 0=3 μm; d50=16 μm and d90=108 μm, analyzed suspended in water using Frauenhofer laser diffraction.

### Test #2: Hammer Milled Yeast Powder With Twin Screw Extruder

The hammer milled yeast powder provided from Comparative Example C1 was fed at 2.3 kg/hr to an 18 mm twin screw extruder (Coperion Werner Pfleiderer ZSK-18 mm MC, Stuttgart, Germany) operating with a 10 kW motor and high torque shaft, at 150 rpm and % torque range of 66-68 to provide a disrupted yeast powder cooled to 26° C. in a final water cooled barrel.

Test #3: Yeast Powder with Twin Screw Extruder

Drum dried flakes of yeast (Yarrowia lipolytica strain Y8672) biomass containing 24.2% total oil were fed at 2.3 kg/hr to an 18 mm twin screw extruder (Coperion Werner Pfleiderer ZSK-18 mm MC) operating with a 10 kW motor and high torque shaft, at 150 rpm and % torque range of 71-73 to provide a disrupted yeast powder cooled to 23° C. in a final water cooled barrel.

### Comparison of Free Microbial Oil and Disruption Efficiency in Disrupted Yeast Powder

The free microbial oil and disruption efficiency was determined in the disrupted yeast powders of Tests #1, #2 and #3 according to the following method. Specifically, free oil and total oil content of extruded biomass samples were determined using a modified version of the method reported by Troëng (J. Amer. Oil Chemists Soc., 32:124-126 (1955)). In this method, a sample of the extruded biomass was weighed into a stainless steel centrifuge tube with a measured volume of hexane. Several chrome steel ball bearings were added if total oil was to be determined. The ball bearings were not used if free oil was to be determined. The tubes were then capped and placed on a shaker for 2 hours. The shaken samples were centrifuged, the supernatant was collected and the volume measured. The hexane was evaporated from the supernatant first by rotary film evaporation and then by evaporation under a stream of dry nitrogen until a constant weight was obtained. This weight was then used to calculate the percentage of free or total oil in the original sample. The oil content is expressed on a percent dry weight basis by measuring the moisture content of the sample, and correcting as appropriate.

The percent disruption efficiency (i.e., the percent of cells walls that have been fractured during processing) was quantified by optical visualization.

Table 13 summarizes the yeast cell disruption efficiency data for Tests #1, #2 and #3 and reveals the following. Hammer milling alone results in only 33% disruption of the yeast cells, while twin screw extrusion with a compression zone, either with or without Hammer-milling (respectively), results in yeast cell disruption greater than 80%. Additionally, the free oil content positively correlates with the percent disruption efficiency; thus, disruption using twin screw extrusion with a compression zone was preferred over Hammer milling.

TABLE 13
Comparison Of Yeast Cell Disruption Efficiency

| | Free Oil | Disruption |
|---|---|---|
| Test | % DWT | Efficiency, % |
| #1 | 8 | 33 |
| #2 | 19.6 | 82 |
| #3 | 21 | 87 |

SCF Extraction with CO₂

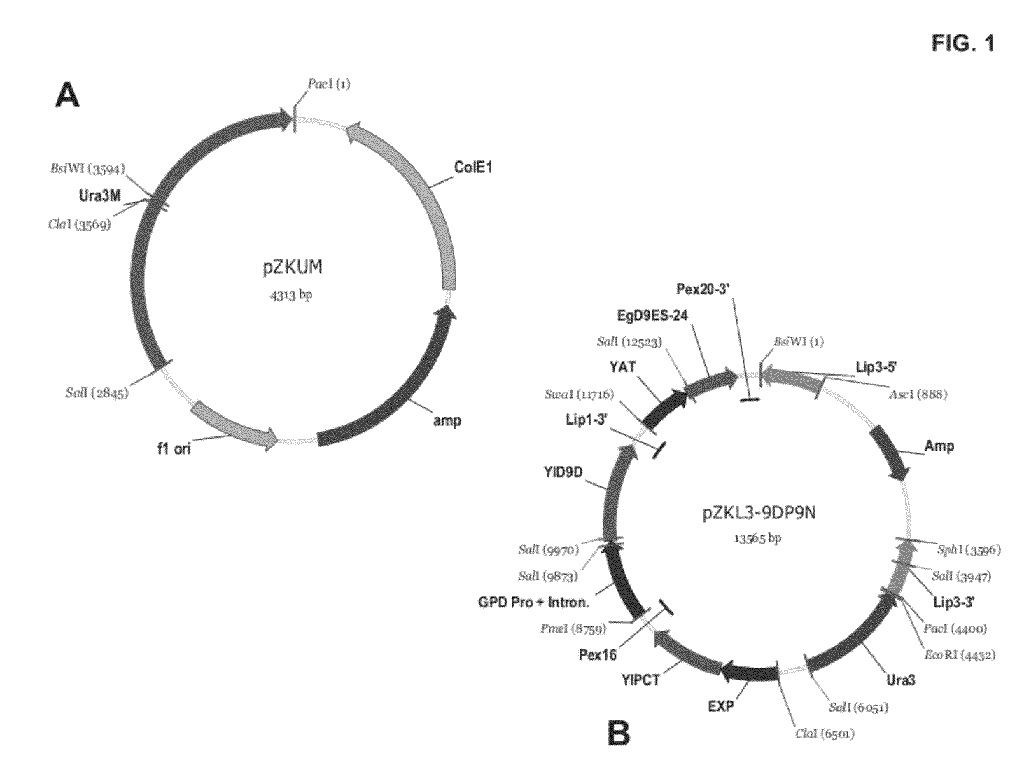

Supercritical CO₂ extraction of yeast samples in the examples below was conducted in a custom high-pressure extraction apparatus illustrated in the flowsheet of FIG. 1. In general, dried and disrupted yeast cells were charged to an extraction vessel (1) packed between plugs of glass wool, flushed with CO₂, and then heated and pressurized to the desired operating conditions under CO₂ flow. The 89-ml extraction vessels were fabricated from 316 SS tubing (2.54 cm o.d.×1.93 cm i.d.×30.5 cm long) and equipped with a 2-micron sintered metal filter on the effluent end of the vessel. The extraction vessel was installed inside of a custom machined aluminum block equipped with four calrod heating cartridges which were controlled by an automated temperature controller. The CO₂ was fed as a liquid directly from a commercial cylinder (2) equipped with an eductor tube and was metered with a high-pressure positive displacement pump (3) equipped with a refrigerated head assembly (Jasco Model PU-1580-002). Extraction pressure was maintained with an automated back pressure regulator (4) (Jasco Model BP-1580-81) which provided a flow restriction on the effluent side of the vessel, and the extracted oil sample was collected in a sample vessel while simultaneously venting the CO₂ solvent to the atmosphere.

Reported oil extraction yields from the yeast samples were determined gravimetrically by measuring the mass loss from the sample during the extraction. Thus, the reported extracted oil comprises microbial oil and moisture associated with the solid pellets.

Specifically, the extraction vessel was charged with approximately 25 g (yeast basis) of disrupted yeast biomass from Tests #1, #2 and #3, respectively. The yeast were flushed with CO₂, then heated to approximately 40° C. and pressurized to approximately 311 bar. The yeast were extracted at these conditions at a flow rate of 4.3 g/min CO₂ for approximately 6.7 hr, giving a final solvent-to-feed (S/F) ratio of about 75 g CO₂/g yeast. Extraction yields are reported in Table 14.

The data show that higher cell disruption leads to significantly higher extraction yields, measured as the weight percent of crude extracted oil.

TABLE 14
Comparison Of Cell Disruption Efficiency And Oil Extraction

| | Yeast | Cell | | | | S/F | |
|---|---|---|---|---|---|---|---|
| | Charge | disruption | | Pres- | | ratio (g | Extracted |
| | (g Dry | efficiency | Temp. | sure | Time | CO₂/g | Oil Yield |
| Test | weight) | (%) | (° C.) | (bar) | (hr) | yeast) | (wt %) |
| #1 | 25.1 | 33 | 40 | 310 | 6.6 | 74.7 | 7.5 |
| #3 | 25.2 | 87 | 41 | 310 | 6.7 | 74.4 | 18.8 |

### Example 8

### Comparison of Disrupted Drum-Dried Flakes and Spray-Dried Powder from Yarrowia lipolytica

A comparison was performed to prepare disrupted yeast powder, wherein the initial microbial biomass was either drum dried flakes or spray-dried powder of yeast, mixed in a twin-screw extruder. The present work is also described in U.S. Pat. Application No. 61/441,836 (Attorney Docket Number CL5053USPRV, filed Feb. 11, 2011), hereby incorporated herein by reference.

The initial yeast biomass was from Yarrowia lipolytica strain Y9502, having a moisture level of 2.8% and containing approximately 36% total oil. Drum dried flakes of yeast biomass were fed at 2.3 kg/hr to the twin screw extruder operating with a % torque range of 34-35; the disrupted yeast powder was cooled to 27° C. In contrast, spray dried powder of yeast biomass were fed at 1.8 kg/hr to the twin screw extruder operating with a % torque range of 33-34; the disrupted yeast powder was cooled to 26° C.

The dried yeast flakes or powder were fed to an 18 mm twin screw extruder (Coperion Werner Pfleiderer ZSK-18 mm MC) operating with a 10 kW motor and high torque shaft, at 150 rpm. The resulting disrupted yeast powder was cooled in a final water cooled barrel.

The disrupted yeast powder was then subjected to supercritical CO₂ extraction, using the apparatus described in Example 7, and total extraction yields were compared. More specifically, the extraction vessel was charged with 11.7 g (yeast basis) of drum-dried or spray-dried disrupted yeast biomass, respectively. The yeast was flushed with CO₂, then heated to approximately 40° C. and pressurized to 311 bar. The yeast samples were extracted at these conditions at a flow rate of 4.3 g/min CO₂ for 3.2 hr, giving a final solvent-to-feed (S/F) ratio of 76.4 g CO₂/g yeast. The drum-dried yeast biomass that was disrupted with the twin screw extruder produced an extracted oil yield of 31.8 weight percent while the spray-dried yeast biomass that was disrupted with the twin screw extruder produced an extracted oil yield of 30.5 weight percent. Thus, the differences between drum-drying and spray-drying prior to disruption were not significant.

### Example 9

### Means to Pelletize Disrupted Drum-Dried Flakes of Yarrowia lipolytica

This present example demonstrates that disrupted drum-dried flakes of yeast biomass could be formed into a solid pellet by blending the disrupted yeast biomass with at least one binding agent (i.e., water) to provide a fixable mix and then forming a solid pellet of disrupted yeast biomass from the fixable mix. Formation of solid pellets may facilitate handling of the disrupted material prior to its use as an ingredient in an aquaculture feed composition.

Drum-dried flakes of yeast (Yarrowia lipolytica strain Z1978, described infra in Example 10) biomass containing approximately 36.4% total oil were fed at 2.3 kg/hr to an 18 mm twin screw extruder (Coperion Werner Pfleiderer ZSK-18 mm MC). Along with the dry feed, deionized water was injected after the disruption zone of the extruder at a flow-rate of 4.7 mL/min. The extruder was operating with a 10 kW motor and high torque shaft, at 200 rpm and % torque range of 33-34 to provide a disrupted yeast powder cooled to 24° C. in a final water cooled barrel.

The fixable mix was then fed into a MG-55 LCI Dome Granulator assembled with 1 mm hole diameter by 1 mm thick screen and set to 80 RPM. Extrudates were formed at 77 kg/hr and a steady 2.4 amp current. The sample was dried in a Sherwood Dryer for 20 min to provide solid pellets having a final moisture level of 2.1%. The solid pellets were approximately 1 mm diameter×2 to 8 mm in length. The percent free oil as measured using a standard n-heptane extraction technique was 28.0%.

One of skill in the art will appreciate that these solid pellets of disrupted biomass could then be successfully formulated with other feed ingredients, according to the previous Examples, and extruded into solid pellets.

### Example 10

### Generation of Yarrowia lipolytica Strain Z1978 from Strain Y9502

The development of Yarrowia lipolytica strain Z1978 from strain Y. lipolytica Y9502 (GENERAL METHODS) is described in U.S. patent application Ser. No. 13/218,591 (Attorney Docket Number CL4783USNA, filed Aug. 26, 2011) and Ser. No. 13/218,708 (Attorney Docket Number CL5411USNA, filed on Aug. 26, 2011), hereby incorporated herein by reference.

Specifically, to disrupt the Ura3 gene in strain Y9502, construct pZKUM (FIG. 1A; SEQ ID NO:1; described in Table 15 of U.S. Pat. Appl. Pub. No. 2009-0093543-A1) was used to integrate an Ura3 mutant gene into the Ura3 gene of strain Y9502. Transformation was performed according to the methodology of U.S. Pat. Appl. Pub. No. 2009-0093543-A1, hereby incorporated herein by reference. A total of 27 transformants (selected from a first group comprising 8 transformants, a second group comprising 8 transformants, and a third group comprising 11 transformants) were grown on 5-fluoroorotic acid [“FOA”] plates (FOA plates comprise per liter: 20 g glucose, 6.7 g Yeast Nitrogen base, 75 mg uracil, 75 mg uridine and appropriate amount of FOA (Zymo Research Corp., Orange, Calif.), based on FOA activity testing against a range of concentrations from 100 mg/L to 1000 mg/L (since variation occurs within each batch received from the supplier)). Further experiments determined that only the third group of transformants possessed a real Ura-phenotype.

For fatty acid [“FA”] analysis, cells were collected by centrifugation and lipids were extracted as described in Bligh, E. G. & Dyer, W. J. (Can. J. Biochem. Physiol., 37:911-917 (1959)). Fatty acid methyl esters [“FAMEs”] were prepared by transesterification of the lipid extract with sodium methoxide (Roughan, G., and Nishida I., Arch Biochem Biophys., 276(1):38-46 (1990)) and subsequently analyzed with a Hewlett-Packard 6890 GC fitted with a 30-m×0.25 mm (i.d.) HP-INNOWAX (Hewlett-Packard) column. The oven temperature was from 170° C. (25 min hold) to 185° C. at 3.5° C./min.

For direct base transesterification, Yarrowia cells (0.5 mL culture) were harvested, washed once in distilled water, and dried under vacuum in a Speed-Vac for 5-10 min. Sodium methoxide (100 μl of 1%) and a known amount of C15:0 triacylglycerol (C15:0 TAG; Cat. No. T-145, Nu-Check Prep, Elysian, Minn.) was added to the sample, and then the sample was vortexed and rocked for 30 min at 50° C. After adding 3 drops of 1 M NaCl and 400 μl hexane, the sample was vortexed and spun. The upper layer was removed and analyzed by GC (supra). FAME peaks recorded via GC analysis were identified and quantitated according to the methodology of Example 1, as was the lipid profile.

Alternately, a modification of the base-catalysed transersterification method described in Lipid Analysis, William W. Christie, 2003 was used for routine analysis of the broth samples from either fermentation or flask samples. Specifically, broth samples were rapidly thawed in room temperature water, then weighed (to 0.1 mg) into a tarred 2 mL microcentrifuge tube with a 0.22 μm Corning® Costar® Spin-X® centrifuge tube filter (Cat. No. 8161). Sample (75-800 μl) was used, depending on the previously determined DCW. Using an Eppendorf 5430 centrifuge, samples are centrifuged for 5-7 min at 14,000 rpm or as long as necessary to remove the broth. The filter was removed, liquid was drained, and ˜500 μl of deionized water was added to the filter to wash the sample. After centrifugation to remove the water, the filter was again removed, the liquid drained and the filter re-inserted. The tube was then re-inserted into the centrifuge, this time with the top open, for ˜3-5 min to dry. The filter was then cut approximately ½ way up the tube and inserted into a fresh 2 mL round bottom Eppendorf tube (Cat. No. 22 36 335-2).

The filter was pressed to the bottom of the tube with an appropriate tool that only touches the rim of the cut filter container and not the sample or filter material. A known amount of C15:0 TAG (supra) in toluene was added and 500 μl of freshly made 1% sodium methoxide in methanol solution. The sample pellet was firmly broken up with the appropriate tool and the tubes were closed and placed in a 50° C. heat block (VWR Cat. No. 12621-088) for 30 min. The tubes were then allowed to cool for at least 5 min. Then, 400 μl of hexane and 500 μl of a 1 M NaCl in water solution were added, the tubes were vortexed for 2×6 sec and centrifuged for 1 min. Approximately 150 μl of the top (organic) layer was placed into a GC vial with an insert and analyzed by GC.

FAME peaks recorded via GC analysis were identified by their retention times, when compared to that of known fatty acids, and quantitated by comparing the FAME peak areas with that of the internal standard (C15:0 TAG) of known amount. Thus, the approximate amount (μg) of any fatty acid FAME [“μg FAME”] is calculated according to the formula: (area of the FAME peak for the specified fatty acid/area of the standard FAME peak)*(μg of the standard C15:0 TAG), while the amount (μg) of any fatty acid [“μg FA”] is calculated according to the formula: (area of the FAME peak for the specified fatty acid/area of the standard FAME peak)*(μg of the standard C15:0 TAG)*0.9503, since 1 μg of C15:0 TAG is equal to 0.9503 μg fatty acids. Note that the 0.9503 conversion factor is an approximation of the value determined for most fatty acids, which range between 0.95 and 0.96.

The lipid profile, summarizing the amount of each individual fatty acid as a wt % of TFAs, was determined by dividing the individual FAME peak area by the sum of all FAME peak areas and multiplying by 100.

In this way, GC analyses showed that there were 28.5%, 28.5%, 27.4%, 28.6%, 29.2%, 30.3% and 29.6% EPA of TFAs in pZKUM-transformants #1, #3, #6, #7, #8, #10 and #11 of group 3, respectively. These seven strains were designated as strains Y9502U12, Y9502U14, Y9502U17, Y9502U18, Y9502U19, Y9502U21 and Y9502U22, respectively (collectively, Y9502U).

Construct pZKL3-9DP9N (FIG. 1B; SEQ ID NO:2) was then generated to integrate one delta-9 desaturase gene, one choline-phosphate cytidylyl-transferase gene, and one delta-9 elongase mutant gene into the Yarrowia YALI0F32131p locus (GenBank Accession No. XM_{—}506121) of strain Y9502U. The pZKL3-9DP9N plasmid contained the following components:

TABLE 15
Description of Plasmid pZKL3-9DP9N (SEQ ID NO:2)

| RE Sites And | |
|---|---|
| Nucleotides | |
| Within SEQ ID | Description Of Fragment |
| NO:2 | And Chimeric Gene Components |
| Ascl/BsiWl | 884 by 5′ portion of YALIOF32131p locus (GenBank |
| (887-4) | Accession No. XM_506121, labeled as “Lip3-5” in Figure) |
| Pacl/Sphl | 801 by 3′ portion of YALI0F32131p locus (GenBank |
| (4396-3596) | Accession No. XM_506121, labeled as “Lip3-3” in Figure) |
| Swal/BsiWl | YAT1::EgD9eS-L35G::Pex20, comprising: |
| (11716-1) | YAT1: Yarrowia lipolytica YAT1 promoter (labeled as |
| | “YAT” in Figure; U.S. Pat. Appl. Pub. No. 2010- |
| | 0068789A1); EgD9eS-L35G: Synthetic mutant of |
| | delta-9 elongase gene (SEQ ID NO:3; U.S Pat. application |
| | No. 13/218591), derived from Euglena gracilis (“EgD9eS”; |
| | U.S. Pat. No. 7,645,604); Pex20: Pex20 terminator |
| | sequence from Yarrowia Pex20 gene (GenBank Accession |
| | No. AF054613) |
| Pmel/Swal | GPDIN::YID9::Lip1, comprising: |
| (8759-11716) | GPDIN: Yarrowia lipolytica GPDIN promoter |
| | (U.S. Pat. No. 7,459,546); |
| | YID9: Yarrowia lipolytica delta-9 desaturase gene |
| | (GenBank Accession No. XM_501496; SEQ ID NO:5); |
| | Lip1: Lip1 terminator sequence from Yarrowia Lip1 gene |
| | (GenBank Accession No. Z50020) |
| Clal/l/Pmel | EXP::YIPCT::Pex16, comprising: |
| (6501-8759) | EXP1: Yarrowia lipolytica export protein (EXP1) promoter |
| | (labeled as “Exp” in Figure; U.S Pat. No. 7,932,077); |
| | YIPCT: Yarrowia lipolytica choline-phosphate cytidylyl- |
| | transferase [“PCT”] gene (Gen Bank Accession No. |
| | XM_502978; SEQ ID NO:7); |
| | Pex16: Pex16 terminator sequence from Yarrowia Pex16 |
| | gene (Gen Bank Accession No. U75433) |
| Sa/l/EcoRl | Yarrowia Ura3 gene (Gen Bank Accession No. AJ306421) |
| (6501-4432) | |

The pZKL3-9DP9N plasmid was digested with AscI/SphI, and then used for transformation of strain Y9502U17. The transformant cells were plated onto Minimal Media [“MM”] plates and maintained at 30° C. for 3 to 4 days (Minimal Media comprises per liter: 20 g glucose, 1.7 g yeast nitrogen base without amino acids, 1.0 g proline, and pH 6.1 (do not need to adjust)). Single colonies were re-streaked onto MM plates, and then inoculated into liquid MM at 30° C. and shaken at 250 rpm/min for 2 days. The cells were collected by centrifugation, resuspended in High Glucose Media [“HGM”] and then shaken at 250 rpm/min for 5 days (High Glucose Media comprises per liter: 80 glucose, 2.58 g KH₂PO₄ and 5.36 g K₂HPO₄, pH 7.5 (do not need to adjust)). The cells were subjected to fatty acid analysis, supra.

GC analyses showed that most of the selected 96 strains of Y9502U17 with pZKL3-9DP9N produced 50-56% EPA of TFAs. Five strains (i.e., #31, #32, #35, #70 and #80) that produced about 59.0%, 56.6%, 58.9%, 56.5%, and 57.6% EPA of TFAs were designated as Z1977, Z1978, Z1979, Z1980 and Z1981 respectively.

The final genotype of these pZKL3-9DP9N transformant strains with respect to wildtype Yarrowia lipolytica ATCC #20362 was Ura+, Pex3-, unknown 1-, unknown 2-, unknown 3-, unknown 4-, unknown 5-, unknown 6-, unknown 7-, unknown 8-, unknown 9-, unknown 10-, unknown 11-, YAT1::ME3S::Pex16, GPD::ME3S::Pex20, YAT1::ME3S::Lip1, FBAINm::EgD9eS::Lip2, EXP1::EgD9eS::Lip1, GPAT::EgD9e::Lip2, YAT1::EgD9eS::Lip2, YAT::EgD9eS-L35G::Pex20, FBAINm::EgD8M::Pex20, EXP1::EgD8M::Pex16, FBAIN::EgD8M::Lip1, GPD::EaD8S::Pex16 (2 copies), YAT1::E389D9eS/EgD8M::Lip1, YAT1::EgD9eS/EgD8M::Aco, FBAINm::EaD9eS/EaD8S::Lip2, GPDIN::YID9::Lip1, GPD::FmD12::Pex20, YAT1::FmD12::Oct, EXP1::FmD12S::Aco, GPDIN::FmD12::Pex16, EXP1::EgD5M::Pex16, FBAIN::EgD5SM::Pex20, GPDIN::EgD5SM::Aco, GPM::EgD5SM::Oct, EXP1::EgD5SM::Lip1, YAT1::EaD5SM::Oct, FBAINm::PaD17::Aco, EXP1::PaD17::Pex16, YAT1::PaD17S::Lip1, YAT1::YICPT::Aco, YAT1::MCS::Lip1, FBA::MCS::Lip1, YAT1::MaLPAAT1S::Pex16, EXP1::YIPCT::Pex16.

Knockout of the YALIOF32131p locus (GenBank Accession No. XM_{—}50612) in strains Z1977, Z1978, Z1979, Z1980 and Z1981 was not confirmed in any of these EPA strains produced by transformation with pZKL3-9DP9N.

Cells from YPD plates of strains Z1977, Z1978, Z1979, Z1980 and Z1981 were grown and analyzed for total lipid content and composition, according to the methodology below.

For a detailed analysis of the total lipid content and composition in a particular strain of Y. lipolytica, flask assays were conducted as follows. Specifically, one loop of freshly streaked cells was inoculated into 3 mL Fermentation Medium [“FM”] medium and grown overnight at 250 rpm and 30° C. (Fermentation Medium comprises per liter: 6.70 g/L yeast nitrogen base, 6.00 g KH₂PO₄, 2.00 g K₂HPC₄, 1.50 g MgSC₄*7H₂O, 20 g glucose and 5.00 g yeast extract (BBL)). The OD₆₀₀ₙₘ was measured and an aliquot of the cells were added to a final OD₆₀₀ₙₘ of 0.3 in 25 mL FM medium in a 125 mL flask. After 2 days in a shaker incubator at 250 rpm and at 30° C., 6 mL of the culture was harvested by centrifugation and resuspended in 25 mL HGM in a 125 mL flask. After 5 days in a shaker incubator at 250 rpm and at 30° C., a 1 mL aliquot was used for fatty acid analysis (supra) and 10 mL dried for dry cell weight [“DCW”] determination.

For DCW determination, 10 mL culture was harvested by centrifugation for 5 min at 4000 rpm in a Beckman GH-3.8 rotor in a Beckman GS-6R centrifuge. The pellet was resuspended in 25 mL of water and re-harvested as above. The washed pellet was re-suspended in 20 mL of water and transferred to a pre-weighed aluminum pan. The cell suspension was dried overnight in a vacuum oven at 80° C. The weight of the cells was determined.

Total lipid content of cells [“TFAs % DCW”] is calculated and considered in conjunction with data tabulating the concentration of each fatty acid as a weight percent of TFAs [“% TFAs”] and the EPA content as a percent of the dry cell weight [“EPA % DCW”].

Thus, Table 16 below summarizes total lipid content and composition of strains Z1977, Z1978, Z1979, Z1980 and Z1981, as determined by flask assays. Specifically, the Table summarizes the total dry cell weight of the cells [“DCW”], the total lipid content of cells [“TFAs % DCW”], the concentration of each fatty acid as a weight percent of TFAs [“% TFAs”] and the EPA content as a percent of the dry cell weight [“EPA % DCW”].

TABLE 16
Total Lipid Content And Composition In Yarrowia Strains Z1977, Z1978, Z1979, Z1980 and Z1981 By Flask Assay

| | DCW | TFAs % | % TFAs | | | | | | | | | | | | | EPA % |
|---|---|---|---|---|---|---|---|---|---|---|---|---|---|---|---|---|
| Strain | (g/L) | DCW | 16:0 | 16:1 | 18:0 | 18:1 | 18:2 | ALA | EDA | DGLA | ARA | EtrA | ETA | EPA | other | DCW |
| Z1977 | 3.8 | 34.3 | 2.0 | 0.5 | 1.9 | 4.6 | 11.2 | 0.7 | 3.1 | 3.3 | 0.9 | 0.7 | 2.2 | 59.1 | 9.9 | 20.3 |
| Z1978 | 3.9 | 38.3 | 2.4 | 0.4 | 2.4 | 4.8 | 11.1 | 0.7 | 3.2 | 3.3 | 0.8 | 0.6 | 2.1 | 58.7 | 9.5 | 22.5 |
| Z1979 | 3.7 | 33.7 | 2.3 | 0.4 | 2.4 | 4.1 | 10.5 | 0.6 | 3.2 | 3.6 | 0.9 | 0.6 | 2.2 | 59.4 | 9.8 | 20.0 |
| Z1980 | 3.6 | 32.7 | 2.1 | 0.4 | 2.2 | 4.0 | 10.8 | 0.6 | 3.1 | 3.5 | 0.9 | 0.7 | 2.2 | 59.5 | 10.0 | 19.5 |
| Z1981 | 3.5 | 34.3 | 2.2 | 0.4 | 2.1 | 4.2 | 10.6 | 0.6 | 3.3 | 3.4 | 1.0 | 0.8 | 2.2 | 58.5 | 10.7 | 20.1 |

Strain Z1978 was subsequently subjected to partial genome sequencing (U.S. patent application Ser. No. 13/218,591). This work determined that four (not six) delta-5 desaturase genes were integrated into the Yarrowia genome (i.e., EXP1::EgD5M::Pex16, FBAIN::EgD5SM::Pex20, EXP1::EgD5SM::Lip1, and YAT1::EaD5SM::Oct).

What is claimed is:

1. A method of microbial cell disruption for use in making an aquaculture feed composition comprising:
(a) disrupting a microbial biomass, having a moisture level less than 10 weight percent and comprising oil-containing microbes, wherein said disruption results in a disruption efficiency of at least 30% of the oil-containing microbes to produce a disrupted microbial biomass; and,
(b) mixing said disrupted microbial biomass with at least one aquaculture feed component to form an aquaculture feed composition.

2. The method of claim 1 wherein said disruption is performed with a twin screw extruder comprising:
(a) a total specific energy input (SEI) of about 0.04 to 0.4 KW/(kg/hr);
(b) compaction zone using bushing elements with progressively shorter pitch length; and,
(c) a compression zone using flow restriction;
wherein the compaction zone is prior to the compression zone within the extruder.

3. The method of claim 2 wherein said flow restriction is provided by reverse screw elements, restriction/blister ring elements or kneading elements.

4. The method of claim 1, wherein said disrupted microbial biomass of step (b) is in the form of a solid pellet, said solid pellet produced by:
(i) blending the disrupted microbial biomass of step (a) with at least one binding agent to provide a fixable mix; and,
(ii) forming a solid pellet of disrupted microbial biomass from said fixable mix.

5. The method of claim 4 wherein said at least one binding agent is selected from water and carbohydrates selected from the group consisting of: sucrose, lactose, fructose, glucose, and soluble starch.

6. The method of claim 4 wherein said solid pellet comprises:
(a) about 0.5 to 20 weight percent binding agent; and,
(b) about 80 to 99.5 weight percent of disrupted biomass comprising oil-containing microbes;
wherein the weight percents are based on the summation of (a) and (b) in the solid pellet.

7. The method of claim 1, wherein said microbial biomass is obtained from at least one transgenic microbe engineered for the production of polyunsaturated fatty acid-containing microbial oil comprising EPA.

8. The method of claim 5, wherein the at least one transgenic microbe is Yarrowia lipolytica.

9. The method of claim 1, wherein the bioavailability of the oil within the disrupted microbial biomass to the aquacultured species is proportional to the disruption efficiency of the process used to produce the disrupted microbial biomass.

10. The method of claim 1, further comprising extruding said aquaculture feed composition into aquaculture feed pellets, wherein said aquaculture feed pellets are suitable for consumption by an aquacultured species.

11. The method of claim 1, wherein the disruption efficiency is at least 50%.


SEQUENCE LISTING (8 sequences)

SEQ ID NO: 1 - DNA, 4313 bp, Artificial Sequence
  Plasmid pZKUM
taatcgagcttggcgtaatcatggtcatagctgtttcctgtgtgaaattgttatccgctcacaattccacacaacatacgagccggaagcataaagtgtaaagcctggggtgcctaatgagtgagctaactcacattaattgcgttgcgctcactgcccgctttccagtcgggaaacctgtcgtgccagctgcattaatgaatcggccaacgcgcggggagaggcggtttgcgtattgggcgctcttccgcttcctcgctcactgactcgctgcgctcggtcgttcggctgcggcgagcggtatcagctcactcaaaggcggtaatacggttatccacagaatcaggggataacgcaggaaagaacatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcatagctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaaggacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgagattatcaaaaaggatcttcacctagatccttttaaattaaaaatgaagttttaaatcaatctaaagtatatatgagtaaacttggtctgacagttaccaatgcttaatcagtgaggcacctatctcagcgatctgtctatttcgttcatccatagttgcctgactccccgtcgtgtagataactacgatacgggagggcttaccatctggccccagtgctgcaatgataccgcgagacccacgctcaccggctccagatttatcagcaataaaccagccagccggaagggccgagcgcagaagtggtcctgcaactttatccgcctccatccagtctattaattgttgccgggaagctagagtaagtagttcgccagttaatagtttgcgcaacgttgttgccattgctacaggcatcgtggtgtcacgctcgtcgtttggtatggcttcattcagctccggttcccaacgatcaaggcgagttacatgatcccccatgttgtgcaaaaaagcggttagctccttcggtcctccgatcgttgtcagaagtaagttggccgcagtgttatcactcatggttatggcagcactgcataattctcttactgtcatgccatccgtaagatgcttttctgtgactggtgagtactcaaccaagtcattctgagaatagtgtatgcggcgaccgagttgctcttgcccggcgtcaatacgggataataccgcgccacatagcagaactttaaaagtgctcatcattggaaaacgttcttcggggcgaaaactctcaaggatcttaccgctgttgagatccagttcgatgtaacccactcgtgcacccaactgatcttcagcatcttttactttcaccagcgtttctgggtgagcaaaaacaggaaggcaaaatgccgcaaaaaagggaataagggcgacacggaaatgttgaatactcatactcttcctttttcaatattattgaagcatttatcagggttattgtctcatgagcggatacatatttgaatgtatttagaaaaataaacaaataggggttccgcgcacatttccccgaaaagtgccacctgacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttccattcgccattcaggctgcgcaactgttgggaagggcgatcggtgcgggcctcttcgctattacgccagctggcgaaagggggatgtgctgcaaggcgattaagttgggtaacgccagggttttcccagtcacgacgttgtaaaacgacggccagtgaattgtaatacgactcactatagggcgaattgggtaccgggccccccctcgaggtcgacgagtatctgtctgactcgtcattgccgcctttggagtacgactccaactatgagtgtgcttggatcactttgacgatacattcttcgttggaggctgtgggtctgacagctgcgttttcggcgcggttggccgacaacaatatcagctgcaacgtcattgctggctttcatcatgatcacatttttgtcggcaaaggcgacgcccagagagccattgacgttctttctaatttggaccgatagccgtatagtccagtctatctataagttcaactaactcgtaactattaccataacatatacttcactgccccagataaggttccgataaaaagttctgcagactaaatttatttcagtctcctcttcaccaccaaaatgccctcctacgaagctcgagtgctcaagctcgtggcagccaagaaaaccaacctgtgtgcttctctggatgttaccaccaccaaggagctcattgagcttgccgataaggtcggaccttatgtgtgcatgatcaaaacccatatcgacatcattgacgacttcacctacgccggcactgtgctccccctcaaggaacttgctcttaagcacggtttcttcctgttcgaggacagaaagttcgcagatattggcaacactgtcaagcaccagtaccggtgtcaccgaatcgccgagtggtccgatatcaccaacgcccacggtgtacccggaaccggaatcgattgctggcctgcgagctggtgcgtacgaggaaactgtctctgaacagaagaaggaggacgtctctgactacgagaactcccagtacaaggagttcctagtcccctctcccaacgagaagctggccagaggtctgctcatgctggccgagctgtcttgcaagggctctctggccactggcgagtactccaagcagaccattgagcttgcccgatccgaccccgagtttgtggttggcttcattgcccagaaccgacctaagggcgactctgaggactggcttattctgacccccggggtgggtcttgacgacaagggagacgctctcggacagcagtaccgaactgttgaggatgtcatgtctaccggaacggatatcataattgtcggccgaggtctgtacggccagaaccgagatcctattgaggaggccaagcgataccagaaggctggctgggaggcttaccagaagattaactgttagaggttagactatggatatgtaatttaactgtgtatatagagagcgtgcaagtatggagcgcttgttcagcttgtatgatggtcagacgacctgtctgatcgagtatgtatgatactgcacaacctgtgtatccgcatgatctgtccaatggggcatgttgttgtgtttctcgatacggagatgctgggtacagtgctaatacgttgaactacttatacttatatgaggctcgaagaaagctgacttgtgtatgacttaat

SEQ ID NO: 2 - DNA, 13565 bp, Artificial Sequence
  Plasmid pZKL3-9DP9N
gtacggattgtgtatgtccctgtacctgcatcttgatggagagagctccggaaagcggatcaggagctgtccaattttaattttataacatggaaacgagtccttggagctagaagaccattttttcaactgccctatcgactatatttatctactccaaaaccgactgcttcccaagaatcttcagccaaggcttccaaagtaacccctcgcttcccgacacttaattgaaaccttagatgcagtcactgcgagtgaagtggactctaacatctccaacatagcgacgatattgcgagggtttgaatataactaagatgcatgatccattacatttgtagaaatatcataaacaacgaagcacatagacagaatgctgttggttgttacatctgaagccgaggtaccgatgtcattttcagctgtcactgcagagacaggggtatgtcacatttgaagatcatacaaccgacgtttatgaaaaccagagatatagagaatgtattgacggttgtggctatgtcataagtgcagtgaagtgcagtgattataggtatagtacacttactgtagctacaagtacatactgctacagtaatactcatgtatgcaaaccgtattctgtgtctacagaaggcgatacggaagagtcaatctcttatgtagagccatttctataatcgaaggggccttgtaatttccaaacgagtaattgagtaattgaagagcatcgtagacattacttatcatgtattgtgagagggaggagatgcagctgtagctactgcacatactgtactcgcccatgcagggataatgcatagcgagacttggcagtaggtgacagttgctagctgctacttgtagtcgggtgggtgatagcatggcgcgccagctgcattaatgaatcggccaacgcgcggggagaggcggtttgcgtattgggcgctcttccgcttcctcgctcactgactcgctgcgctcggtcgttcggctgcggcgagcggtatcagctcactcaaaggcggtaatacggttatccacagaatcaggggataacgcaggaaagaacatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcatagctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaagaacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgagattatcaaaaaggatcttcacctagatccttttaaattaaaaatgaagttttaaatcaatctaaagtatatatgagtaaacttggtctgacagttaccaatgcttaatcagtgaggcacctatctcagcgatctgtctatttcgttcatccatagttgcctgactccccgtcgtgtagataactacgatacgggagggcttaccatctggccccagtgctgcaatgataccgcgagacccacgctcaccggctccagatttatcagcaataaaccagccagccggaagggccgagcgcagaagtggtcctgcaactttatccgcctccatccagtctattaattgttgccgggaagctagagtaagtagttcgccagttaatagtttgcgcaacgttgttgccattgctacaggcatcgtggtgtcacgctcgtcgtttggtatggcttcattcagctccggttcccaacgatcaaggcgagttacatgatcccccatgttgtgcaaaaaagcggttagctccttcggtcctccgatcgttgtcagaagtaagttggccgcagtgttatcactcatggttatggcagcactgcataattctcttactgtcatgccatccgtaagatgcttttctgtgactggtgagtactcaaccaagtcattctgagaatagtgtatgcggcgaccgagttgctcttgcccggcgtcaatacgggataataccgcgccacatagcagaactttaaaagtgctcatcattggaaaacgttcttcggggcgaaaactctcaaggatcttaccgctgttgagatccagttcgatgtaacccactcgtgcacccaactgatcttcagcatcttttactttcaccagcgtttctgggtgagcaaaaacaggaaggcaaaatgccgcaaaaaagggaataagggcgacacggaaatgttgaatactcatactcttcctttttcaatattattgaagcatttatcagggttattgtctcatgagcggatacatatttgaatgtatttagaaaaataaacaaataggggttccgcgcacatttccccgaaaagtgccacctgatgcggtgtgaaataccgcacagatgcgtaaggagaaaataccgcatcaggaaattgtaagcgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtccattcgccattcaggctgcgcaactgttgggaagggcgatcggtgcgggcctcttcgctattacgccagctggcgaaagggggatgtgctgcaaggcgattaagttgggtaacgccagggttttcccagtcacgacgttgtaaaacgacggccagtgaattgtaatacgactcactatagggcgaattgggcccgacgtcgcatgcaggaatagacatcttcaataggagcattaatacctgtgggatcactgatgtaaacttctcccagagtatgtgaataaccagcgggccatccaacaaagaagtcgttccagtgagtgactcggtacatccgtctttcggggttgatggtaagtccgtcgtctccttgcttaaagaacagagcgtccacgtagtctgcaaaagccttgtttccaagtcgaggctgcccatagttgattagcgttggatcatatccaagattcttcaggttgatgcccatgaatagagcagtgacagctcctagagagtggccagttacgatcaatttgtagtcagtgttgtttccaaggaagtcgaccagacgatcctgtacgttcaccatagtctctctgtatgccttctgaaagccatcatgaacttggcagccaggacaattgatactggcagaagggtttgtggagtttatgtcagtagtgttaagaggagggatactggtcatgtagggttgttggatcgtttggatgtcagtaatagcgtctgcaatggagaaagtgcctcggaaaacaatatacttttcctttttggtgtgatcgtgggccaaaaatccagtaactgaagtcgagaagaaatttcctccaaactggtagtcaagagtcacatcgggaaaatgagcgcaagagtttccacaggtaaaatcgctctgcagggcaaatgggccaggggctctgacacaataggccacgttagatagccatccgtacttgagaacaaagtcgtatgtctcctgggtgataggagccgttaattaagttgcgacacatgtcttgatagtatcttgaattctctctcttgagcttttccataacaagttcttctgcctccaggaagtccatgggtggtttgatcatggttttggtgtagtggtagtgcagtggtggtattgtgactggggatgtagttgagaataagtcatacacaagtcagctttcttcgagcctcatataagtataagtagttcaacgtattagcactgtacccagcatctccgtatcgagaaacacaacaacatgccccattggacagatcatgcggatacacaggttgtgcagtatcatacatactcgatcagacaggtcgtctgaccatcatacaagctgaacaagcgctccatacttgcacgctctctatatacacagttaaattacatatccatagtctaacctctaacagttaatcttctggtaagcctcccagccagccttctggtatcgcttggcctcctcaataggatctcggttctggccgtacagacctcggccgacaattatgatatccgttccggtagacatgacatcctcaacagttcggtactgctgtccgagagcgtctcccttgtcgtcaagacccaccccgggggtcagaataagccagtcctcagagtcgcccttaggtcggttctgggcaatgaagccaaccacaaactcggggtcggatcgggcaagctcaatggtctgcttggagtactcgccagtggccagagagcccttgcaagacagctcggccagcatgagcagacctctggccagcttctcgttgggagaggggactaggaactccttgtactgggagttctcgtagtcagagacgtcctccttcttctgttcagagacagtttcctcggcaccagctcgcaggccagcaatgattccggttccgggtacaccgtgggcgttggtgatatcggaccactcggcgattcggtgacaccggtactggtgcttgacagtgttgccaatatctgcgaactttctgtcctcgaacaggaagaaaccgtgcttaagagcaagttccttgagggggagcacagtgccggcgtaggtgaagtcgtcaatgatgtcgatatgggttttgatcatgcacacataaggtccgaccttatcggcaagctcaatgagctccttggtggtggtaacatccagagaagcacacaggttggttttcttggctgccacgagcttgagcactcgagcggcaaaggcggacttgtggacgttagctcgagcttcgtaggagggcattttggtggtgaagaggagactgaaataaatttagtctgcagaactttttatcggaaccttatctggggcagtgaagtatatgttatggtaatagttacgagttagttgaacttatagatagactggactatacggctatcggtccaaattagaaagaacgtcaatggctctctgggcgtcgcctttgccgacaaaaatgtgatcatgatgaaagccagcaatgacgttgcagctgatattgttgtcggccaaccgcgccgaaaacgcagctgtcagacccacagcctccaacgaagaatgtatcgtcaaagtgatccaagcacactcatagttggagtcgtactccaaaggcggcaatgacgagtcagacagatactcgtcgaccttttccttgggaaccaccaccgtcagcccttctgactcacgtattgtagccaccgacacaggcaacagtccgtggatagcagaatatgtcttgtcggtccatttctcaccaactttaggcgtcaagtgaatgttgcagaagaagtatgtgccttcattgagaatcggtgttgctgatttcaataaagtcttgagatcagtttggccagtcatgttgtggggggtaattggattgagttatcgcctacagtctgtacaggtatactcgctgcccactttatactttttgattccgctgcacttgaagcaatgtcgtttaccaaaagtgagaatgctccacagaacacaccccagggtatggttgagcaaaaaataaacactccgatacggggaatcgaaccccggtctccacggttctcaagaagtattcttgatgagagcgtatcgatggttaatgctgctgtgtgctgtgtgtgtgtgttgtttggcgctcattgttgcgttatgcagcgtacaccacaatattggaagcttattagcctttctattttttcgtttgcaaggcttaacaacattgctgtggagagggatggggatatggaggccgctggagggagtcggagaggcgttttggagcggcttggcctggcgcccagctcgcgaaacgcacctaggaccctttggcacgccgaaatgtgccacttttcagtctagtaacgccttacctacgtcattccatgcgtgcatgtttgcgccttttttcccttgcccttgatcgccacacagtacagtgcactgtacagtggaggttttgggggggtcttagatgggagctaaaagcggcctagcggtacactagtgggattgtatggagtggcatggagcctaggtggagcctgacaggacgcacgaccggctagcccgtgacagacgatgggtggctcctgttgtccaccgcgtacaaatgtttgggccaaagtcttgtcagccttgcttgcgaacctaattcccaattttgtcacttcgcacccccattgatcgagccctaacccctgcccatcaggcaatccaattaagctcgcattgtctgccttgtttagtttggctcctgcccgtttcggcgtccacttgcacaaacacaaacaagcattatatataaggctcgtctctccctcccaaccacactcacttttttgcccgtcttcccttgctaacacaaaagtcaagaacacaaacaaccaccccaacccccttacacacaagacatatctacagcaatggccatggccaaaagcaaacgacggtcggaggctgtggaagagcacgtgaccggctcggacgagggcttgaccgatacttcgggtcacgtgagccctgccgccaagaagcagaagaactcggagattcatttcaccacccaggctgcccagcagttggatcgggagcgcaaggaggagtatctggactcgctgatcgacaacaaggactatctcaagtaccgtcctcgaggctggaagctcaacaacccgcctaccgaccgacctgtgcgaatctacgccgatggagtgtttgatttgttccatctgggacacatgcgtcagctggagcagtccaagaaggccttccccaacgcagtgttgattgtgggcattcccagcgacaaggagacccacaagcggaagggattgaccgtgctgagtgacgtccagcggtacgagacggtgcgacactgcaagtgggtggacgaggtggtggaggatgctccctggtgtgtcaccatggactttctggaaaaacacaaaatcgactacgtggcccatgacgatctgccctacgcttccggcaacgacgatgatatctacaagcccatcaaggagaagggcatgtttctggccacccagcgaaccgagggcatttccacctcggacatcatcaccaagattatccgagactacgacaagtatttaatgcgaaactttgcccggggtgctaaccgaaaggatctcaacgtctcgtggctcaagaagaacgagctggacttcaagcgtcatgtggccgagttccgaaactcgttcaagcgaaagaaggtcggtaaggatctctacggcgagattcgcggtctgctgcagaatgtgctcatttggaacggcgacaactccggcacttccactccccagcgaaagacgctgcagaccaacgccaagaagatgtacatgaacgtgctcaagactctgcaggctcctgacgctgttgacgtggactcctcggagaacgtgtctgagaacgtcactgatgaggaggaggaagacgacgacgaggttgatgaggacgaagaagccgacgacgacgacgaagacgacgaagacgaggaagacgacgagtaggcggccgcattgatgattggaaacacacacatgggttatatctaggtgagagttagttggacagttatatattaaatcagctatgccaacggtaacttcattcatgtcaacgaggaaccagtgactgcaagtaatatagaatttgaccaccttgccattctcttgcactcctttactatatctcatttatttcttatatacaaatcacttcttcttcccagcatcgagctcggaaacctcatgagcaataacatcgtggatctcgtcaatagagggctttttggactccttgctgttggccaccttgtccttgctgtttaaacacgcagtaggatgtcctgcacgggtctttttgtggggtgtggagaaaggggtgcttggagatggaagccggtagaaccgggctgcttgtgcttggagatggaagccggtagaaccgggctgcttggggggatttggggccgctgggctccaaagaggggtaggcatttcgttggggttacgtaattgcggcatttgggtcctgcgcgcatgtcccattggtcagaattagtccggataggagacttatcagccaatcacagcgccggatccacctgtaggttgggttgggtgggagcacccctccacagagtagagtcaaacagcagcagcaacatgatagttgggggtgtgcgtgttaaaggaaaaaaaagaagcttgggttatattcccgctctatttagaggttgcgggatagacgccgacggagggcaatggcgctatggaaccttgcggatatccatacgccgcggcggactgcgtccgaaccagctccagcagcgttttttccgggccattgagccgactgcgaccccgccaacgtgtcttggcccacgcactcatgtcatgttggtgttgggaggccactttttaagtagcacaaggcacctagctcgcagcaaggtgtccgaaccaaagaagcggctgcagtggtgcaaacggggcggaaacggcgggaaaaagccacgggggcacgaattgaggcacgccctcgaatttgagacgagtcacggccccattcgcccgcgcaatggctcgccaacgcccggtcttttgcaccacatcaggttaccccaagccaaacctttgtgttaaaaagcttaacatattataccgaacgtaggtttgggcgggcttgctccgtctgtccaaggcaacatttatataagggtctgcatcgccggctcaattgaatcttttttcttcttctcttctctatattcattcttgaattaaacacacatcaacatggccatcaaagtcggtattaacggattcgggcgaatcggacgaattgtgagtaccatagaaggtgatggaaacatgacccaacagaaacagatgacaagtgtcatcgacccaccagagcccaattgagctcatactaacagtcgacaacctgtcgaaccaattgatgactccccgacaatgtactaacacaggtcctgcccatggtgaaaaacgtggaccaagtggatctctcgcaggtcgacaccattgcctccggccgagatgtcaactacaaggtcaagtacacctccggcgttaagatgagccagggcgcctacgacgacaagggccgccacatttccgagcagcccttcacctgggccaactggcaccagcacatcaactggctcaacttcattctggtgattgcgctgcctctgtcgtcctttgctgccgctcccttcgtctccttcaactggaagaccgccgcgtttgctgtcggctattacatgtgcaccggtctcggtatcaccgccggctaccaccgaatgtgggcccatcgagcctacaaggccgctctgcccgttcgaatcatccttgctctgtttggaggaggagctgtcgagggctccatccgatggtgggcctcgtctcaccgagtccaccaccgatggaccgactccaacaaggacccttacgacgcccgaaagggattctggttctcccactttggctggatgctgcttgtgcccaaccccaagaacaagggccgaactgacatttctgacctcaacaacgactgggttgtccgactccagcacaagtactacgtttacgttctcgtcttcatggccattgttctgcccaccctcgtctgtggctttggctggggcgactggaagggaggtcttgtctacgccggtatcatgcgatacacctttgtgcagcaggtgactttctgtgtcaactcccttgcccactggattggagagcagcccttcgacgaccgacgaactccccgagaccacgctcttaccgccctggtcacctttggagagggctaccacaacttccaccacgagttcccctcggactaccgaaacgccctcatctggtaccagtacgaccccaccaagtggctcatctggaccctcaagcaggttggtctcgcctgggacctccagaccttctcccagaacgccatcgagcagggtctcgtgcagcagcgacagaagaagctggacaagtggcgaaacaacctcaactggggtatccccattgagcagctgcctgtcattgagtttgaggagttccaagagcaggccaagacccgagatctggttctcatttctggcattgtccacgacgtgtctgcctttgtcgagcaccaccctggtggaaaggccctcattatgagcgccgtcggcaaggacggtaccgctgtcttcaacggaggtgtctaccgacactccaacgctggccacaacctgcttgccaccatgcgagtttcggtcattcgaggcggcatggaggttgaggtgtggaagactgcccagaacgaaaagaaggaccagaacattgtctccgatgagagtggaaaccgaatccaccgagctggtctccaggccacccgggtcgagaaccccggtatgtctggcatggctgcttaggcggccgcatgagaagataaatatataaatacattgagatattaaatgcgctagattagagagcctcatactgctcggagagaagccaagacgagtactcaaaggggattacaccatccatatccacagacacaagctggggaaaggttctatatacactttccggaataccgtagtttccgatgttatcaatgggggcagccaggatttcaggcacttcggtgtctcggggtgaaatggcgttcttggcctccatcaagtcgtaccatgtcttcatttgcctgtcaaagtaaaacagaagcagatgaagaatgaacttgaagtgaaggaatttaaatagttggagcaagggagaaatgtagagtgtgaaagactcactatggtccgggcttatctcgaccaatagccaaagtctggagtttctgagagaaaaaggcaagatacgtatgtaacaaagcgacgcatggtacaataataccggaggcatgtatcatagagagttagtggttcgatgatggcactggtgcctggtatgactttatacggctgactacatatttgtcctcagacatacaattacagtcaagcacttacccttggacatctgtaggtaccccccggccaagacgatctcagcgtgtcgtatgtcggattggcgtagctccctcgctcgtcaattggctcccatctactttcttctgcttggctacacccagcatgtctgctatggctcgttttcgtgccttatctatcctcccagtattaccaactctaaatgacatgatgtgattgggtctacactttcatatcagagataaggagtagcacagttgcataaaaagcccaactctaatcagcttcttcctttcttgtaattagtacaaaggtgattagcgaaatctggaagcttagttggccctaaaaaaatcaaaaaaagcaaaaaacgaaaaacgaaaaaccacagttttgagaacagggaggtaacgaaggatcgtatatatatatatatatatatatacccacggatcccgagaccggcctttgattcttccctacaaccaaccattctcaccaccctaattcacaaccatggaggtcgtgaacgaaatcgtctccattggccaggaggttcttcccaaggtcgactatgctcagctctggtctgatgcctcgcactgcgaggtgctgtacctctccatcgccttcgtcatcctgaagttcacccttggtcctctcggacccaagggtcagtctcgaatgaagtttgtgttcaccaactacaacctgctcatgtccatctactcgctgggctccttcctctctatggcctacgccatgtacaccattggtgtcatgtccgacaactgcgagaaggctttcgacaacaatgtcttccgaatcaccactcagctgttctacctcagcaagttcctcgagtacattgactccttctatctgcccctcatgggcaagcctctgacctggttgcagttctttcaccatctcggagctcctatggacatgtggctgttctacaactaccgaaacgaagccgtttggatctttgtgctgctcaacggcttcattcactggatcatgtacggctactattggacccgactgatcaagctcaagttccctatgcccaagtccctgattacttctatgcagatcattcagttcaacgttggcttctacatcgtctggaagtaccggaacattccctgctaccgacaagatggaatgagaatgtttggctggtttttcaactacttctacgttggtactgtcctgtgtctgttcctcaacttctacgtgcagacctacatcgtccgaaagcacaagggagccaaaaagattcagtgagcggccgcaagtgtggatggggaagtgagtgcccggttctgtgtgcacaattggcaatccaagatggatggattcaacacagggatatagcgagctacgtggtggtgcgaggatatagcaacggatatttatgtttgacacttgagaatgtacgatacaagcactgtccaagtacaatactaaacatactgtacatactcatactcgtacccggcaacggtttcacttgagtgcagtggctagtgctcttactcgtacagtgtgcaatactgcgtatcatagtctttgatgtatatcgtattcattcatgttagttgc

SEQ ID NO: 3 - DNA, 777 bp, Euglena gracilis
  CDS (1)..(777): mutant delta-9 elongase “EgD9eS-L35G”
atggaggtcgtgaacgaaatcgtctccattggccaggaggttcttcccaaggtcgactatgctcagctctggtctgatgcctcgcactgcgaggtgctgtacgggtccatcgccttcgtcatcctgaagttcacccttggtcctctcggacccaagggtcagtctcgaatgaagtttgtgttcaccaactacaacctgctcatgtccatctactcgctgggctccttcctctctatggcctacgccatgtacaccattggtgtcatgtccgacaactgcgagaaggctttcgacaacaatgtcttccgaatcaccactcagctgttctacctcagcaagttcctcgagtacattgactccttctatctgcccctcatgggcaagcctctgacctggttgcagttctttcaccatctcggagctcctatggacatgtggctgttctacaactaccgaaacgaagccgtttggatctttgtgctgctcaacggcttcattcactggatcatgtacggctactattggacccgactgatcaagctcaagttccctatgcccaagtccctgattacttctatgcagatcattcagttcaacgttggcttctacatcgtctggaagtaccggaacattccctgctaccgacaagatggaatgagaatgtttggctggtttttcaactacttctacgttggtactgtcctgtgtctgttcctcaacttctacgtgcagacctacatcgtccgaaagcacaagggagccaaaaagattcagtga

SEQ ID NO: 4 - protein, 258 aa, Euglena gracilis
MEVVNEIVSIGQEVLPKVDYAQLWSDASHCEVLYGSIAFVILKFTLGPLGPKGQSRMKFVFTNYNLLMSIYSLGSFLSMAYAMYTIGVMSDNCEKAFDNNVFRITTQLFYLSKFLEYIDSFYLPLMGKPLTWLQFFHHLGAPMDMWLFYNYRNEAVWIFVLLNGFIHWIMYGYYWTRLIKLKFPMPKSLITSMQIIQFNVGFYIVWKYRNIPCYRQDGMRMFGWFFNYFYVGTVLCLFLNFYVQTYIVRKHKGAKKIQ

SEQ ID NO: 5 - DNA, 1449 bp, Yarrowia lipolytica
  CDS (1)..(1449): delta-9 desaturase; GenBank Accession No. XM_501496
atggtgaaaaacgtggaccaagtggatctctcgcaggtcgacaccattgcctccggccgagatgtcaactacaaggtcaagtacacctccggcgttaagatgagccagggcgcctacgacgacaagggccgccacatttccgagcagcccttcacctgggccaactggcaccagcacatcaactggctcaacttcattctggtgattgcgctgcctctgtcgtcctttgctgccgctcccttcgtctccttcaactggaagaccgccgcgtttgctgtcggctattacatgtgcaccggtctcggtatcaccgccggctaccaccgaatgtgggcccatcgagcctacaaggccgctctgcccgttcgaatcatccttgctctgtttggaggaggagctgtcgagggctccatccgatggtgggcctcgtctcaccgagtccaccaccgatggaccgactccaacaaggacccttacgacgcccgaaagggattctggttctcccactttggctggatgctgcttgtgcccaaccccaagaacaagggccgaactgacatttctgacctcaacaacgactgggttgtccgactccagcacaagtactacgtttacgttctcgtcttcatggccattgttctgcccaccctcgtctgtggctttggctggggcgactggaagggaggtcttgtctacgccggtatcatgcgatacacctttgtgcagcaggtgactttctgtgtcaactcccttgcccactggattggagagcagcccttcgacgaccgacgaactccccgagaccacgctcttaccgccctggtcacctttggagagggctaccacaacttccaccacgagttcccctcggactaccgaaacgccctcatctggtaccagtacgaccccaccaagtggctcatctggaccctcaagcaggttggtctcgcctgggacctccagaccttctcccagaacgccatcgagcagggtctcgtgcagcagcgacagaagaagctggacaagtggcgaaacaacctcaactggggtatccccattgagcagctgcctgtcattgagtttgaggagttccaagagcaggccaagacccgagatctggttctcatttctggcattgtccacgacgtgtctgcctttgtcgagcaccaccctggtggaaaggccctcattatgagcgccgtcggcaaggacggtaccgctgtcttcaacggaggtgtctaccgacactccaacgctggccacaacctgcttgccaccatgcgagtttcggtcattcgaggcggcatggaggttgaggtgtggaagactgcccagaacgaaaagaaggaccagaacattgtctccgatgagagtggaaaccgaatccaccgagctggtctccaggccacccgggtcgagaaccccggtatgtctggcatggctgcttag

SEQ ID NO: 6 - protein, 482 aa, Yarrowia lipolytica
MVKNVDQVDLSQVDTIASGRDVNYKVKYTSGVKMSQGAYDDKGRHISEQPFTWANWHQHINWLNFILVIALPLSSFAAAPFVSFNWKTAAFAVGYYMCTGLGITAGYHRMWAHRAYKAALPVRIILALFGGGAVEGSIRWWASSHRVHHRWTDSNKDPYDARKGFWFSHFGWMLLVPNPKNKGRTDISDLNNDWVVRLQHKYYVYVLVFMAIVLPTLVCGFGWGDWKGGLVYAGIMRYTFVQQVTFCVNSLAHWIGEQPFDDRRTPRDHALTALVTFGEGYHNFHHEFPSDYRNALIWYQYDPTKWLIWTLKQVGLAWDLQTFSQNAIEQGLVQQRQKKLDKWRNNLNWGIPIEQLPVIEFEEFQEQAKTRDLVLISGIVHDVSAFVEHHPGGKALIMSAVGKDGTAVFNGGVYRHSNAGHNLLATMRVSVIRGGMEVEVWKTAQNEKKDQNIVSDESGNRIHRAGLQATRVENPGMSGMAA

SEQ ID NO: 7 - DNA, 1101 bp, Yarrowia lipolytica
  CDS (1)..(1101): choline-phosphate cytidylyl-transferase; GenBank Accession No. XM_502978
atggccaaaagcaaacgacggtcggaggctgtggaagagcacgtgaccggctcggacgagggcttgaccgatacttcgggtcacgtgagccctgccgccaagaagcagaagaactcggagattcatttcaccacccaggctgcccagcagttggatcgggagcgcaaggaggagtatctggactcgctgatcgacaacaaggactatctcaagtaccgtcctcgaggctggaagctcaacaacccgcctaccgaccgacctgtgcgaatctacgccgatggagtgtttgatttgttccatctgggacacatgcgtcagctggagcagtccaagaaggccttccccaacgcagtgttgattgtgggcattcccagcgacaaggagacccacaagcggaagggattgaccgtgctgagtgacgtccagcggtacgagacggtgcgacactgcaagtgggtggacgaggtggtggaggatgctccctggtgtgtcaccatggactttctggaaaaacacaaaatcgactacgtggcccatgacgatctgccctacgcttccggcaacgacgatgatatctacaagcccatcaaggagaagggcatgtttctggccacccagcgaaccgagggcatttccacctcggacatcatcaccaagattatccgagactacgacaagtatttaatgcgaaactttgcccggggtgctaaccgaaaggatctcaacgtctcgtggctcaagaagaacgagctggacttcaagcgtcatgtggccgagttccgaaactcgttcaagcgaaagaaggtcggtaaggatctctacggcgagattcgcggtctgctgcagaatgtgctcatttggaacggcgacaactccggcacttccactccccagcgaaagacgctgcagaccaacgccaagaagatgtacatgaacgtgctcaagactctgcaggctcctgacgctgttgacgtggactcctcggagaacgtgtctgagaacgtcactgatgaggaggaggaagacgacgacgaggttgatgaggacgaagaagccgacgacgacgacgaagacgacgaagacgaggaagacgacgagtag

SEQ ID NO: 8 - protein, 366 aa, Yarrowia lipolytica
MAKSKRRSEAVEEHVTGSDEGLTDTSGHVSPAAKKQKNSEIHFTTQAAQQLDRERKEEYLDSLIDNKDYLKYRPRGWKLNNPPTDRPVRIYADGVFDLFHLGHMRQLEQSKKAFPNAVLIVGIPSDKETHKRKGLTVLSDVQRYETVRHCKWVDEVVEDAPWCVTMDFLEKHKIDYVAHDDLPYASGNDDDIYKPIKEKGMFLATQRTEGISTSDIITKIIRDYDKYLMRNFARGANRKDLNVSWLKKNELDFKRHVAEFRNSFKRKKVGKDLYGEIRGLLQNVLIWNGDNSGTSTPQRKTLQTNAKKMYMNVLKTLQAPDAVDVDSSENVSENVTDEEEEDDDEVDEDEEADDDDEDDEDEEDDE